(19) United States
(12) Patent Application Publication
(10) Pub. No.: US 2007/0042173 A1
(43) Pub. Date: Feb. 22, 2007

(54) Antireflection film, manufacturing method thereof, and polarizing plate using the same, and image display device

(75) Inventors: Katsuro Nagaoka, Minami-Ashigara-shi (JP); Hiroyuki Yoneyama, Minami-Ashigara-shi (JP); Masaki Noro, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/507,198

(22) Filed: Aug. 21, 2006

(30) Foreign Application Priority Data
Aug. 22, 2005 (JP) 2005-240007

(51) Int. Cl. B32B 27/20; B32B 27/00; B05D 5/06; B05D 3/02; C08F 2/46

(52) U.S. Cl. 428/313.9; 428/411.1; 428/421; 428/323; 427/162; 427/487; 427/384

(57) ABSTRACT

An antireflection film comprising a support and a layer formed by coating a composition containing at least one salt formed from an organic base whose conjugate acid has a pKa of from 5.0 to 10.5 and an acid, wherein the antireflection film has a haze value due to surface scattering of 1% or more and less than 10%, or an antireflection film comprising a support and a layer formed by coating a composition containing at least one salt formed from a nitrogen-containing organic base having a boiling point of from 35° C. to 85° C. and an acid, wherein the antireflection film has a haze value due to surface scattering of 1% or more and less than 10%.

### FIELD OF THE INVENTION

The present invention relates to an antireflection film, a manufacturing method thereof, and a polarizing plate using the antireflection film, and an image display device using the antireflection film or the polarizing plate for the outermost surface of the display.

### BACKGROUND OF THE INVENTION

The antireflection film (which is also referred to as an antireflection membrane) is generally positioned on the outermost surface of a display in order to prevent contrast reduction due to reflection of external light or glare of images in an image display device such as a cathode ray tube display device (CRT), a plasma display (PDP), an electroluminescence display (ELD), or a liquid crystal display device (LCD) so as to reduce the reflectance using the principle of the optical interference.

Such an antireflection film can be generally manufactured by forming, on a support, a low refractive index layer with a lower refractive index than that of the support, and with a proper film thickness. In order to implement a low reflectance, use of a material with a minimum refractive index is desired for the low refractive index layer. Whereas, the antireflection film is used for the outermost surface of the display, and hence it is required to have a high scratch resistance. In order to implement a high scratch resistance for a thin film with a thickness of around 100 nm, the strength of the film itself and the adhesion to the underlayer are required.

In order to reduce the refractive index of the material, there are means such as (1) introduction of a fluorine atom, and (2) reduction of the density (introduction of voids). However, in any case, the film strength or the adhesion of the interface is reduced, so that the scratch resistance tends to be reduced. Thus, it has been a difficult problem to achieve both the low refractive index and the high scratch resistance.

It is important for implementing a high scratch resistance to sufficiently promote the curing reaction. From the viewpoint of the productivity, it is advantageous to apply a fluorine-containing polymer onto a support, and then to cure the film with some method. The methods, in which the hydroxyl groups of the fluorine-containing polymer are allowed to react with the curing agent by an acid catalyst to cure the low refractive index layer of the antireflection film, are proposed in JP-A-11-228631.

On the other hand, in JP-A-62-174276 and JP-A-2-173172 (corresponding to U.S. Pat. No. 4,812,506), there is proposed a curing composition using an amine salt of sulfonic acid, a paint, or the like as a catalyst.

### SUMMARY OF THE INVENTION

With the techniques of JP-A-11-228631, the curing activity is high, but the curing reaction partly proceeds during storage. Therefore, the stability of the coating solution is insufficient, and the coating conditions have a restriction. Thus, there has been a demand for the implementation of both the curing activity and the stability of the coating solution.

It is an object of the present invention to provide an antireflection film excellent in scratch resistance while achieving both the storage stability of the coating solution and the curing activity. Further, it is another object to provide a polarizing plate and an image display device each using such an antireflection film.

The present inventors have conducted a close study in order to resolve the foregoing problems. As a result, they found that the foregoing problems can be resolved and the objects can be attained by adopting the following constitutions, and they have reached the completion of the invention. Namely, the invention has attained the objects by the following constitutions.
<1> An antireflection film characterized by having a support and at least one layer formed by coating a composition containing at least one salt formed from an organic base whose conjugate acid has a pKa of 5.0 to 10.5 and an acid, and having a haze value due to surface scattering of 1% or more and less than 10%.
<2> An antireflection film characterized by having a support and at least one layer formed by coating a composition containing at least one salt formed from a nitrogen-containing organic base having a boiling point of 35° C. or more and 85° C. or less and an acid, and having a haze value due to surface scattering of 1% or more and less than 10%.
<3> The antireflection film according to the item <1> or <2>, wherein the salt contained in the composition is formed from sulfonic acid and an organic base.
<4> The antireflection film according to any of the items <1> to <3>, wherein the layer formed by coating a composition containing a salt formed from an organic base and an acid is a low refractive index layer.
<5> The antireflection film according to any of the items <1> to <4>, wherein the composition is a composition further containing

at least one fluorine-containing polymer having (a) a fluorine-containing vinyl monomer polymerization unit and (b) a hydroxyl group-containing vinyl monomer polymerization unit, and

at least one crosslinking agent reactable with a hydroxyl group, and the layer formed by coating the composition is a low refractive index layer.
<6> The antireflection film according to the item <5>, wherein the crosslinking agent is a compound containing a nitrogen atom in the molecule, and having two or more carbon atoms, each substituted with an alkoxy group adjacent to the nitrogen atom.
<7> The antireflection film according to any of the items <1> to <6>, wherein the haze value due to internal scattering is 5 to 30%.
<8> The antireflection film according to any of the items <1> to <7>, wherein the total haze value is 5% to 35%.
<9> The antireflection film according to any of the items <5> to <8>, wherein the fluorine-containing polymer has (a) a fluorine-containing vinyl monomer polymerization unit, (b) a hydroxyl group-containing vinyl monomer polymerization unit, and (c) a polymerization unit having a graft moiety including a polysiloxane repeating unit represented by the following formula (1) at the side chain, and has a main chain including only carbon atoms: 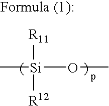
   wherein R¹¹ and R¹² may be the same or different, and each represent an alkyl group or an aryl group; and p represents an integer of 1 to 500.
<10> The antireflection film according to any of the items <5> to <8>, wherein the fluorine-containing polymer has (a) a fluorine-containing vinyl monomer polymerization unit, and (b) a hydroxyl group-containing vinyl monomer polymerization unit, and has (d) a polysiloxane repeating unit represented by the following formula (1) at the main chain: 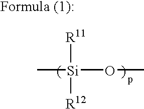
   wherein R¹¹ and R¹² may be the same or different, and each represent an alkyl group or an aryl group; and p represents an integer of 1 to 500.
<11> The antireflection film according to any of the items <4> to <10>, wherein the composition for forming the low refractive index layer further contains a compound having a hydroxyl group or a polysiloxane structure capable of reacting with a hydroxyl group and forming a bond.
<12> The antireflection film according to any of the items <4> to <11>, wherein the low refractive index layer contains inorganic oxide particles with a particle size of 1 nm or more and 150 nm or less.
<13> The antireflection film according to the item <12>, wherein the inorganic oxide particles contained in the low refractive index layer are hollow silica particles.
<14> A method for manufacturing an antireflection film, characterized by coating a composition for forming a low refractive index layer, the composition containing at least one salt formed from an organic base whose conjugate acid has a pKa of from 5.0 to 10.5 and an acid, by heating the coated composition under the condition of 70° C. and more and 130° C. or less for 5 minutes or more and 20 minutes or less, and by curing the coated composition by the use of an active energy ray, wherein the curing is conducted simultaneously with the heating, before the heating or after the coating.
<15> A method for manufacturing an antireflection film, characterized by coating a composition for forming a low refractive index layer, the composition containing at least one salt formed from a nitrogen-containing organic base having a boiling point of from 35° C. to 85° C. and an acid, by heating the coated composition under the condition of 70° C. and more and 130° C. or less for 5 minutes or more and 20 minutes or less, and by curing the coated composition by the use of an active energy ray, wherein the curing is conducted simultaneously with the heating, before the heating or after the coating.
<16> A polarizing plate characterized in that the antireflection film according to any of the items <1> to <13>, or the antireflection film manufactured with the method according to the item <14> or <15> is used for one of two protective films of a polarizing film of the polarizing plate.
<17> An image display device characterized in that the antireflection film according to any of the items <1> to <13>, or the antireflection film manufactured with the method according to the item <14> or <15>, or the polarizing plate according to the item <16> is used for the outermost surface of the display.

An antireflection film of the invention is manufactured by using a coating solution which has achieved the storage stability and the curing activity. Therefore, it is high in suitability for manufacturing, and also excellent in scratch resistance while having a sufficient antireflection property. Further, an image display device having the antireflection film of the invention and an image display device having a polarizing plate using the antireflection film of the invention are less susceptible to glare of external light and glare of the background, and very high in visibility.

### BRIEF DESCRIPTION OF THE DRAWINGS

FIG. 1 is a schematic cross sectional view schematically showing a preferred embodiment of an antireflection film of the invention;

FIG. 2 is a schematic cross sectional view schematically showing another preferred embodiment of the antireflection film of the invention;

FIG. 3 is a schematic cross sectional view schematically showing a still other preferred embodiment of the antireflection film of the invention;

FIG. 4 is a schematic cross sectional view schematically showing a furthermore preferred embodiment of the antireflection film of the invention;

FIG. 5 is a schematic cross sectional view schematically showing a still more further preferred embodiment of the antireflection film of the invention;

### DESCRIPTION OF REFERENCE NUMERALS AND SIGNS

(1) Support
(2) Hard coat layer
(3) Intermediate refractive index layer
(4) High refractive index layer
(5) Low refractive index layer

### DETAILED DESCRIPTION OF THE INVENTION

Below, the invention will be described in more details.

Incidentally, in this specification, when the numerical values represent physical property values, characteristic values, or the like, the wording “(numerical value 1) to (numerical value 2)” means “(numerical value 1) or more and (numerical value 2) or less”. Whereas, in this specification, the term “(meth)acrylate” means “at least any of acrylate and methacrylate”. The same goes for “(meth)acrylic acid”, “(meth)acryloyl”, or the like.

The invention is an antireflection film characterized by having a haze value due to surface scattering of 1% or more and less than 10%, and having at least one layer formed by coating a composition satisfying at least any of the following items (1) and (2):
(1) The composition contains at least one salt formed from an organic base whose conjugate acid has a pKa of 5.0 to 10.5 and an acid; and
(2) contains at least one salt formed from a nitrogen-containing organic base with a boiling point of 35° C. or more and 85° C. or less, and an acid.

The haze will be described in details in the section of “6-5. Haze”, and the salt, in the section of [Curing catalyst] in “1-3. Crosslinkable compound (crosslinking agent)”.

1. Constituents of the Invention

First, various compounds usable for the antireflection film of the invention will be described.

1-1. Binder

[Ionizing Radiation Curable Compound]

The antireflection film of the invention can be configured to include at least one layer formed by the crosslinking reaction or the polymerization reaction of an ionizing radiation curable compound. Namely, a coating solution (which is hereinafter also referred to as a curable composition) containing ionizing radiation curable multifunctional monomers and multifunctional oligomers as binders is coated on a transparent support, and the crosslinking reaction or the polymerization reaction of the multifunctional monomers and multifunctional oligomers are effected. This can form at least one layer of a functional layer which contributes to the antireflection function on the support.

The functional groups of ionizing radiation curable multifunctional monomers and multifunctional oligomers are preferably photo-, electron beam, or radiation polymerizable ones. Out of these, photopolymerizable functional groups are preferred. As the photopolymerizable functional groups, mention may be made of unsaturated polymerizable functional groups such as a (meth)acryloyl group, a vinyl group, a styryl group, and an allyl group, and the like. Out of these, a (meth)acryloyl group is preferred.

[Photopolymerizable Multifunctional Monomer]

Specific examples of the photopolymerizable multifunctional monomer having a photopolymerizable functional group may include: (meth)acrylic acid diesters of alkylene glycol such as neopentyl glycol acrylate, 1,6-hexanediol(meth)acrylate, and propylene glycol di(meth)acrylate; (meth)acrylic acid diesters of polyoxyalkylene glycol such as triethylene glycol di(meth)acrylate, dipropylene glycol di(meth)acrylate, polyethylene glycol di(meth)acrylate, and polypropylene glycol di(meth)acrylate; (meth)acrylic acid diesters of polyhydric alcohol such as pentaerythritol di(meth)acrylate; and (meth)acrylic acid diesters of an ethylene oxide or propylene oxide adduct such as 2,2-bis{4-(acryloxy-diethoxy)phenyl}propane and 2-2-bis{4-(acryloxy-polypropoxy)phenyl}propane.

Further, epoxy(meth)acrylates, urethane(meth)acrylates, and polyester(meth)acrylates are also preferably used as the photopolymerizable multifunctional monomers.

Out of these, esters of polyhydric alcohol and (meth)acrylic acid are preferred. Further preferably, multifunctional monomers having 3 or more (meth)acryloyl groups per molecule are preferred. Specific examples thereof may include: trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentacrylate, (di)pentaerythritol tetra(meth)acrylate, (di)pentaerythritol hexa(meth)acrylate, tripentaerythritol triacrylate, and tripentaerythritol hexatriacrylate.

As the monomer binders, monomers with different refractive indices can be used for controlling the refractive indices of respective layers. Particularly, examples of a high refractive index monomer may include bis(4-methacryloylthiophenyl)sulfide, vinyl naphthalene, vinyl phenyl sulfide, and 4-methacryloxyphenyl-4′-methoxyphenyl thioether. Whereas, for example, dendrimer described in JP-A-2005-76005 and JP-A-2005-36105, and such a norbornene ring-containing monomer as described in JP-A-2005-60425 can also be used.

The multifunctional monomers may be used in combination of two or more thereof.

Polymerization of the monomers having the ethylenically unsaturated groups can be carried out through irradiation with ionizing radiation or heating in the presence of a radical photopolymerization initiator or a heat radical initiator.

A photopolymerization initiator is preferably used for the polymerization reaction of the photopolymerizable multifunctional monomers. The photopolymerization initiator is preferably a radical photopolymerization initiator or a cationic photopolymerization initiator. A radical photopolymerization initiator is particularly preferred.

[Polymer Binder]

As the binder in the invention, a non-crosslinked polymer or a crosslinked polymer can be used. The crosslinked polymer preferably has an anionic group. The crosslinked anionic group-containing polymer has a structure in which the main chain of the polymer having an anionic group is crosslinked.

Examples of the main chain of the polymer may include polyolefin (saturated hydrocarbon), polyether, polyurea, polyurethane, polyester, polyamine, polyamide, and melamine resins. A polyolefin main chain, a polyether main chain, and a polyurea main chain are preferred. A polyolefin main chain and a polyether main chain are further preferred, and a polyolefin main chain is most preferred.

The polyolefin main chain includes saturated hydrocarbons. The polyolefin main chain can be obtained, for example, by the addition polymerization reaction of unsaturated polymerizable groups. The polyether main chain includes repeating units linked to each other through ether linkages (—O—). The polyether main chain can be obtained, for example, by the ring-opening polymerization reaction of epoxy groups. The polyurea main chain includes repeating units linked to each other through urea linkages (—NH—CO—NH—). The polyurea main chain can be obtained, for example, by the condensation polymerization reaction between an isocyanate group and an amino group. The polyurethane main chain includes repeating units linked to each other through urethane linkages(—NH—CO—O—). The polyurethane main chain can be obtained, for example, by the condensation polymerization reaction between an isocyanate group and a hydroxyl group (including an N-methylol group). The polyester main chain includes repeating units linked to each other through ester linkages (—CO—O—). The polyester main chain can be obtained, for example, by the condensation polymerization reaction between a carboxyl group (including an acid halide group) and a hydroxyl group (including an N-methylol group). The polyamine main chain includes repeating units linked to each other through imino linkages (—NH—). The polyamine main chain can be obtained, for example, by the ring-opening polymerization reaction of an ethylenimine group. The polyamide main chain includes repeating units linked to each other through amido linkages(—NH—CO—). The polyamide main chain can be obtained, for example, by the reaction between an isocyanate group and a carboxyl group (including an acid halide group). The melamine resin main chain can be obtained, for example, by the condensation polymerization reaction between a triazine group (e.g., melamine) and aldehyde (e.g., formaldehyde). Incidentally, in the melamine resin, the main chain itself has a crosslinked structure.

The anionic group is directly linked to the main chain of the polymer, or linked to the main chain via a linking group. The anionic group is preferably linked as a side chain to the main chain via a linking group. Examples of the anionic group may include a carboxylic acid group (carboxyl group), a sulfonic acid group (a sulfo group), and a phosphoric acid group (a phosphono group). A sulfonic acid group and a phosphoric acid group are preferred. The anionic group may be in the form of a salt. The cation forming a salt with the anionic group is preferably an alkali metal ion. Whereas, the proton of the anionic group may be dissociated.

The linking group for linking the anionic group to the main chain of the polymer is preferably —CO—, —O—, an alkylene group, an arylene group, and a divalent group selected from a combination of these.

The crosslinked structure chemically links (preferably, covalently links) two or more main chains, and preferably covalently links 3 or more main chains. The crosslinked structure preferably includes —CO—, —O—, —S—, nitrogen atom, phosphorus atom, aliphatic residues, aromatic residues, and a di- or more valent group selected from combinations of these.

The polymer having a crosslinked anionic group is preferably a copolymer having a repeating unit having an anionic group and another repeating unit having a crosslinked structure. The proportion of the repeating units having an anionic group in the copolymer is preferably 2 to 96 mass %, further preferably 4 to 94 mass %, and most preferably 6 to 92 mass %. The repeating unit may have two or more anionic groups. The proportion of the repeating units having a crosslinked structure in the copolymer is preferably 4 to 98 mass %, further preferably 6 to 96 mass %, and most preferably 8 to 94 mass %.

The repeating unit of the polymer having a crosslinked anionic group may also have both of an anionic group and a crosslinked structure. Whereas, other repeating units (repeating units having neither anionic group nor crosslinked structure) may be contained therein.

The other repeating units are preferably a repeating unit having an amino group or a quaternary ammonium group, and a repeating unit having a benzene ring. The amino group or the quaternary ammonium group has a function of keeping the dispersed state of inorganic particles as with the anionic group. Incidentally, even when an amino group, a quaternary ammonium group, and a benzene ring are contained in the repeating unit having an anionic group or the repeating unit having a crosslinked structure, it is possible to obtain the same effects.

In the repeating unit having an amino group or a quaternary ammonium group, the amino group or the quaternary ammonium group is directly linked to the main chain of the polymer, or linked to the main chain through a linking group. The amino group or the quaternary ammonium group is preferably linked as a side chain to the main chain through a linking group. The amino group or the quaternary ammonium group is preferably a secondary amino group, a tertiary amino group, or a quaternary ammonium group, and further preferably a tertiary amino group or a quaternary ammonium group. The group to be linked to the nitrogen atom of a secondary amino group, a tertiary amino group, or a quaternary ammonium group is preferably an alkyl group, more preferably an alkyl group having 1 to 12 carbon atoms, and further preferably an alkyl group having 1 to 6 carbon atoms.

The counter ion of the quaternary ammonium group is preferably a halide ion.

The linking groups for linking the amino group or the quaternary ammonium group to the main chain of the polymer are preferably —CO—, —NH—, —O—, an alkylene group, an arylene group, and a divalent group selected from combinations thereof. When the polymer having a crosslinked anionic group contains the repeating units having an amino group or a quaternary ammonium group, the proportion thereof is preferably 0.06 to 32 mass %, further preferably 0.08 to 30 mass %, and most preferably 0.1 to 28 mass %.

[Fluorine-containing Polymer Binder]

In the invention, particularly for a low refractive index layer, out of the polymer binders, a fluorine-containing copolymer compound can be preferably used.

(a) (Fluorine-containing Vinyl Monomer Polymerization Unit)

In the invention, there is no particular restriction on the structure of the fluorine-containing vinyl monomer polymerization unit contained in the fluorine-containing polymer to be used for the formation of the low refractive index layer. For example, mention may be made of polymerization units based on fluorine-containing olefin, perfluoroalkyl vinyl ether, fluorine-containing alkyl group-containing vinyl ether, and (meth)acrylate. From the viewpoints of the suitability for manufacturing, and the properties required of the low refractive index layer such as the refractive index and the film strength, the fluorine-containing polymer is preferably a copolymer of a fluorine-containing olefin and vinyl ether, and more preferably a copolymer of perfluoroolefin and vinyl ether. Further, it may also contain perfluoroalkyl vinyl ether, fluorine-containing alkyl group-containing vinyl ether, (meth)acrylate, or the like as a copolymerization component for the purpose of reducing the refractive index.

Perfluoroolefin preferably has 3 to 7 carbon atoms. From the viewpoint of the polymerization reactivity, perfluoropropylene or perfluorobutylene is preferred. From the viewpoint of the availability, perfluoropropylene is particularly preferred.

The content of perfluoroolefin in the polymer is preferably 25 to 75 mol %. The increase in the introduction ratio of perfluoroolefin is desired for achieving a lower refractive index of the material. However, for the general solution system radical polymerization reaction, the introduction of about 50 to 70 mol % is a limit, and the introduction of a larger amount than this is difficult in terms of the polymerization reaction. In the invention, the content of perfluoroolefin is preferably 30% to 70 mol %, more preferably 30 to 60 mol %, further preferably 35 to 60 mol %, and in particular preferably 40 to 60 mol %.

The fluorine-containing polymer to be preferably used in the invention may be copolymerized with perfluorovinyl ether represented by the following formula M2 for achieving a lower refractive index. The copolymerization component may be introduced in an amount in the range of 0 to 40 mol %, more preferably 0 to 30 mol %, and further preferably 0 to 20 mol % in the polymer.

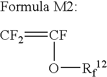

where in the formula M2, Rf¹² represents a fluorine-containing alkyl group having 1 to 30 carbon atoms, and an alkyl fluoride group preferably having 1 to 20 carbon atoms, and in particular preferably 1 to 10 carbon atoms, and further preferably a perfluoroalkyl group having 1 to 10 carbon atoms. Further, the alkyl fluoride group may have a substituent. Specific examples of R² may include —CF₃{M2-(1)}, —CF₂CF₃{M2-(2)}, —CF₂CF₂CF₃{M2-(3)}, and —CF₂CF(OCF₂CF₂CF₃){M2-(4)}.

Whereas, in the invention, for achieving a lower refractive index, a fluorine-containing vinyl ether represented by the following formula M1 may be copolymerized. The copolymerization component may be introduced in an amount in the range of 0 to 40 mol % in the polymer, and it is introduced in an amount of preferably 0 to 30 mol %, and in particular preferably 0 to 20 mol %.

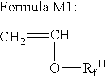

where in the formula M1, Rf¹¹ represents a fluorine-containing alkyl group having 1 to 30 carbon atoms, and a fluorine-containing alkyl group preferably having 1 to 20 carbon atoms, and in particular preferably having 1 to 15 carbon atoms; it may be a straight-chain {e.g., —CF₂CF₃, —CH₂(CF₂)_{q1}H, or —CH₂CH₂(CF₂)_{q1}F (q1: an integer of 2 to 12)}, may have a branched structure {e.g., CH(CF₃)₂, CH₂CF(CF₃)₂, or —CH(CH₃)CF₂CF₃, —CH(CH₃)(CF₂)₅CF₂H), or may have an alicyclic structure (preferably a 5-membered ring or a 6-membered ring, e.g., a perfluorocyclohexyl group or a perfluorocyclopentyl group, or an alkyl group substituted therewith, and may have an ether linkage (e.g., —CH₂OCH₂CF₂CF₃, —CH₂CH₂OCH₂(CF₂)_{q2}H, —CH₂CH₂OCH₂(CF₂)_{q2}F (q2: an integer of 2 to 12), or CH₂CH₂OCF₂CF₂OCF₂CF₂H). Incidentally, the substituent represented by Rf¹¹ is not limited to the substituents herein described.

The monomers represented by the formula M1 can be synthesized by, for example, a method in which fluorine-containing alcohol is allowed to act on leaving group-substituted alkyl vinyl ethers such as vinyloxyalkyl sulfonate or vinyloxyalkyl chloride in the presence of a base catalyst as described in Macromolecules, vol. 32 (21), p. 7122 (1999), JP-A-2-721, and the like; a method in which fluorine-containing alcohol and vinyl ethers such as butyl vinyl ether are mixed in the presence of a palladium catalyst to exchange vinyl groups as described in WO 92/05135; or a method in which fluorine-containing ketone and dibromoethane are allowed to react with each other in the presence of a potassium fluoride catalyst, and then a HBr elimination reaction is effected by an alkali catalyst.

(B) (Hydroxyl Group-containing Vinyl Monomer Polymerization Unit)

The fluorine-containing polymer to be preferably used in the invention preferably contains a hydroxyl group-containing vinyl monomer polymerization unit, the content of which has no particular restriction. The hydroxyl group has a function of reacting with a crosslinking agent, and becoming cured. Therefore, a higher content of the hydroxyl groups can form a hard film, and hence it is preferred. The content is preferably 10 mol % or more 70 mol % or less, more preferably more than 20 mol % and 60 mol % or less, and further preferably 25 mol % or more and 55 mol % or less.

Hydroxyl group-containing vinyl monomers such as vinyl ethers, (meth)acrylates, and styrenes can be used without no particular restriction so long as they are copolymerizable with the foregoing fluorine-containing vinyl monomer polymerization units. For example, when as the fluorine-containing vinyl monomer, perfluoroolefin (such as hexafluoropropylene) is used, a hydroxyl group-containing vinyl ether with favorable copolymerizability is preferably used. Non-exclusive specific examples thereof may include 2-hydroxyethyl vinyl ether, 4-hydroxybutyl vinyl ether, 6-hydroxyhexyl vinyl ether, 8-hydroxyoctyl vinyl ether, diethylene glycol vinyl ether, triethylene glycol vinyl ether, and 4-(hydroxymethyl)cyclohexylmethyl vinyl ether.

(Structural Unit Having a Polysiloxane Structure)

The fluorine-containing polymer to be preferably used in the invention preferably has a structural unit having a polysiloxane structure in order to impart a stain proof property.

(Polysiloxane Repeating Unit Contained in Side Chain)

As the fluorine-containing polymer having a polysiloxane structure useful in the invention, first, mention may be made of a fluorine-containing polymer which has at least respective ones of (a) a fluorine-containing vinyl monomer polymerization unit, (b) a hydroxyl group-containing vinyl monomer polymerization unit, and (c) a polymerization unit having a graft moiety including a polysiloxane repeating unit represented by the following formula (1) at the side chain, and has the main chain including only carbon atoms.

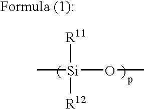

In the formula (1), R¹¹ and R¹² may be the same or different, and each represent an alkyl group or an aryl group. The alkyl group preferably has 1 to 4 carbon atoms, examples of which may include a methyl group, a trifluoromethyl group, and an ethyl group. The aryl group preferably has 6 to 20 carbon atoms, examples of which may include a phenyl group and a naphthyl group. Out of these, a methyl group and a phenyl group are preferred and a methyl group is particularly preferred. p represents an integer of 1 to 500, preferably an integer of 2 to 500, more preferably 5 to 350, and further preferably 8 to 250.

The polymer having a polysiloxane structure represented by the formula (1) at the side chain can be synthesized as described in, for example, J. Appl. Polym. Sci., vol. 2000, p. 78, (1955), and JP-A-56-28219, by a process in which to a polymer having a reactive group such as an epoxy group, a hydroxyl group, carboxyl, or an acid anhydride group, polysiloxane having a counterpart reactive group (e.g., an amino group, a mercaptro group, a carboxyl group, or a hydroxyl group for an epoxy group or an acid anhydride group) at the one end [e.g., “Silaplane” series (manufactured by Chisso Corporation)) is introduced by a polymer reaction, or a process in which polysiloxane-containing siloxane macromers are polymerized. Either process can be preferably used. In the invention, the process in which introduction is carried out by the polymerization of silicone macromers is more preferred.

Any silicone macromer is acceptable so long as it has a polymerizable group copolymerizable with a fluorine-containing olefin, and it preferably has a structure represented by any of the formulae (2-1) to (2-4):

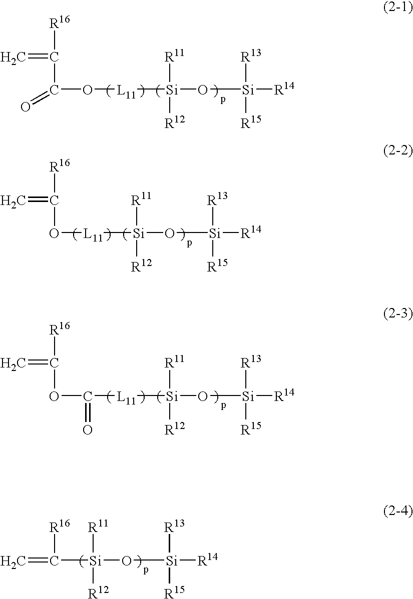

In the formulae (2-1) to (2-4), R¹¹, R¹², and p represent the same meanings as in the formula (1), and the preferred ranges thereof are also the same as those thereof. R¹³ to R¹⁵ each independently represent a substituted or unsubstituted monovalent organic group or a hydrogen atom, and represent preferably an alkyl group having 1 to 10 carbon atoms (e.g., a methyl group, an ethyl group, or an octyl group), an alkoxy group having 1 to 10 carbon atoms (e.g., a methoxy group, an ethoxy group, or a propyloxy group), or an aryl group having 6 to 20 carbon atoms (e.g., a phenyl group or a naphthyl group), and in particular preferably an alkyl group having 1 to 5 carbon atoms. R¹⁶ represents a hydrogen atom or a methyl group. L₁₁ represents a given linking group having 1 to 20 carbon atoms, and mention may be made of a substituted or unsubstituted straight-chain, branched, or alicyclic alkylene group, or a substituted or unsubstituted arylene group, preferably an unsubstituted straight-chain alkylene group having 1 to 20 carbon atoms, and in particular preferably an ethylene group or a propylene group. These compounds are synthesized by, for example, the method described in JP-A-6-322053.

Any of the compounds represented by the formulae (2-1) to (2-4) can be preferably used in the invention. However, out of these, the one of the structure represented by the formula (2-1),(2-2), or (2-3) is preferred from the viewpoint of the copolymerizability with a fluorine-containing olefin. The polysiloxane moiety accounts for preferably 0.01 to 20 mass %, more preferably 0.05 to 15 mass %, and in particular preferably 0.5 to 10 mass % in the graft copolymer.

Below, preferred examples of the polymerization unit of the polymer graft moiety containing a polysiloxane moiety at the side chain useful for the invention will be shown, but the invention is not limited to these.

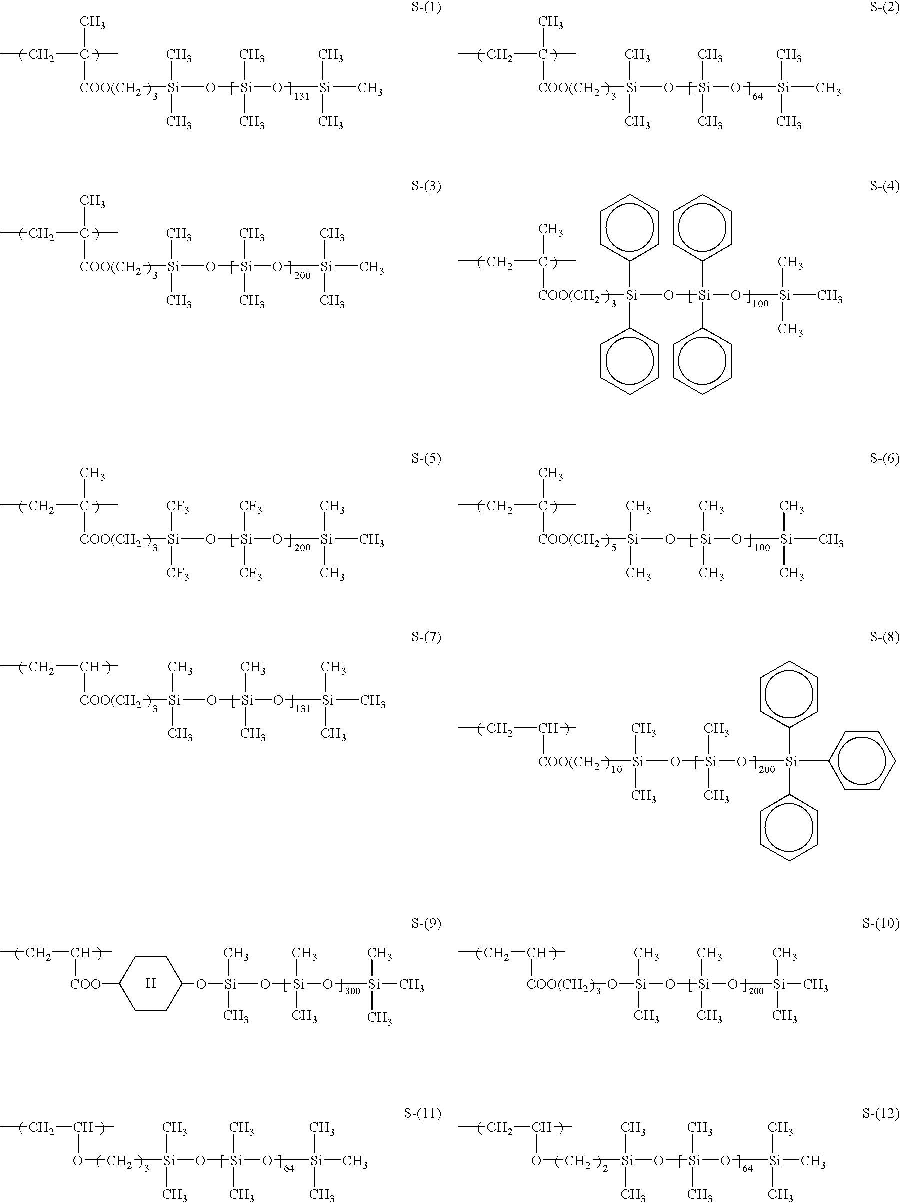

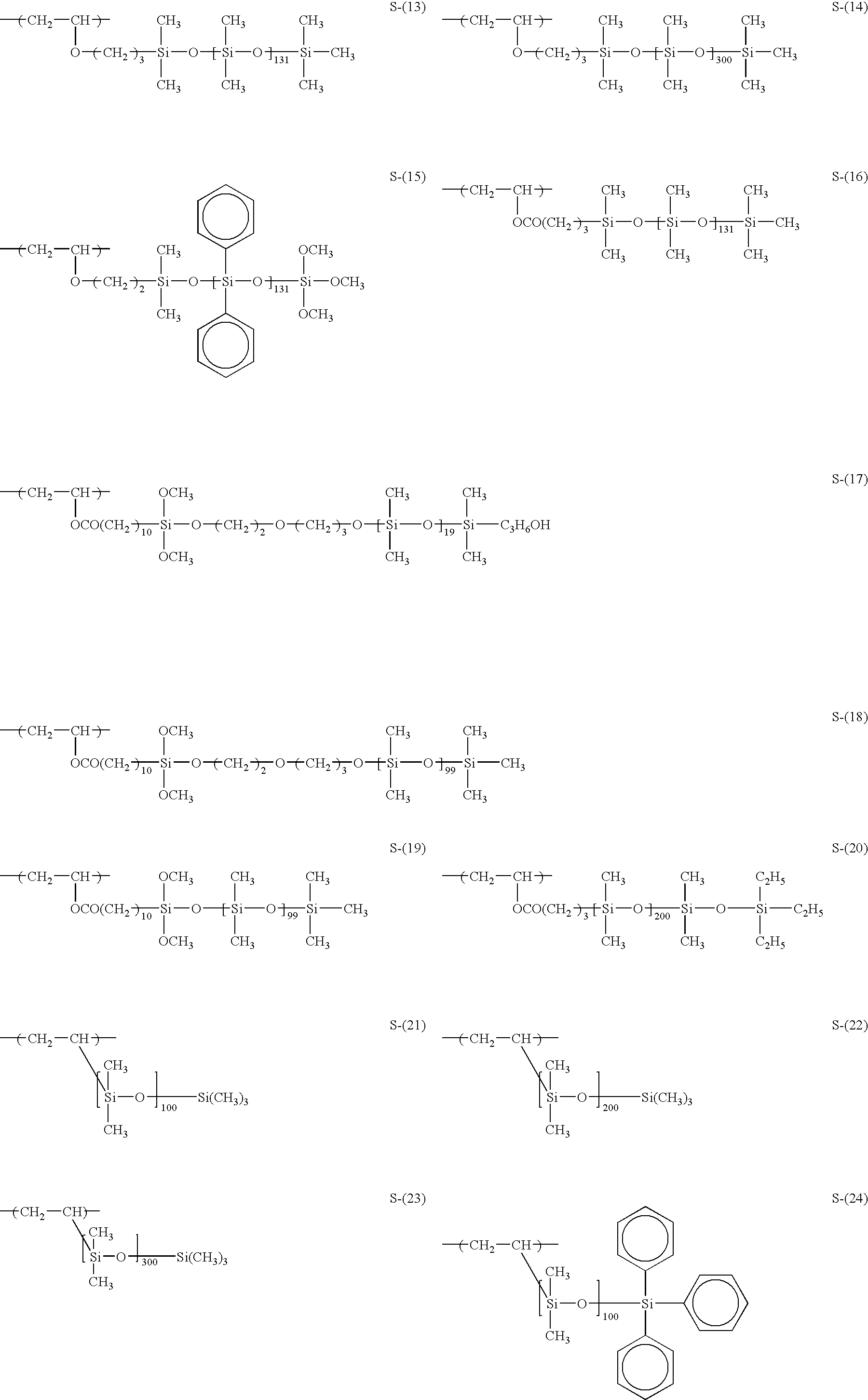

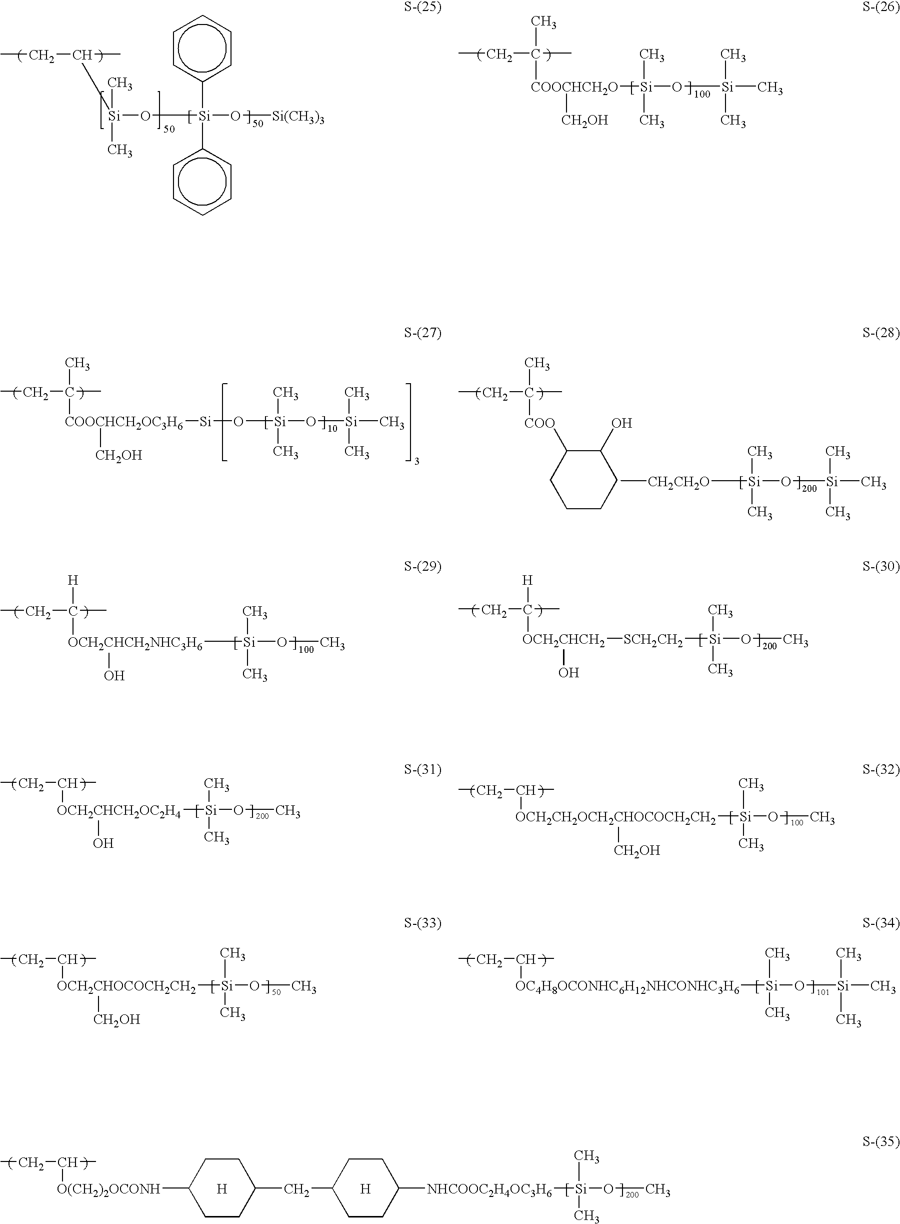

S-(36): “Silaplane FM-0711” (manufactured by Chisso Corporation))

S-(37): “Silaplane FM-0721” (the same as above)

S-(38): “Silaplane FM-0725” (the same as above)

(Polysiloxane Repeating Unit Contained in the Main Chain)

In the invention, together with the fluorine-containing polymer including a polysiloxane repeating unit at the side chain, a fluorine-containing polymer having a polysiloxane structure at the main chain, namely, a fluorine-containing polymer having at least respective ones of (a) a fluorine-containing vinyl monomer polymerization unit, and (b) a hydroxyl group-containing vinyl monomer polymerization unit, and including a polysiloxane repeating unit represented by the following formula (1) at the main chain can also be preferably used.

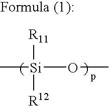

In the formula (1), R¹¹ and R¹² have the same definitions described for R¹¹ and R¹² in the formula (1) in the fluorine-containing polymer containing a polysiloxane repeating unit at the side chain, and the preferred ranges thereof are also the same as those thereof.

The method for introducing a polysiloxane structure to the main chain has no particular restriction. Examples thereof may include a method using a polymer type initiator such as an azo group-containing polysiloxaneamide described in JP-A-6-93100, a method in which a reactive group (e.g., a mercapto group, a carboxyl group, or a hydroxyl group) derived from a polymerization initiator or a chain transfer agent is introduced to the polymer terminal, followed by the reaction with mono-terminal or bi-terminal reactive group (e.g., an epoxy group or an isocyanate group)-containing polysiloxane, and a method in which cyclic siloxane oligomers such as hexamethylcyclotrisiloxane are copolymerized by anion ring opening polymerization. Out of these, the technique utilizing an initiator having a polysiloxane structure is easy and preferred.

The polysiloxane structure to be introduced to the main chain of the copolymer for use in the invention is in particular preferably the structure represented by the formula (3):

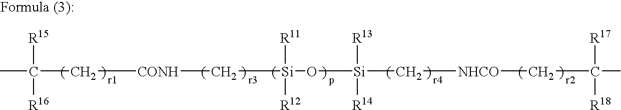

In the formula (3), R¹¹ to R¹⁴ each independently represent a hydrogen atom, an alkyl group (preferably having 1 to 5 carbon atoms, examples of which may include a methyl group and an ethyl group), a haloalkyl group (preferably a fluorinated alkyl group having 1 to 5 carbon atoms, examples of which may include a trifluoromethyl group and a pentafluoroethyl group), an aryl group (preferably having 6 to 20 carbon atoms, examples of which may include a phenyl group and a naphthyl group), preferably a methyl group or a phenyl group, and in particular preferably a methyl group.

R¹⁵ to R¹⁸ each independently represent a hydrogen atom, an alkyl group (preferably having 1 to 5 carbon atoms, examples of which may include a methyl group and an ethyl group), an aryl group (preferably having 6 to 10 carbon atoms, examples of which may include a phenyl group and a naphthyl group), an alkoxycarbonyl group (preferably having 2 to 5 carbon atoms, examples of which may include a methoxycarbonyl group and an ethoxycarbonyl group), or a cyano group, preferably an alkyl group or a cyano group, and in particular preferably a methyl group or a cyano group.

r1 and r2 each independently represent an integer of 1 to 10, preferably an integer of 1 to 6, and in particular preferably an integer of 2 to 4. r3 and r4 each independently represent an integer of 0 to 10, preferably an integer of 1 to 6, and in particular preferably an integer of 2 to 4. p represents an integer of 10 to 1000, preferably an integer of 10 to 500, and more preferably an integer of 20 to 500.

“VPS-0501” and “VPS-1001” {trade name; manufactured by Wako Pure Chemical Industries, Ltd.} which are commercially available macroazo initiators are each a compound including several units covered by the formula (3) linked via azo groups, and these are preferable for the following reason. When polymerization is effected using the compound as an initiator, the units can be introduced into the resulting polymer.

The polysiloxane structure is preferably introduced in an amount in the range of 0.01 to 20 mass %, and introduced more preferably in an amount in the range of 0.05 to 15 mass %, and introduced in particular preferably in an amount in the range of 0.5 to 10 mass % based on the amount of the copolymer for use in the invention.

The introduction of the polysiloxane structure imparts the stain proof property and the dust proof property to the film, and also imparts the slipping property to the film surface, also resulting in an advantage for the abrasion resistance.

(Other Polymerization Units)

The copolymerization components forming other polymerization units than those described above can be appropriately selected from various viewpoints of the hardness, the adhesion to the base material, the solubility in a solvent, the transparency, and the like. Examples thereof may include vinyl ethers such as methyl vinyl ether, ethyl vinyl ether, t-butyl vinyl ether, n-butyl vinyl ether, cyclohexyl vinyl ether, and isopropyl vinyl ether, and vinyl esters such as vinyl acetate, vinyl propionate, vinyl butyrate, and vinyl cyclohexanecarboxylate. The amount of each of these copolymerization components to be introduced falls within the range of 0 to 40 mol %, preferably falls within the range of 0 to 30 mol %, and in particular preferably falls within the range of 0 to 20 mol %.

(Preferred Forms of Fluorine-containing Polymer)

The particularly preferred polymer form in the invention is the form represented by the following formula (4):

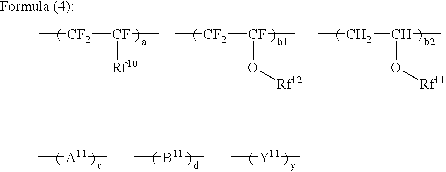

In the formula (4), Rfo represents a perfluoroalkyl group having 1 to 5 carbon atoms. The foregoing explanation described as an example of perfluoroolefin holds for the monomers forming the moiety represented by —CF₂CF(Rf¹⁰). Rf¹² has the same definition as that described for the fluorine-containing vinyl ether (Rf¹² in the compound represented by the formula M2), and the preferred range thereof is also the same as that thereof. Rf¹¹ has the same definition described for another fluorine-containing vinyl ether (Rf¹¹ in the compound represented by the formula M1), and the preferred range thereof is also the same as that thereof.

A¹¹ and B¹¹ represent a hydroxyl group-containing vinyl monomer polymerization unit, and a given structural unit, respectively. A¹¹ has the same definition as that for the hydroxyl group-containing vinyl monomer polymerization unit described above, and B¹¹ has no particular restriction, but more preferably each of vinyl ethers and vinyl esters from the viewpoint of the copolymerizability. Specifically, mention may be made of the monomers exemplified in the above description (other polymerization unit).

Y¹¹ represents a structural unit having a polysiloxane structure, and may be in the form of a polymerization unit having a graft moiety including a polysiloxane repeating unit represented by the formula (1) at the side chain, and may contain a polysiloxane repeating unit represented by the formula (1). The definitions and the preferred ranges are the same as those explained in the above description (structural unit having a polysiloxane structure).

a to d represent the molar fractions (%) of respective components, and satisfy a+b1+b2+c+d=100. a to d satisfy the relationships of 30≦a≦70 (more preferably 30≦a≦60, and further preferably 35≦a≦60), 0≦b1≦40 (more preferably 0≦b1≦30, and further preferably 0≦b1≦20), 0≦b2≦40 (more preferably 0≦b2≦30, and further preferably 0≦b2≦20), 10≦c≦70 (more preferably 20≦c≦60, and further preferably 25≦c≦55), and 0≦d≦40 (more preferably 0≦d≦30), respectively.

y represents the mass fraction (%) of the structural unit containing a polysiloxane structure based on the total amount of the fluorine-containing polymers, and satisfies the relationship of 0.01≦y≦20 (more preferably 0.05≦y≦15, and further preferably 0.5≦y≦10).

The number average molecular weight of the fluorine-containing polymer to be used for the formation of a functional layer, particularly, a low refractive index layer in the antireflection film of the invention is preferably 5,000 to 1,000,000, more preferably 8,000 to 500,000, and in particular preferably 10,000 to 100,000.

Herein, the number average molecular weights are the molecular weights expressed in polystyrene equivalents based on solvent tetrahydrofuran (THF), differential refractometer detection by means of a GPC analysis apparatus using columns of “TSK gel GMHxL”, “TSK gel G400HxL”, and “TSK gel G2000 HxL” {all are trade names of the products manufactured by Tosoh Corporation}.

Tables 1 and 2 show the specific examples of the polymer useful in the invention. However, the invention is not limited thereto. Incidentally, the polymers are expressed as combinations of polymerization units in Tables 1 and 2.

TABLE 1

| Fluorine-containing polymer | | P1 | P2 | P3 | P4 | P5 | P6 | P7 | P8 | P9 | P10 | P11 | P12 |
|---|---|---|---|---|---|---|---|---|---|---|---|---|---|
| Fluorine-containing polymer | HFP | 50 | 50 | 50 | 50 | 50 | 50 | 50 | 45 | 40 | 50 | 50 | 50 |
| components (molar fraction) (%) | M1-(1) | | | | | | | | | | 15 | | 10 |
| | M1-(5) | | | | | | | | | | | 15 | |
| | M2-(3) | | | | | | | | 5 | 10 | | | |
| | HEVE | 50 | 50 | 50 | 40 | 40 | 40 | 45 | 35 | 50 | | | |
| | HBVE | | | | | | | | | | 35 | 35 | 15 |
| | HHVE | | | | | | | | | | | | |
| | DEGVE | | | | | | | | | | | | |
| | HMcHVE | | | | | | | | | | | | |
| | EVE | | | | 10 | 10 | 10 | | | | | | 25 |
| | cHVE | | | | | | | 5 | | | | | |
| | tBuVE | | | | | | | | 15 | | | | |
| | VAc | | | | | | | | | | | | |
| Polysiloxane-containing polymer | FM-0721 | | | | | | 6 | | | | | | 4 |
| components (mass %) | FM-0725 | | 1.7 | | 4.9 | | | | 5.1 | | | | |
| | VPS-0501 | | | | | 3.4 | | | | | 1.7 | | |
| | VPS-1001 | | | 2.7 | | | | | | 1 | | | |

| | | | | | | | | | | | | |
|---|---|---|---|---|---|---|---|---|---|---|---|---|
| Number average molecular weight (×10,000) | 1.5 | 1.7 | 2.1 | 4.5 | 2.8 | 2.5 | 1.8 | 3.5 | 4.1 | 2.5 | 1.4 | 32 |

TABLE 2

| Fluorine-containing polymer | | P13 | P14 | P15 | P16 | P17 | P18 | P19 | P20 | P21 | P22 | P23 | P24 |
|---|---|---|---|---|---|---|---|---|---|---|---|---|---|
| Fluorine-containing polymer | HFP | 50 | 50 | 50 | 50 | 40 | 50 | 45 | 50 | 50 | 50 | 50 | 40 |
| components (molar fraction) (%) | M1-(1) | | | 5 | | | 10 | | | | | | |
| | M1-(5) | | | | | | | | | | | | 10 |
| | M2-(3) | | | | | 10 | | 5 | | | | | |
| | HEVE | | | | | | | | | | | | |
| | HBVE | | | | | | | | | | | | |
| | HHVE | 13 | 35 | 40 | 35 | | | | | | | | |
| | DEGVE | | | | | 40 | 25 | 15 | 30 | | | | |
| | HMcHVE | | | | | | | | | 40 | 25 | 25 | 35 |
| | EVE | | | | 15 | 10 | | | | 10 | | | |
| | cHVE | 37 | | | | | | | 20 | | 25 | | |
| | tBuVE | | | 5 | | | 15 | | | | | 10 | 15 |
| | VAc | | 15 | | | | | 35 | | | | 15 | |
| Polysiloxane-containing polymer | FM-0721 | | | | 5 | | | | | | | | |
| components (mass %) | FM-0725 | | | 4.1 | | 3.6 | | | | 2.9 | 7.3 | | 4.8 |
| | VPS-0501 | 5 | | | | | | 8 | | | | | |
| | VPS-1001 | | 4.9 | | | | 0.9 | | 9.7 | | | | |

| | | | | | | | | | | | | |
|---|---|---|---|---|---|---|---|---|---|---|---|---|
| Number average molecular weight (×10,000) | 2.6 | 3.4 | 3.9 | 2.9 | 3.5 | 2.8 | 3.1 | 4.5 | 3.6 | 4.2 | 1.8 | 4.5 |

In the tables, the molar ratios of respective components are shown for the fluorine-containing polymer components. The abbreviations are as follows:

HFP: hexafluoropropylene,

M1-(1): perfluoromethyl vinyl ether,

M1-(5): perfluoropentyl vinyl ether,

M2-(3): heptafluoropropyltrifluoro vinyl ether,

HEVE: 2-hydroxyethyl vinyl ether,

HBVE: 4-hydroxybutyl vinyl ether,

HHVE: 6-hydroxyhexyl vinyl ether,

DEGVE: diethylene glycol monovinyl ether,

HMcHVE: 4-(hydroxymethyl)cyclohexyl methyl vinyl ether,

EVE: ethyl vinyl ether,

cHVE: cyclohexyl vinyl ether,

tBuVE: t-butyl vinyl ether, and

VAc: vinyl acetate.

As for the components containing a polysiloxane structure, the names of polysiloxane-containing components used for the synthesis reaction, and the mass percentage of each polysiloxane structure-containing structural unit based on the total amount of the polymer are described. The abbreviations are as follows:

FM-0721: “Silaplane FM-0721” {manufactured by Chisso Corporation}

FM-0725: “Silaplane FM-0725” (the same as above)

VPS-1001: Macroazo initiator “VPS-1001” {manufactured by Wako Pure Chemical Industries, Ltd.}

VPS-0501: Macroazo initiator “VPS-0501” (the same as above)

(Synthesis of Fluorine-containing Polymer)

The synthesis of the fluorine-containing polymer for use in the invention can be carried out by various polymerization methods of, for example, solution polymerization, suspension polymerization, precipitation polymerization, bulk polymerization, and emulsion polymerization. Further, the synthesis can be carried out through known operations of batch, semi-continuous, continuous, and other types.

The methods for initiating polymerization include a method using a radical initiator, a method in which light or radiation is applied, and other methods. These polymerization methods and the methods for initiating polymerization are described, for example, in Teiji Tsuruta, Polymer Synthesis Method (KOUBUNSHI GOSEI HOUHOU), revised edition, (published by The Nikkan Kogyo Shimbun, Ltd., 1971), and Experiment Method of Polymer Synthesis (KOUBUNSHI GOUSEI NO JIKKEN HOUHOU) written by Takayuki Ootsu and Masaetsu Kinoshita, and published by Kagaku-Dojin Publishing Company, INC., 1972, pages 124 to 154.

Out of the above-described polymerization methods, the solution polymerization method using a radical initiator is particularly preferred. Examples of the solvent for use in the solution polymerization method may include: various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol, which may be used singly or as a mixture of two or more thereof, or further may be used as a mixed solvent with water.

The polymerization temperature is required to be set in association with the molecular weight of a resultant polymer, the kind of the initiator, and the like. It may be 0° C. or less to 100° C. or more. However, polymerization is preferably carried out at a temperature in the range of 40 to 100° C.

The reaction pressure can be appropriately selected. Desirably, it is generally about 0.01 to 10 MPa, preferably 0.05 to 5 MPa, more preferably 0.1 to 2 MPa. The reaction time is about 5 to 30 hours.

The resulting polymer can be employed still in the reaction solution form for use in the invention, or can also be purified by reprecipitation or a liquid separation operation to be used.

[Organosilane Compound]

The functional layer in the antireflection film of the invention is preferably allowed to contain a hydrolysate and/or a partial condensate of an organosilane compound, or the like (the resulting reaction solution is also hereinafter referred to as a “sol component”) from the viewpoint of the scratch resistance.

The sol component functions as a binder by coating the curable composition, followed by condensation by drying and heating steps to form a cured product. Whereas, when it has a multifunctional acrylate polymer, a binder having a three dimensional structure is formed through irradiation with an active ray.

The organosilane compound is preferably the one expressed by the following formula (5):
(R³⁰)_{m1—Si(X}³¹)₄₋ₘₗ Formula (5):

In the formula (5), R³⁰ represents a substituted or unsubstituted alkyl group, or a substituted or unsubstituted aryl group. As alkyl groups, mention may be made of methyl, ethyl, propyl, isopropyl, hexyl, decyl, hexadecyl, and the like. As alkyl groups, mention may be made of preferably the ones with 1 to 30 carbon atoms, more preferably the ones with 1 to 16 carbon atoms, and in particular preferably the ones with 1 to 6 carbon atoms. As aryl groups, mention may be made of phenyl, naphthyl, and the like, and preferably a phenyl group.

X³¹ represents a hydroxyl group or a hydrolyzable group. Examples thereof may include an alkoxy group (an alkoxy group having 1 to 6 carbon atoms is preferred, and examples thereof may include a methoxy group and an ethoxy group), a halogen atom (e.g., Cl, Br, or I), and a group represented by R³¹COO (where R³¹ is preferably a hydrogen atom, or an alkyl group having 1 to 5 carbon atoms, examples of which may include CH₃COO and C₂H₅COO). It is preferably an alkoxy group, and in particular preferably a methoxy group or an ethoxy group.

m1 represent an integer of 1 to 3, preferably 1 or 2, and in particular preferably 1.

When a plurality of R³⁰'s or X³¹'s are present, a plurality of R³⁰'s or X³¹'s may be the same or different.

The substituent contained in R³⁰ has no particular restriction. However, mention may be made of a halogen atom (such as fluorine, chlorine, or bromine), a hydroxyl group, a mercapto group, a carboxyl group, an epoxy group, an alkyl group (such as methyl, ethyl, i-propyl, propyl, or t-butyl), an aryl group (such as phenyl or naphthyl), an aromatic heterocyclic group (such as furyl, pyrazolyl, or pyridyl), an alkoxy group (such as methoxy, ethoxy, i-propoxy, or hexyloxy), an aryloxy group (such as phenoxy), an alkylthio group (such as methylthio or ethylthio), an arylthio group (such as phenylthio), an alkenyl group (such as vinyl or 1-propenyl), an acyloxy group (such as acetoxy, acryloyloxy, or (meth)acryloyl), an alkoxycarbonyl group (such as methoxycarbonyl or ethoxycarbonyl), an aryloxycarbonyl group (such as phenoxycarbonyl), a carbamoyl group (such as carbamoyl, N-methylcarbamoyl, N,N-dimethylcarbamoyl, or N-methyl-n-octylcarbamoyl), an acylamino group (such as acetylamino, benzoylamino, acrylamino, or methacrylamino), or the like. These substituents may be further substituted.

When a plurality of R³⁰'s are present, it is preferable that at least one is a substituted alkyl group or a substituted aryl group.

Out of the organosilane compounds represented by the formula (5), an organosilane compound having a vinyl polymerizable substituent represented by the following formula (5-1) is preferred.

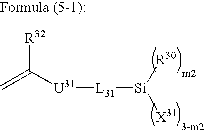

In the formula (5-1), R³² represents a hydrogen atom, a methyl group, a methoxy group, an alkoxycarbonyl group, a cyano group, a fluorine atom, or a chlorine atom. As an alkoxycarbonyl group, mention may be made of a methoxycarbonyl group, an ethoxycarbonyl group, or the like. A hydrogen atom, a methyl group, a methoxy group, a methoxycarbonyl group, a cyano group, a fluorine atom, and a chlorine atom are preferred, a hydrogen atom, a methyl group, a methoxycarbonyl group, a fluorine atom, and a chlorine atom are further preferred, and a hydrogen atom and a methyl group are particularly preferred.

U³¹ represents a single bond, or *—COO—**, *—CONH—**, or *—O—**. A single bond, *—COO—**, and *—CONH—** are preferred, a single bond and *—COO—** are further preferred, and *—COO—* is particularly preferred. * represents the linking site to ═C(R³²)—, and * * represents the linking site to L₃₁.

L₃₁ represents a divalent linking chain. Specifically, mention may be made of a substituted or unsubstituted alkylene group, a substituted or unsubstituted arylene group, a substituted or unsubstituted alkylene group having therein a linking group (e.g., ether, ester, or amido), a substituted or unsubstituted arylene group having therein a linking group. A substituted or unsubstituted alkylene group, a substituted or unsubstituted arylene group, and an alkylene group having therein a linking group are preferred, an unsubstituted alkylene group, an unsubstituted arylene group, an alkylene group having therein an ether or ester linking group are further preferred, and an unsubstituted alkylene group, and an alkylene group having therein an ether or ester linking group are particularly preferred. As the substituents, mention may be made of halogen, a hydroxyl group, a mercapto group, a carboxyl group, an epoxy group, an alkyl group, an aryl group, and the like. These substituents may be further substituted.

m2 represents 0 or 1, and preferably 0. When a plurality of X³¹'s are present, a plurality of X³¹'s may be respectively the same of different.

R³⁰ has the same definition as that of R³⁰ in the formula (5), and it is preferably a substituted or unsubstituted alkyl group or an unsubstituted aryl group, and further preferably an unsubstituted alkyl group or an unsubstituted aryl group.

X³¹ has the same definition as that of X³¹ in the formula (5), and it is preferably a halogen atom, a hydroxyl group, or an unsubstituted alkoxy group, further preferably a chlorine atom, a hydroxyl group, or an unsubstituted alkoxy group having 1 to 6 carbon atoms, further preferably a hydroxyl group or an alkoxy group having 1 to 3 carbon atoms, and particularly preferably a methoxy group.

The compounds of the formula (5) and the formula (5-1) may be used in combination of two or more thereof.

Below, non-limiting specific examples of the compounds represented by the formula (5) and the formula (5-1) will be shown.

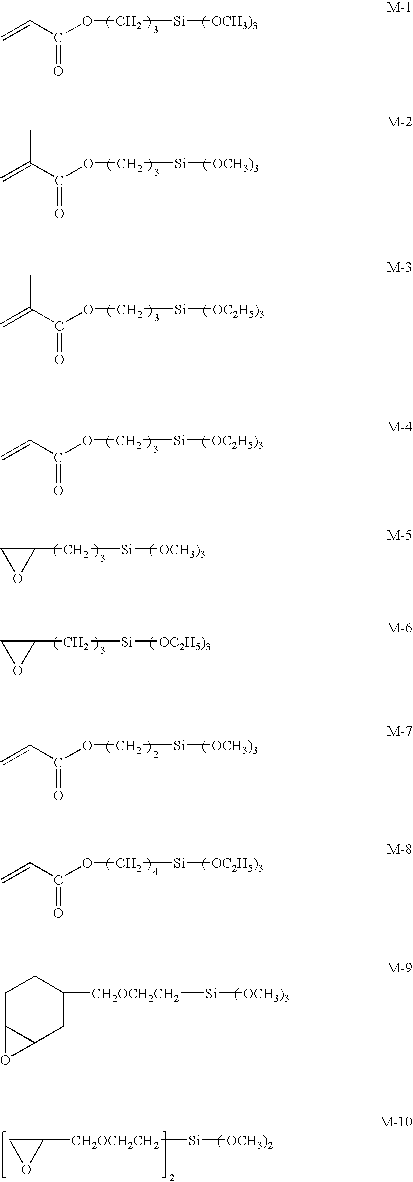

In these compounds, (M-1), (M-2), and (M-5) are particularly preferred.

[Catalyst for Use in Organosilane Compound]

Then, the hydrolysate and/or a partial condensate of the organosilane compound is generally produced by treating the organosilane compound in the presence of a catalyst.

As the catalysts, mention may be made of inorganic acids such as hydrochloric acid, sulfuric acid, and nitric acid; organic acids such as oxalic acid, acetic acid, formic acid, methanesulfonic acid, and toluenesulfonic acid; inorganic bases such as sodium hydroxide, potassium hydroxide, and ammonia; organic bases such as triethylamine and pyridine; metal alkoxides such as triisopropoxy aluminum and tetrabutoxy zirconium; a metal chelate compound having a metal such as Zr, Ti, or Al as a center metal; and the like. In the invention, the metal chelate compounds, and acid catalysts of inorganic acids and organic acids are preferably used. In the inorganic acids, hydrochloric acid and sulfuric acid are preferred. In the organic acids, the ones having an acid dissociation constant in water {pKa value (25° C.)} of 4.5 or less are preferred. Further, hydrochloric acid, sulfuric acid, an organic acid having an acid dissociation constant in water of 3.0 or less are preferred. Particularly, hydrochloric acid, sulfuric acid, an organic acid having an acid dissociation constant in water of 2.5 or less are preferred. An organic acid having an acid dissociation constant in water of 2.5 or less is further preferred. Specifically, methanesulfonic acid, oxalic acid, phthalic acid, and malonic acid are further preferred, and oxalic acid is particularly preferred.

(Metal Chelate Compound)

A metal chelate compound can be preferably used without particular restriction so long as it has alcohol represented by the formula R⁴¹OH (where in the formula, R⁴¹ represents an alkyl group having 1 to 10 carbon atoms), and a compound represented by R⁴²COCH₂COR⁴³ (where in the formula, R⁴² represents an alkyl group having 1 to 10 carbon atoms, and R⁴³ represents an alkyl group having 1 to 10 carbon atoms or an alkoxy group having 1 to 10 carbon atoms) as ligands, and has a metal selected from Zr, Ti, and Al as a center metal. Within this scope, two or more metal chelate compounds may be used in combination.

The metal chelate compound for use in the invention is preferably the one selected from the compound group represented by the formulae Zr(OR⁴¹)ₛ₁(R⁴²COCHCOR⁴³)ₛ₂, Ti(OR⁴¹)ₜ₁(R⁴²COCHCOR⁴³)ₜ₂, and Al(OR⁴¹)ᵤ₁(R⁴²COCHCOR⁴³)ᵤ₂, and has an action of promoting the condensation reaction of the hydrolysate and/or the partial condensate of the organosilane compound.

R⁴¹ and R⁴² in the metal chelate compound may be the same or different, and are each an alkyl group having 1 to 10 carbon atoms, specifically, an ethyl group, a n-propyl group, a 1-propyl group, a n-butyl group, a s-butyl group, a t-butyl group, a n-pentyl group, a phenyl group, or the like. Whereas, R⁴³ is, other than the same alkyl group having 1 to 10 carbon atoms as described above, an alkoxy group having 1 to 10 carbon atoms, such as a methoxy group, an ethoxy group, a n-propoxy group, a 1-propoxy group, a n-butoxy group, a s-butoxy group, a t-butoxy group, or the like. Whereas, s1, s2, t1, t2, u1, and u2 in the metal chelate compound respectively represent integers determined so as to satisfy s1+s2=4, t1+t2=4, and u1+u2=3.

Specific examples of the metal chelate compounds may include zirconium chelate compounds such as zirconium tri-n-butoxy ethyl acetoacetate, zirconium di-n-butoxy bis(ethyl acetoacetate), zirconium n-butoxy tris(ethyl acetoacetate), zirconium tetrakis(n-propyl acetoacetate), zirconium tetrakis(acetyl acetoacetate), and zirconium tetrakis(ethyl acetoacetate); titanium chelate compounds such as titanium diisopropoxy bis(ethyl acetoacetate), titanium diisopropoxy bis(acetyl acetoacetate), and titanium diisopropoxy bis(acetyl acetonate); aluminum chelate compounds such as aluminum diisopropoxy ethyl acetoacetate, aluminum diisopropoxy acetyl acetonate, aluminum isoprpoxy bis(ethyl acetoacetate), aluminum isoprpoxy bis(acetyl acetonate), aluminum tris(ethyl acetoacetate), aluminum tris(acetyl acetonate), and aluminum monoacetyl acetonate bis(ethyl acetoacetate).

Out of these metal chelate compounds, zirconium tri-n-butoxy ethyl acetoacetate, titanium diisopropoxy bis(acetyl acetonate), aluminum diisopropoxy ethyl acetoacetate, and aluminum tris(ethyl acetoacetate) are preferred. These metal chelate compounds can be used singly alone, or in combination of two or more thereof. Whereas, the partial hydrolysates of these metal chelate compounds can also be used.

(β-Diketone Compound and β-keto Ester Compound)

Whereas, in the invention, preferably, to the curable composition, a β-diketone compound and/or a β-keto ester compound is further added. Below, this will be further described.

The one for use in the invention is a β-diketone compound and/or a β-keto ester compound represented by the formula R⁴²COCH₂COR⁴³, and serves as a stability improver for a curable composition for use in the invention. Herein, R⁴² represents an alkyl group having 1 to 10 carbon atoms, and R⁴³ represents an alkyl group having 1 to 10 carbon atoms or an alkoxy group having 1 to 10 carbon atoms. Namely, conceivably, the compound coordinates with the metal atoms in the metal chelate compound (zirconium, titanium, and/or aluminum compound ), thereby to suppress the action of promoting the condensation reaction of the hydrolysate and/or the partial condensate of an organosilane compound by the metal chelate compound, and functions as improving the storage stability of the resulting composition. R⁴² and R⁴³ forming the β-diketone compound and/or the β-keto ester compound are the same as R⁴² and R⁴³ forming the metal chelate compound.

Specific examples of the β-diketone compound and/or the β-keto ester compound may include acetylacetone, methyl acetoacetate, ethyl acetoacetate, n-propyl acetoacetate, i-propyl acetoacetate, n-butyl acetoacetate, s-butyl acetoacetate, t-butyl acetoacetate, 2,4-hexane-dione, 2,4-heptane-dione, 3,5-heptane-dione, 2,4-octane-dione, 2,4-nonane-dione, and 5-methylhexane-dione. Out of these, ethyl acetoacetate and acetylacetone are preferred, and particularly, acetylacetone is preferred. These β-diketone compounds and/or β-keto ester compounds may be used singly alone, or in mixture of two or more thereof. In the invention, the β-diketone compound and/or the β-keto ester compound is used in an amount of 1 mol, preferably 2 mol or more, and more preferably 3 to 20 mol per mole of the metal chelate compound. Use of the compound in an amount of 2 mol or more can prevent the storage stability of the resulting composition from being reduced, and hence it is preferred.

The amount of the organosilane compound to be added is preferably 0.1 to 50 mass %, more preferably 0.5 to 20 mass %, and most preferably 1 to 10 mass % based on the total solid content of the layer formed by coating the curable composition on a support, such as a low refractive index layer.

The organosilane compound may be directly added to a curable composition (a layer formed on a support, such as a coating solution for forming an antiglare layer, a low refractive index layer, or the like). However, preferably, the organosilane compound is previously treated in the presence of a catalyst to prepare the hydrolysate and/or the partial condensate of the organosilane compound, and the curable composition is prepared using the resulting reaction solution (sol solution). In the invention, preferably, first, a composition containing the hydrolysate and/or the partial condensate of the organosilane compound, and a metal chelate compound is prepared. The solution obtaining by adding a β-diketone compound and/or a β-keto ester compound thereto is allowed to be contained in a coating solution for at least one layer of an antiglare layer or a low refractive index layer, and coated.

[Other Binder Compounds]

With the foregoing binder forming the functional layer in the antireflection film of the invention, for example, the following reactive organic silicon compounds described in JP-A-2003-39586 can also be used in combination. The reactive organic silicon compound is used in an amount in the range of 10 to 100 mass % based on the total amount of an ionizing radiation curable compound and a reactive organic silicon compound. Particularly when the following ionizing radiation curable organic silicon compound is used, it is possible to form a electrically conductive layer using only this as a resin component.

[Reactive Organic Silicon Compound]

(Silicon Alkoxide)

Silicon alkoxide corresponds to a compound represented by the formula (5), where X³¹ is an alkoxy group (OR³²), and R³⁰ and R³² each represent an alkyl group having 1 to 10 carbon atoms. Examples of these compounds may include tetramethoxysilane, tetraethoxysilane, tetra-i-propoxysilane, tetra-n-propoxysilane, tetra-n-butoxysilane, tetra-s-butoxysilane, tetra-t-butoxysilane, tetrapentaethoxysilane, tetrapenta-1-propoxysilane, tetrapenta-n-propoxysilane, tetrapenta-n-butoxysilane, tetrapenta-s-butoxysilane, tetrapenta-t-butoxysilane, methyl trimethoxysilane, methyl triethoxysilane, methyl tripropoxysilane, methyl tributoxysilane, dimethyl dimethoxysilane, dimethyl diethoxysilane, dimethylethoxysilane, dimethyl methoxysilane, dimethylpropoxysilane, dimethyl butoxysilane, methyl dimethoxysilane, methyl diethoxysilane, and hexyl trimethoxysilane.

(Silane Coupling Agent)

Examples of the silane coupling agent may include γ-(2-amino ethyl)amino propyl trimethoxysilane, γ-(2-amino ethyl)amino propyl methyl dimethoxysilane, β-(3,4-epoxy cyclohexyl)ethyl trimethoxysilane, γ-amino propyl triethoxysilane, γ-methacryloxy propyl trimethoxysilane, N-β-(N-vinyl benzylamino ethyl)-γ-amino propyl methoxysilane/hydrochloric acid salt, γ-glycidoxy propyl trimethoxysilane, amino silane, methyl trimethoxysilane, vinyl triacetoxysilane, γ-mercapto propyl trimethoxysilane, γ-chloropropyl trimethoxysilane, hexamethyl disilazane, vinyl tris(β-methoxyethoxy)silane, octadecyl dimethyl[3-(trimethoxy silyl)propyl]ammonium chloride, methyl trichlorosilane, and dimethyl dichlorosilane.

(Ionizing Radiation Curable Silicon Compound)

Mention may be made of organic silicon compound with a molecular weight of 5,000 or less, having a plurality of groups reacting and crosslinking through ionizing radiation, such as polymerizable double bond groups. As such reactive organic silicon compound, mention may be made of mono-terminal vinyl functional polysilane, bi-terminal vinyl functional polysilane, mono-terminal vinyl functional polysiloxane, bi-terminal vinyl functional polysiloxane, or vinyl functional polysilanes or vinyl functional polysiloxanes resulting from the reactions of these compounds, or the like.

(Other Compounds)

As other compounds, mention may be made of (meth)acryloxy silane compounds such as 3-(meth)acryloxy propyl trimethoxysilane, and 3-(meth)acryloxy propyl methyl dimethoxy silane, and the like.

1-2. Radical Polymerization Initiator

Polymerization of various monomers having ethylenically unsaturated groups for use in the invention can be carried out through irradiation with ionizing radiation or heating in the presence of a radical photopolymerization initiator or a heat radical polymerization initiator. For forming the antireflection film of the invention, a radical photopolymerization initiator and a heat radical polymerization initiator can be used in combination.

[Radical Photopolymerization Initiator]

As radical photopolymerization initiators, mention may be made of acetophenones, benzoins, benzophenones, phosphine oxides, ketals, anthraquinones, thioxanthones, azo compounds, peroxides (the ones described in JP-A-2001-139663, and the like), 2,3-dialkyldione compounds, disulfide compounds, fluoroamine compounds, aromatic sulfoniums, lophine dimers, onium salts, borates, active esters, active halogens, inorganic complexes, coumarins, and the like.

Examples of acetophenones may include: 2,2-dimethoxy acetophenone, 2,2-diethoxy acetophenone, p-dimethyl acetophenone, 1-hydroxy-dimethyl phenyl ketone, 1-hydroxy dimethyl-p-isopropyl phenyl ketone, 1-hydroxy cyclohexyl phenyl ketone, 2-methyl-4-methylthio -2-morpholino propiophenone, 2-benzyl-2-dimethylamino-1-(4-morpholino phenyl)-butanone, 4-phenoxy dichloro acetophenone, and 4-t-butyl dichloro acetophenone.

Examples of benzoins may include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether, and benzoin isopropyl ether.

Examples of benzophenones may include benzophenone, hydroxy benzophenone, 4-benzoyl-4′-methyl diphenyl sulfide, 2,4-dichlorobenzophenone, 4,4-dichlorobenzophenone, and p-chlorobenzophenone, 4,4′-dimethylamino benzophenone (Michler's ketone), and 3,3,4,4′-tetra(t-butyl peroxycarbonyl)benzophenone.

Examples of phosphine oxides may include 2,4,6-trimethyl benzoyl diphenyl phosphine oxide.

Examples of active esters may include IRGACURE OXE01 (1,2-octanedione, 1-[4-(phenylthio)-,2-(O-benzoyl oxime)]; produced by Ciba Specialty Chemicals), sulfonic acid esters, and cyclic active ester compounds. Specifically, the compounds 1 to 21 described in Examples of JP-A-2000-80068 are particularly preferred.

Examples of onium salts may include aromatic diazonium salts, aromatic iodonium salts, and aromatic sulfonium salts.

As active halogens, specifically, mention may be made of the compounds described in Bull. Chem. Soc. Japan by Wakabayashi et al., vol. 42, page 2924 (1969), U.S. Pat. No. 3,905,815, JP-A-5-27830, Journal of Heterocyclic Chemistry by M. P. Hutt, vol. 1 (No. 3), (1970), and the like. Particularly, mention may be made of a trihalomethyl group-substituted oxazole compound: s-triazine compound. More preferably, mention may be made of a s-triazine derivative in which at least one mono-, di-, or tri-halogen-substituted methyl group is linked to the s-triazine ring.

As specific examples thereof, S-triazine and an oxathiazole compound are known. Examples thereof may include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetic acid ester)amino)phenyl)-4,6-bis(trichloromethyl)-s-triazine, and 2-trihalomethyl-5-(p-methoxyphenyl)-1,3,4-oxadiazole. Specifically, the compounds in p. 14 to p. 30 of JP-A-58-15503, p. 6 to p. 10 of JP-A-55-77742, Nos. 1 to 8 described on p. 287 of JP-B-60-27673, Nos. 1 to 17 on p. 443 and p. 444 of JP-A-60-239736, Nos. 1 to 19 of U.S. Pat. No. 4,701,399, and the like are particularly preferred.

Examples of borate salt may include the compounds described as organic borate salts in Japanese Patent No. 2764769, JP-A-2002-116539, and, Kunz, Martin Rad Tech'98. Proceeding April, pages 19 to 22, 1998, Chicago, and the like. For example, mention may be made of the compounds described in paragraph Nos. [0022] to [0027] of JP-A-2002-116539. Whereas, specific examples of other organic boron compounds may include the organic boron transition metal-coordinated complexes in JP-A-6-348011, JP-A-7-128785, JP-A-7-140589, JP-A-7-306527, JP-A-7-292014, and the like. Specifically, mention may be made of ion complexes with cationic coloring matters.

Examples of inorganic complexes may include bis(η⁵-2,4-cyclopentadiene-1-yl)-bis[2,6-difluoro-3-(1H-pyrrole-1-yl)-phenyl]titanium. Examples of coumarins may include 3-ketocoumarin.

These initiators may be used alone or in mixture thereof.

As the radical photopolymerization initiators, other than the foregoing ones, various examples are described in SAISHIN UV KOUKA GIJYUTSU, {Technical Information Institute Co., Ltd.} (1991), p. 159, and SHIGAISEN KOUKA SYSTEM, written by Kiyomi Kato, {published by SOGO GIJYUTSU CENTER CO.}, p. 65 to 148, and are useful for the invention.

Preferred examples of commercially available radical photopolymerization initiators may include “KAYACURE-DETX-S”, “KAYACURE-BP-100”, “KAYACURE-BDMK”, “KAYACURE-CTX”, “KAYACURE-BMS”, “KAYACURE-2-EAQ”, “KAYACURE-ABQ”, KAYACURE-CPTX”, “KAYACURE-EPD”, “KAYACURE-ITX”, “KAYACURE-QTX”, “KAYACURE-BTC”, “KAYACURE-MCA”, and the like manufactured by NIPPON KAYAKU Co., Ltd.; “IRGACURE 651”, “IRGACURE 184”, “IRGACURE 500”, “IRGACURE 819”, “IRGACURE 907”, “IRGACURE 369”, “IRGACURE 1173”, “IRGACURE 1870”, “IRGACURE 2959”, “IRGACURE 4265”, “IRGACURE 4263”, and the like manufactured by Ciba Specialty Chemicals; “Esacure (KIP 100F, KB1, EB3, BP, X33, KT046, KT37,KIP 150, TZT)”, and the like manufactured by Sartomer Company, and combinations thereof.

The photopolymerization initiator is used in an amount preferably in the range of 0.1 to 15 parts by mass, and more preferably in the range of 1 to 10 parts by mass per 100 parts by mass of the multifunctional monomer.

[Photosensitizer]

In addition to the photopolymerization initiator, a photosensitizer may also be used. Specific examples of the photosensitizer may include n-butylamine, triethylamine, tri-n-butylphosphine, Michler's ketone, and thioxanthone.

Further, aids such as an azido compound, a thiourea compound, and a mercapto compound may be used in combination of one or more thereof.

As the commercially available photosensitizers, mention may be made of KAYACURE (DMBI or EPA) manufactured by NIPPON KAYAKU Co., Ltd., and the like.

[Heat Radical Polymerization Initiator]

As the heat radical polymerization initiators, organic or inorganic peroxides, organic azo and diazo compounds, and the like are usable.

Specifically, mention may be made of: organic peroxides such as benzoyl peroxide, halogen benzoyl peroxide, lauroyl peroxide, acetyl peroxide, dibutyl peroxide, cumene hydroperoxide, and butyl hydroperoxide, inorganic peroxides such as hydrogen peroxide, ammonium persulfate, and potassium persulfate, azo compounds such as 2,2′-azobis(isobutyronitrile), 2,2′-azobis(propionitrile), and 1,1′-azobis(cyclohexanecarbonitrile), and diazo compounds such as diazoaminobenzene and p-nitrobenzene diazonium, and the like.

1-3. Crosslinkable Compound (Crosslinking Agent)

[Curing Agent]

A low refractive index layer which is one of the functional layers in the invention is preferably formed by using a curable composition containing a fluorine-containing polymer containing a hydroxyl group, and a compound (curing agent) capable of reacting with the hydroxyl group in the fluorine-containing polymer, a so-called curable resin composition. The curing agent preferably has two or more, and further preferably 4 or more moieties reacting with a hydroxyl group.

The structure of the curing agent has no particular restriction so long as it is the one having the foregoing number of functional groups capable of reacting with a hydroxyl group. Examples thereof may include polyisocyanates, a partial condensate of an isocyanate compound, multimers, adducts with polyhydric alcohols, low molecular weight polyester films, and the like, a blocked polyisocyanate compound obtained by blocking an isocyanate group by a blocking agent such as phenol, aminoplasts, and polybasic acids or anhydrides thereof.

[Aminoplasts]

Out of these, in the invention, from the viewpoint of the compatibility between the stability during storage and the activity of the crosslinking reaction, and from the viewpoint of the strength of the film to be formed, aminoplasts which undergo a crosslinking reaction with a hydroxyl group-containing compound under acidic conditions are preferred. Aminoplasts are each a compound containing an amino group capable of reacting with the hydroxyl group present in a fluorine-containing polymer, i.e., a hydroxyalkylamino group or an alkoxyalkylamino group, or a carbon atom adjacent to a nitrogen atom, and substituted with an alkoxy group. Specific examples thereof may include melamine type compounds, urea type compounds, and benzoguanamine type compounds.

The melamine type compounds are generally known as the compounds having a skeleton in which a nitrogen atom is linked to the triazine ring. Specifically, mention may be made of melamine, alkylated melamine, methylol melamine, alkoxylated methyl melamine, and the like. Particularly, methylolated melamine obtained by allowing melamine and formaldehyde to react with each other under basic conditions, alkoxylated methyl melamines, and derivatives thereof are preferred. Particularly, alkoxylated methyl melamines are particularly preferred from the viewpoint of storage stability. Whereas, the methylolated melamines and alkoxylated methyl melamines have no particular restriction, and can be obtained by, for example, the method described in Plastic Zairyo Kouza [8]Urea/Melamine Resin, (Nikkan Kogyo Shimbun Ltd.). Various resins can also be used.

Whereas, as the urea compounds, other than urea, polymethylolated urea and alkoxylated methylurea which is a derivative thereof, and further compounds having a glycol uryl skeleton or 2-imidazolidinone skeleton which is a cyclic urea structure are also preferred. Also for the amino compounds such as the urea derivatives, various resins described in the Urea/Melamine Resin, and the like can be used.

In the invention, as the compounds to be preferably used as a crosslinking agent, particularly melamine compounds or glycol uryl compounds are preferred from the viewpoint of the compatibility with a fluorine-containing copolymer. Out of these, from the viewpoint of the reactivity, the crosslinking agent is preferably a compound containing nitrogen atoms in the molecule, and containing two or more carbon atoms, each substituted with an alkoxy group adjacent to each of the nitrogen atoms. Particularly preferred compounds are the compounds having the structures represented by the following (H-1) and (H-2), and partial condensates thereof. In the formulae, R represents an alkyl group having 1 to 6 carbon atoms or a hydroxyl group.

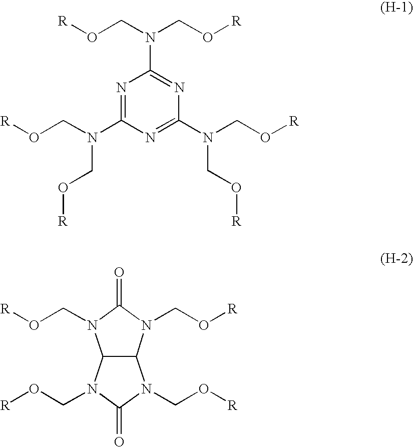

The amount of aminoplast to be added to the fluorine-containing polymer is 1 to 50 parts by mass, preferably 3 to 40 parts by mass, and further preferably 5 to 30 parts by mass per 100 parts by mass of the copolymer. When the amount is 1 part by mass or more, the durability as a thin film can be sufficiently exerted. When the amount is 50 parts by mass or less, the low refractive index can be kept, and hence the amount is preferred. From the viewpoint of keeping the refractive index low even when a curing agent is added, a curing agent which causes less increase in refractive index even when added is preferred. From the viewpoint, out of the foregoing compounds, the compounds having the skeleton represented by H-2 are more preferred.

[Curing Catalyst]

For the antireflection film of the invention, a composition for forming a low refractive index layer is coated, and then, the film is cured by the crosslinking reaction of the hydroxyl group of the fluorine-containing polymer and the curing agent with heating. In this system, curing is promoted by an acid. Therefore, to a curable resin composition, an acidic substance is desirably added. However, addition of a general acid promotes the crosslinking reaction even in the coating solution, which causes failures (such as inconsistencies or cissing). Therefore, in order to ensure the compatibility of the storage stability and the curing activity in the thermal curing system, a compound generating an acid by heating (which is hereinafter also referred to as a thermal acid generator) is added as a curing catalyst.

[Salt Formed From an Acid and an Organic Base]

The curing catalyst for use in the invention is a salt formed from an acid and an organic base. As the acids, mention may be made of organic acids such as sulfonic acid, phosphonic acid, and carboxylic acid, and inorganic acids such as sulfuric acid and phosphoric acid. From the viewpoint of the compatibility with a polymer, organic acids are more preferred, sulfonic acid and phosphonic acid are further preferred, and sulfonic acid is most preferred. As preferred sulfonic acids, mention may be made of p-toluenesulfonic acid (PTS), benzenesulfonic acid (BS), p-dodecyl benzenesulfonic acid (DBS), p-chlorobenzenesulfonic acid (CBS), 1,4-naphthalene disulfonic acid (NDS), methanesulfonic acid (MsOH), nonafluorobutane-1-sulfonic acid (NFBS), and the like. All can be preferably used (the term in the parentheses is the abbreviation).

The inventors focused their attention on the following fact: the curing catalyst largely changes according to (1) basicity and/or (2) boiling point of the organic base to be combined with an acid in terms of the compatibility between the storage stability and the curing activity in the thermal curing system. Thus, they completed the invention. Below, the items (1) and (2) will be described.

(Thermal Acid Generator)

In a first embodiment of the invention,

(1) The composition contains at least one salt formed from an organic base whose conjugate acid has a pKa of 5.0 to 10.5, and an acid.

A lower basicity of the organic base results in higher acid generation efficiency upon heating, and it is preferred from the viewpoint of the curing activity. However, too low basicity results in insufficient storage stability. Therefore, in the invention, an organic base having a proper basicity is used. When the basicity is expressed with the pKa of the conjugate acid as an index thereof, the pKa of the organic base for use in the invention is required to be 5.0 to 10.5, more preferably 6.0 to 10.0, and further preferably 6.5 to 10.0. The values of the pKa of organic bases are described in terms of the values in an aqueous solution in Kagaku Binran Kiso Hen (revised 5 edition, edited by the Chemical Society of Japan, Maruzen, 2004), vol. 2, II-pages 334 to 340. Therefore, it is possible to select an organic base having a proper pKa therefrom. Whereas, it is also possible to preferably use a compound which can be supposed to have the proper pKa even when there is no description thereon in the Kagaku Binran. Table 3 shows the pKa's of various compounds described in the Kagaku Binran. However, the ones with a pKa of 5.0 to 10.5 for use in the invention are not limited to the compounds described in Table 3.

TABLE 3

Organic base

| No. | Chemical name | pKa |
|---|---|---|
| b-1 | N,N-Dimethyl aniline | 5.1 |
| b-2 | Benzimidazole | 5.5 |
| b-3 | Pyridine | 5.7 |
| b-4 | 3-methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Dimethylpyridine | 7.0 |
| b-11 | Imidazole | 7.0 |
| b-12 | 2-Methyl imidazole | 7.6 |
| b-13 | 2-Ethyl morpholine | 7.7 |
| b-14 | 2-Methyl morpholine | 7.8 |
| b-15 | Bis(2-methoxyethyl)amine | 8.9 |
| b-16 | 2,2-Iminodiethanol | 9.1 |
| b-17 | N,N-dimethyl-2-aminoethanol | 9.5 |
| b-18 | Trimethylamine | 9.9 |

Below, the boiling points of the above-mentioned compounds are shown in the parentheses.

b-3: pyridine (115° C.), b-14: 4-methylmorpholine (115° C.), b-20: diallyl methylamine (111° C.), b-21: t-butylmethylamine (67 to 69° C.), b-22: dimethylisopropylamine (66° C.), b-23: diethylmethylamine (63 to 65° C.), b-24: dimethylethylamine (36 to 38° C.), b-18: trimethylamine (3 to 5° C.).

In a second embodiment of the invention,

(2) the composition contains at least one salt formed from a nitrogen-containing organic base with a boiling point of 35° C. or more and 85° C. or less, and an acid.

A lower boiling point of the organic base results in higher acid generation efficiency upon heating, and it is preferred from the viewpoint of the curing activity. Therefore, in the invention, an organic base having a proper boiling point is used.

The boiling point of the organic base for use in the invention is 35° C. or more and 85° C. or less. When it is equal to, or more than this temperature, deterioration of the scratch resistance is caused. Whereas, when the boiling point is less than 35° C., the coating solution becomes unstable. The boiling point is further preferably 45° C. or more and 80° C. or less, and most preferably 55° C. or more and 75° C. or less. Non-limiting examples of the compound for use in the invention may include the ones with a boiling point of 35° C. or more and 85° C. or less out of the compounds described in Table 3.

In the invention, when the salt is used as an acid catalyst, the salt formed from an acid and an organic base may be isolated and used. Alternatively, an acid and an organic base are mixed to form a salt in a solution, and the resulting solution may be used. Further, both acids and organic bases may be used alone respectively, or may be used in mixture of a plurality thereof. When an acid and an organic base are mixed to be used, these are mixed so that the equivalent ratio of the acid and the organic base is preferably 1:0.9 to 1.5, more preferably 1:0.95 to 1.3, and 1:1.0 to 1.1.

The ratio of the acid catalyst to be used is preferably 0.01 to 10 parts by mass, more preferably 0.1 to 5 parts by mass, and further preferably 0.2 to 3 parts by mass per 100 parts by mass of the fluorine-containing polymer in the curable resin composition.

(Photosensitive Acid Generator)

In the invention, other than the foregoing thermal acid generator, a compound generating an acid by light irradiation, i.e., a photosensitive acid generator may be further added. The photosensitive acid generator imparts the photosensitivity to the curable resin composition-coated film. For example, it is a substance which enables the film to be photocured by irradiation with radiation such as light.

As such a photosensitive acid generator, mention may be made of known compounds and mixtures thereof such as a photoinitiator for cation photopolymerization, a light decolorizing agent of dyes, a light discoloring agent, or known acid generators used in a microresist, or the like.

Typical examples of the photosensitive acid generator may include (1) various onium salts such as iodonium salts, sulfonium salts, phosphonium salts, diazonium salts, ammonium salts, iminium salts, pyridinium salts, arsonium salts, and selenonium salts, (preferably diazonium salts, iodonium salts, sulfonium salts, and iminium salts); (2) sulfone compounds such as β-keto ester and β-sulfonylsulfone, and α-diazo compounds thereof; (3) sulfonic acid esters such as alkyl sulfonic acid ester, haloalkyl sulfonic acid ester, aryl sulfonic acid ester, and imino sulfonate; (4) sulfonimide compounds; and (5)diazomethane compounds.

The photosensitive acid generators may be used alone, or in combination of two or more thereof. The ratio of the photosensitive acid generator to be used is preferably 0 to 20 parts by mass, more preferably 0.01 to 10 parts by mass, and further preferably 0.1 to 5 parts by mass per 100 parts by mass of the fluorine-containing polymer in the curable resin composition. When the ratio of the photosensitive acid generator is equal to, or less than the upper limit value, the resulting cured film becomes excellent in strength, and also is favorable in transparency. Therefore, such a ratio is preferred.

In addition, as specific compounds and use methods, the contents described in JP-A-2005-43876, and the like can be used.

1-4. Light Transmissive Particles

For the functional layers of the antireflection film of the invention, particularly, an antiglare layer or a hard coat layer, various light transmissive particles can be used in order to impart the antiglare property (surface scattering property) or internally scattering property thereto.

The light transmissive particles may be either organic particles or inorganic particles. The lesser the variations in particle diameter, the lesser the variations in scattering characteristics, which facilitates the design of the haze value. The light transmissive particles are preferably plastic beads, and particularly preferred are the ones which are high in transparency, and have a difference in refractive index from the binder falling within the numerical value range as described later.

The usable organic particles are polymethyl methacrylate particles (refractive index 1.49), crosslinked poly(acrylic-styrene) copolymer particles (refractive index 1.54), melamine resin particles (refractive index 1.57), polycarbonate particles (refractive index 1.57), polystyrene particles (refractive index 1.60), crosslinked polystyrene particles (refractive index 1.61), polyvinyl chloride particles (refractive index 1.60), benzoguanamine-melamine formaldehyde particles (refractive index 1.68), and the like. As the inorganic particles, mention may be made of silica particles (refractive index 1.44), alumina particles (refractive index 1.63), zirconia particles, titania particles, or inorganic particles having hollows and pores.

Out of these, crosslinked polystyrene particles, crosslinked poly(meth)acrylate particles, crosslinked poly(acrylic-styrene) particles are preferably used. The refractive index of the binder is adjusted in accordance with the refractive index of each light transmissive particle selected from these particles. This can achieve the internal haze, and the surface haze in the invention, and further can allow the centerline average roughness to fall within the preferred range.

Further, a binder containing a three- or more functional (meth)acrylate monomer as a main component (with a refractive index after curing of 1.50 to 1.53) and light transmissive particles including crosslinked poly(meth)acrylate polymer having an acrylic content of 50 to 100 percent by mass are preferably used in combination. Particularly, a combination of a binder and light transmissive particles including a crosslinked poly(styrene-acrylic) copolymer (with a refractive index of 1.48 to 1.54) is preferred.

Each refractive index of binder (light transmissive resin) and the light transmissive particles is preferably 1.45 to 1.70, and more preferably 1.48 to 1.65. In order for the refractive index to fall within the range, it is essential only that the type and the amount ratio of the binder and the light transmissive particles are appropriately selected. How these are selected can be previously experimentally known with ease.

Whereas, in the invention, the difference in refractive index between the binder and the light transmissive particles (refractive index of the light transmissive particles−refractive index of the binder) is, in absolute value, preferably 0.001 to 0.030, more preferably 0.001 to 0.020, and further preferably 0.001 to 0.015. When the difference exceeds 0.030, blur of film characters, the reduction of the darkroom contrast, whitening of the surface, and other problems occur.

Herein, the refractive index of the binder can be quantitatively evaluated by direct measurement with an Abbe refractometer, or measurement of spectral reflection spectrum, spectral ellipsometry, or the like. The refractive index of the light transmissive particles can be measured in the following manner. Two solvents having different refractive indices are mixed in varying ratios. In the resulting solvents with varying refractive indices, the light transmissive particles are dispersed in equal amounts to determine the turbidities. Then, the refractive index of the solvent when the turbidity is minimum is measured by an Abbe refractometer.

For the foregoing light transmissive particles, the light transmissive particles tend to precipitate in a binder. Therefore, inorganic filler such as silica may be added for preventing the precipitation. Incidentally, a larger amount of the inorganic filler to be added is more effective for preventing the light transmissive particles from precipitating, but adversely affects the transparency of the coating film. Therefore, preferably, an inorganic filler with a particle diameter of 0.5 μm or less may be allowed to be contained therein in an amount of less than about 0.1 mass % based on the amount of the binder in such a degree as not to impair the transparency of the coating film.

The average particle diameter of the light transmissive particles is preferably 0.5 to 10 μm, and more preferably 2.0 to 6.0 μm. When average particle diameter is 0.5 μm or more, the scattering angle distribution of light will not increase to a large angle excessively. For this reason, the character blur of the display is not caused, which is preferable. On the other hand, when the average particle diameter is 10 μm or less, the thickness of the film to which the light transmissive particles are added is not required to be increased, and problems such as curl and an increase in cost will not occur. Therefore, such an average particle diameter is preferable.

The particle diameter distribution of the mat particles is measured by a Coulter Counter method, and the measured distribution is converted into the particle count distribution.

The mat particles can be used in any of spherical and amorphous forms.

Whereas, the light transmissive particles may be used in combination of two or more of those having different particle diameters. This enables the following: light transmissive particles with a larger particle diameter impart the antiglare property, while light transmissive particles with a smaller particle diameter reduce the rough feeling of the surface.

The light transmissive particles are preferably added so as to be contained in an amount of 3 to 30 mass % based on the total solid content of the layer to which they are added. They are more preferably added in an amount of 5 to 20 mass %. When the content is 3 mass % or more, the effects of addition can be fully exerted. When the content is 30 mass % or less, problems such as image blur, whitening of the surface, and glare do not occur.

Whereas, the density of the light transmissive particles is preferably 10 to 1000 mg/m², and more preferably 100 to 700 mg/m².

[Preparation and Classification Methods of Light Transmissive Particles]

As the method for manufacturing the light transmissive particles in accordance with the invention, mention may be made of a suspension polymerization method, an emulsion polymerization method, a soap-free emulsion polymerization method, a dispersion polymerization method, a seed polymerization method, or the like. Manufacturing thereof may be achieved with any method. For these manufacturing methods, the methods described in, for example, KOUBUNNSHI GOUSEI NO JIKKENHOU, (written by both Takayuki Outsu and Masaethu Kinoshita, Kagaku-Dojin Publishing Company, Inc.), page 130, and pages 146 to 147, Gousei Koubunnshi, Vol.1, p. 246 to 290, vol. 3, p. 1 to 108, and the like, and the methods described in Japanese Patent No. 2543503, Japanese Patent No. 3508304, Japanese Patent No. 2746275, Japanese Patent No. 3521560, Japanese Patent No.3580320, JP-A-10-1561, JP-A-7-2908, JP-A-5-297506, JP-A-2002-145919, and the like, can serve as references.

For the particle diameter distribution of the light transmissive particles, monodispersible particles are preferred from the viewpoints of control of the haze value and the diffusibility, and the homogeneity of the coated surface conditions. For example, when particles with a particle diameter larger than the average particle diameter by 20% or more are defined as coarse particles, the proportion of the coarse particles is preferably 1% or less, more preferably 0.1% or less, and further preferably 0.01% or less, of the total number of particles. It is also an important means to classify the particles having such a particle diameter distribution after preparation or synthesis reaction. By increasing the frequency of classification, or enhancing the degree, it is possible to obtain particles having a desirable distribution.

For the classification, methods such as an air force classification method, a centrifugal classification method, a precipitation classification method, a filtration classification method, and an electrostatic classification method are preferably used.

1-5. Inorganic Particles

In the invention, various inorganic particles can be used for improving the physical characteristics such as the hardness, the optical characteristics such as reflectance and scattering property, and the like.

The inorganic particles include particles of oxides of at least one metal selected from silicon, zirconium, titanium, aluminum, indium, zinc, tin, and antimony, specific examples of which may include ZrO₂, TiO₂, Al₂O₃, In₂O₃, ZnO, SnO₂, Sb₂O₃, and ITO. Other than these, BaSO₄, CaCO₃, talc, kaolin, and the like are included.

The particle diameter of the inorganic particles for use in the invention is preferably minimized in the dispersion medium. The mass average diameter is 1 to 200 nm. It is preferably 5 to 150 nm, further preferably 10 to 100 nm, and in particular preferably 10 to 80 nm. By reducing the diameter of the inorganic particles to 100 nm or less, it is possible to form a film with no loss of transparency. The particle diameter of the inorganic particles can be measured by a light scattering method or an electron micrograph.

The specific surface area of the inorganic particles is preferably 10 to 400 m²/g, further preferably 20 to 200 m²/g, and most preferably 30 to 150 m²/g.

The inorganic particles for use in the invention are preferably added in the form of a dispersion in the dispersion medium to the coating solution of the layer used.

As the dispersion medium for the inorganic particles, a liquid having a boiling point of 60 to 170° C. is preferably used. Examples of such a dispersion medium include: water, alcohols (e.g., methanol, ethanol, isopropanol, butanol, and benzyl alcohol), ketones (e.g., acetone, methyl ethyl ketone, methyl isobutyl ketone, and cyclohexanone), esters (e.g., methyl acetate, ethyl acetate, propyl acetate, butyl acetate, methyl formate, ethyl formate, propyl formate, and butyl formate), aliphatic hydrocarbons (e.g., hexane and cyclohexane), hydrocarbon halides (e.g., methylene chloride, chloroform, and carbon tetrachloride), aromatic hydrocarbons (e.g., benzene, toluene, and xylene), amides (e.g., dimethylformamide, dimethylacetamide, and n-methylpyrrolidone), ethers (e.g., diethyl ether, dioxane, and tetrahydrofuran), and ether alcohols (e.g., 1-methoxy-2-propanol). Toluene, xylene, methyl ethyl ketone, methyl isobutyl ketone, cyclohexanone, and butanol are more preferred, and methyl ethyl ketone, methyl isobutyl ketone, and cyclohexanone are particularly preferred.

The inorganic particles are dispersed by means of a dispersing machine. Examples of the dispersing machine may include a sand grinder mill (e.g., a beads-mill equipped with pins), a high speed impeller mill, a pebble mill, a roller mill, an attritor, and a colloid mill. A sand grinder mill and a high speed impeller mill are particularly preferred. Whereas, a pre-dispersing treatment may also be performed. Examples of the dispersing machine to be used for the pre-dispersing treatment may include a ball mill, a three-roller mill, a kneader, and an extruder.

[High Refractive Index Particles]

For the purpose of achieving the higher refractive index of the layer forming the invention, a cured product of a composition including inorganic particles with a high refractive index dispersed in monomers and an initiator, and an organic-substituted silicon compound is preferably used.

As the inorganic particles in this case, particularly, ZrO₂ or TiO₂ is preferably used from the viewpoint of the refractive index. Fine particles of ZrO₂ are most preferred for achieving the higher refractive index of the hard coat layer; and fine particles of TiO₂, as the particles for the high refractive index layer, and the medium refractive index layer.

The particles of TiO₂ are in particular preferably inorganic particles containing at least one element selected from cobalt, aluminum, and zirconium, and containing TiO₂ as a main component. The main component denotes the component of which the content (mass %) is the highest of those of the components forming the particle.

The particles containing TiO₂ as a main component in the invention has a refractive index of preferably 1.90 to 2.80, more preferably 2.10 to 2.80, and most preferably 2.20 to 2.80.

The primary particles of the particles containing TiO₂ as a main component have a mass average diameter of preferably 1 to 200 nm, more preferably 1 to 150 nm, still more preferably 1 to 100 nm, and in particular preferably 1 to 80 nm.

The crystal structure of the particle containing TiO₂ as a main component mainly contains preferably a rutile, a rutile/anatase mixed crystal, anatase, or an amorphous structure, and in particular preferably mainly contains a rutile structure. The main component denotes the component of which the content (mass %) is the highest of those of the components forming the particle.

By allowing the particle containing TiO₂ as a main component to contain at least one element selected from Co (cobalt), Al (aluminum), and Zr (zirconium), it is possible to inhibit the photocatalytic activity possessed by TiO₂. This can improve the weather resistances of the antireflection layer of the invention. The particularly preferred element is Co (cobalt). Whereas, these elements may also be preferably used in combination of two or more thereof.

The inorganic particles containing TiO₂ as a main component for use the invention may also have a core/shell structure as described in JP-A-2001-166104 by a surface treatment.

The amount of the inorganic particles added in the layer is preferably 10 to 90 mass %, and further preferably 20 to 80 mass % based on the total mass of the binder. Two or more types of the inorganic particles may be used in the layer.

[Low Refractive Index Particles]

The inorganic particles to be contained in the low refractive index layer desirably have a low refractive index. Mention may be made of magnesium fluoride and silica fine particles. Particularly, silica fine particles are preferred in terms of the refractive index, the dispersion stability, and the cost. The inorganic particles usable for the low refractive index layer preferably have a particle size of 1 to 150 nm from the viewpoint of imparting the transparency and the strength to the coating film.

As silica particles for use in the low refractive index layer, two or more types of particles having different particles sizes can be used. As preferable one average particle diameter range thereof, mention may be made of preferably 30% or more and 150% or less, more preferably 35% or more and 80% or less, and further preferably 40% or more 60% or less, of the thickness of the low refractive index layer. Namely, when the thickness of the low refractive index layer is 100 nm, the particle diameter of the silica fine particles is preferably 30 nm or more and 150 nm or less, more preferably 35 nm or more and 80 nm or less, and further preferably 40 nm or more and 60 nm or less. (The particles having a particle diameter within the range are referred as “silica fine particles with a large size particle diameter”).

Herein, the average particle diameter of the inorganic particles is measured by Coulter Counter.

When the particle diameter of the silica fine particles is equal to or more than the lower limit value, the effect of improving the scratch resistance is enhanced. When the particle diameter is equal to or less than the upper limit value, fine unevenness is formed on the low refractive index layer surface. Thus, disadvantages including degradation of the outward appearances such as tightness of black, or the integral reflectance, and the like do not occur. Therefore, such a particle diameter is preferable. The silica fine particles may be any of crystalline and amorphous. Whereas, even when the particles are monodispersible particles, agglomerate particles are acceptable so long as they have a particle diameter satisfying a prescribed particle diameter. The particle is most preferably in a spherical form, but even an amorphous particle does not matter.

Whereas, another preferable average particle diameter range thereof is less than 25% of the thickness of the low refractive index layer (which are referred to as “silica fine particles with a small size particle diameter”).

The silica fine particles with a small particle diameter can exist in the gaps between the silica fine particles with a large particle diameter, and hence can serve as a holding agent for the silica fine particles with a large particle diameter.

The average particle diameter of the silica fine particles with a small particle diameter is preferably 1 nm or more and 25 nm or less, further preferably 5 nm or more and 15 nm or less, and particularly preferably 10 nm or more and 15 nm or less, when the low refractive index layer is 100 nm in thickness. Use of such silica fine particles is preferred in terms of the raw material cost and the holding agent effect.

The coating amount of the silica fine particles with a low refractive index is preferably 1 mg/m² to 100 mg/m², more preferably 5 mg/m² to 80 mg/m², and further preferably 10 mg/m² to 60 mg/m². When the coating amount is equal to or more than the lower limit value, favorable scratch resistance improving effects can be exerted. When the coating amount is equal to or less than the upper limit value, fine unevenness is formed on the low refractive index layer surface. Thus, favorably, disadvantages including degradation of the outward appearances such as tightness of black, or the integral reflectance, and the like do not occur.

(Hollow Silica Particles)

For the purpose of more reducing the refractive index, hollow silica fine particles are preferably used.

The hollow silica fine particles has a refractive index of preferably 1.15 to 1.40, further preferably 1.17 to 1.35, and most preferably 1.17 to 1.30. The refractive index herein denotes the refractive index of the whole particles, and does not denote the refractive index of only the silica of the shell forming the hollow silica particle. In this case, the void ratio X is expressed by the following mathematical expression (1):
X={(4πrᵢ³/3)/(4πrₒ³/3)}×100 Mathematical expression (1):

where rᵢ denotes the radius of the void in the particle, and rₒ denotes the radius of the particle shell. The void ratio X of the hollow silica particle is preferably 10 to 60%, further preferably 20 to 60%, and most preferably 30 to 60%.

In order for the hollow silica particles to have a lower refractive index and a larger void ratio, the thickness of the shell is reduced, and the strength of the particle is weakened. Therefore, from the viewpoint of the scratch resistance, the refractive index of the hollow silica particles is generally 1.15 or more.

The methods for manufacturing hollow silica particles are described in, for example, JP-A-2001-233611 and JP-A-2002-79616. The hollow silica particle for use in the invention is in particular preferably a particle having a void inside the shell, of which the pores are closed. Incidentally, the refractive index of these hollow silica particles can be calculated by the method described in JP-A-2002-79616.

The coating amount of the hollow silica particles is preferably 1 mg/m² to 100 mg/m², more preferably 5 mg/m² to 80 mg/m², and further preferably 10 mg/m² to 60 mg/m². When the coating amount is equal to or more than the lower limit value, favorable effects of reducing the refractive index and improving the scratch resistance are enhanced. Therefore, such a coating amount is preferred. When the coating amount is equal to or less than the lower limit value, fine unevenness is formed on the low refractive index layer surface. Thus, disadvantages including degradation of the outward appearances such as tightness of black, or the integral reflectance, and the like do not occur. Therefore, such a coating amount is preferred.

The average particle diameter of the hollow silica particles is preferably 30% or more and 150% or less, more preferably 35% or more and 80% or less, and further preferably 40% or more and 60% or less, of the thickness of the low refractive index layer. Namely, when the thickness of the low refractive index layer is 100 nm, the particle diameter of hollow silica is preferably 30 nm or more and 150 nm or less, more preferably 35 nm or more and 100 nm or less, and further preferably 40 nm or more and 65 nm or less. When the particle diameter of the hollow silica particles is equal to or more than the lower limit value, the ratio of the void portion is sufficient, and the refractive index can be expected to be reduced. Therefore, such a particle diameter is preferred. When the particle diameter is equal to or less than the upper limit value, fine unevenness is formed on the low refractive index layer surface. Thus, disadvantages including degradation of the outward appearances such as tightness of black, or the integral reflectance, and the like do not occur. Therefore, such a particle diameter is preferable. The hollow silica particles may be any of crystalline and amorphous, or may be monodispersible particles. The particle is most preferably in a spherical form, but even an amorphous particle does not matter.

Whereas, hollow silica particles different in particle average particle size can be used in combination of two or more thereof. Herein, the average particle diameter of the hollow silica particles can be determined from an electron micrograph.

In the invention, the specific surface area of the hollow silica particles is preferably 20 to 300 m²/g, further preferably 30 to 120 m²/g, and most preferably 40 to 90 m²/g. The surface area can be determined by using nitrogen with a BET method.

In the invention, void-free silica particles can be used in combination with hollow silica. For use in combination, the particle size of the void-free silica is preferably 30 nm or more and 150 nm or less, further preferably 35 nm or more and 100 nm or less, and most preferably 40 nm or more and 80 nm or less.

1-6. Electrically Conductive Particles

To the antireflection film of the invention, various electrically conductive particles can be used in order to impart the electrical conductivity thereto. The electrically conductive particles are preferably formed from an oxide or a nitride of a metal. Examples of the oxide or the nitride of a metal may include tin oxide, indium oxide, zinc oxide, and titanium nitride. Tin oxide and indium oxide are particularly preferred.

The electrically conductive inorganic particles can contain metal oxide or nitride as a main component, and can further contain other elements. The main component denotes the component of which the content (mass %) is the highest of those of the components forming the particle. Examples of the other elements may include Ti, Zr, Sn, Sb, Cu, Fe, Mn, Pb, Cd, As, Cr, Hg, Zn, Al, Mg, Si, P, S, B, Nb, In, V, and a halogen atom. In order to enhance the electric conductivity of tin oxide and indium oxide, Sb, P, B, Nb, In, V, and a halogen atom are preferably added. Sb-containing tin oxide (ATO) and Sn-containing indium oxide (ITO) are particularly preferred. The proportion of Sb in ATO is preferably 3 to 20 mass %. The proportion of Sn in ITO is preferably 5 to 20 mass %.

The average particle diameter of primary particles of the electrically conductive inorganic particles for use in the antistatic layer is preferably 1 to 150 nm, further preferably 5 to 100 nm, and most preferably 5 to 70 nm. The average particle diameter of the electrically conductive inorganic particles in the antistatic layer to be formed is 1 to 200 nm, preferably 5 to 150 nm, further preferably 10 to 100 nm, and most preferably 10 to 80 nm. The average particle diameter of the electrically conductive inorganic particles is the particle mass-weighted average diameter, and can be measured by means of a light scattering method or an electron micrograph.

The specific surface area of the electrically conductive inorganic particles is preferably 10 to 400 m²/g, further preferably 20 to 200 m²/g, and most preferably 30 to 150 m²/g.

The electrically conductive inorganic particles may be subjected to a surface treatment. The surface treatment is carried out by using an inorganic compound or an organic compound. Examples of the inorganic compound for use in the surface treatment may include alumina and silica. A silica treatment is particularly preferred. Examples of the organic compound for use in the surface treatment may include polyol, alkanolamine, stearic acid, a silane coupling agent, and a titanate coupling agent. The silane coupling agent is most preferred. Two or more surface treatments may be carried out in combination.

The electrically conductive inorganic particle preferably has a rice-grain shape, a spherical shape, a cubic shape, a spindle shape, or an indefinite shape.

The electrically conductive inorganic particles may be used in combination of two or more thereof in a specific layer or in the form of a layer of themselves.

The proportion of the electrically conductive inorganic particles in the antistatic layer is preferably 20 to 90 mass %, preferably 25 to 85 mass %, and further preferably 30 to 80 mass %.

The electrically conductive inorganic particles can be used in the form of a dispersion for the formation of the antistatic layer.

1-7. Surface Treatment Agent

The inorganic particles for use in the invention may be subjected to a physical surface treatment such as a plasma discharge treatment or a corona discharge treatment, or a chemical surface treatment by a surfactant or a coupling agent, in order to stabilize the dispersion in the dispersion or in the coating solution, or in order to enhance the affinity or the bonding property with the binder component.

The surface treatment can be carried out by using a surface treatment agent of an inorganic compound or an organic compound. Examples of the inorganic compound for use in the surface treatment may include cobalt-containing inorganic compounds (such as CoO₂, Co₂O₃, and Co₃O₄), aluminum-containing inorganic compounds (such as Al₂O₃ and Al(OH)₃), zirconium-containing inorganic compounds (such as ZrO₂ and Zr(OH)₄), silicon-containing inorganic compounds (such as SiO₂), and iron-containing inorganic compounds (such as Fe₂O₃).

Cobalt-containing inorganic compounds, aluminum-containing inorganic compounds, and zirconium-containing inorganic compounds are particularly preferred. Cobalt-containing inorganic compounds, and Al(OH)₃ and Zr(OH)₄ are most preferred.

Examples of the organic compound for use in the surface treatment may include polyol, alkanolamine, and organic compounds having an anionic group (preferably, an organic compound having a carboxyl group, a sulfonic acid group, or a phosphoric acid group, and in particular preferably, stearic acid, lauric acid, oleinic acid, linoleic acid, linolenic acid, and the like), a silane coupling agent, and a titanate coupling agent. Out of these, the silane coupling agent is most preferred. In particular, the surface treatment is preferably carried out with at least one of a silane coupling agent (organosilane compound), a partial hydrolysate thereof, and a condensate thereof.

Examples of the titanate coupling agent may include metal alkoxides such as tetramethoxytitanium, tetraethoxytitanium, and tetraisopropoxytitanium, and PLENACT (such as KR-TTS, KR-46B, KR-55, or KR-41B; manufactured by Ajinomoto Co., Inc.).

The organic compounds for use in the surface treatment preferably further have crosslinkable or polymerizable functional groups. As the crosslinkable or polymerizable functional groups, mention may be made of ethylenically unsaturated groups capable of addition reaction/polymerization reaction by radical species {e.g., a (meth)acryl group, an allyl group, a styryl group, and a vinyloxy group}, cationic polymerizable groups (e.g., an epoxy group, an oxatanyl group, and a vinyloxy group), and polycondensable groups (e.g., a hydrolyzable silyl group and an N-methylol group). Preferred are groups having an ethylenically unsaturated group.

These surface treatment agents may be used in combination of two or more thereof. It is particularly preferable to use an aluminum-containing inorganic compound and a zirconium-containing inorganic compound in combination.

When the inorganic particles are silica, use of a coupling agent is particularly preferred. As the coupling agent, alkoxy metal compound (e.g., a titanium coupling agent or a silane coupling agent) is preferably used. Out of these, a silane coupling treatment is particularly effective.

The coupling agent is used, for example, as the surface treatment agent for an inorganic filler of a low refractive index layer, prior to preparation of the layer coating solution, for previously performing a surface treatment. However, preferably, it is further added as an additive during preparation of the layer coating solution, and is allowed to be contained in the layer. Particularly, it is preferable for the reduction of the load of the surface treatment that silica fine particles have been previously dispersed in the medium prior to the surface treatment.

Specific examples of the compound for the surface treatment agent and the catalyst for surface treatment to be preferably used in the invention may include organosilane compounds and catalysts described in WO 2004/017105.

1-8. Dispersant

For dispersion of the particles for use in the invention, various dispersants can be used.

The dispersant preferably further contains a crosslinkable or polymerizable functional group. As the crosslinkable or polymerizable functional groups, mention may be made of ethylenically unsaturated groups capable of addition reaction/polymerization reaction by radical species (such as a (meth)acryloyl group, an allyl group, a styryl group, and a vinyloxy group), cationic polymerizable groups (such as an epoxy group, an oxatanyl group, and a vinyloxy group), and polycondensable groups (such as a hydrolyzable silyl group and an N-methylol group). Preferred are functional groups having ethylenically unsaturated groups.

For the dispersion of inorganic particles, particularly, for the dispersion of the inorganic particles containing TiO₂ as a main component, dispersants having anionic groups are preferably used. The dispersants more preferably have anionic groups, and crosslinkable or polymerizable functional groups, and in particular preferably, the dispersants are the dispersants having the crosslinkable or polymerizable groups at the side chains.

The anionic groups are effectively groups having acidic protons such as a carboxyl group, a sulfonic acid group (a sulfo group), a phosphoric acid group (a phosphono group), and a sulfonamido group, or salts thereof, especially preferably a carboxyl group, a sulfonic acid group, and a phosphoric acid group, or salts thereof, and in particular preferably a carboxyl group and a phosphoric acid group. A plurality of anionic groups may be contained per molecule in the dispersant, however, the number of anionic groups per molecule contained in the dispersant is, on an average, preferably 2 or more, more preferably 5 or more, and in particular preferably 10 or more. As for the anionic groups to be contained in the dispersant, a plurality of types of anionic groups may also be contained per molecule.

In the dispersant having anionic groups in the side chains, the composition ratio of anionic group-containing repeating units is in the range of 10⁻⁴ to 100 mol %, preferably 1 to 50 mol %, and in particular preferably 5 to 20 mol % based on the total amount of the repeating units.

The dispersant preferably further contains a crosslinkable or polymerizable functional group. As the crosslinkable or polymerizable functional groups, mention may be made of ethylenically unsaturated groups capable of addition reaction/polymerization reaction by radical species (such as a (meth)acryloyl group, an allyl group, a styryl group, and a vinyloxy group), cationic polymerizable groups (such as an epoxy group, an oxatanyl group, and a vinyloxy group), and polycondensable groups (such as a hydrolyzable silyl group and an N-methylol group). Preferred are functional groups having ethylenically unsaturated groups.

The number of the crosslinkable or polymerizable functional groups contained per molecule in the dispersant is, on an average, preferably 2 or more, more preferably 5 or more, and in particular preferably 10 or more. As for the crosslinkable or polymerizable functional groups to be contained in the dispersant, a plurality of types thereof may also be contained per molecule.

In the preferred dispersant for use in the invention, examples of the repeating unit having an ethylenically unsaturated group at the side chain may include repeating units of poly-1,2-butadiene and poly-1,2-isoprene structures or (meth)acrylic acid esters or amides. The ones in each of which a specific residue (R group of —COOR or —CONHR) is bonded thereto are usable.

Examples of the specific residue (R group) may include: —(CH₂)ₙ—CR⁵¹═CR⁵²R⁵³, —(CH₂O)ₙ—CH₂CR⁵¹═CR⁵²R⁵³, —(CH₂CH₂O)ₙ—CH₂CR⁵¹═CR⁵²R⁵³, —(CH₂)ₙ—NH—CO—O—CH₂CR⁵¹═CR⁵²R⁵³, —(CH₂)ₙ—O—CO—CR⁵¹═CR⁵²R⁵³ and —(CH₂CH₂O)₂—X⁵¹ (where R⁵¹ to R⁵³ are each a hydrogen atom, a halogen atom, or an alkyl group, an aryl group, an alkoxy group, or an aryloxy group, having 1 to 20 carbon atoms, and R⁵¹ and R⁵² or R⁵³ may also combine with each other to form a ring; n is an integer of 1 to 10; and X⁵¹ is a dicyclopentadiene residue.).

Specific examples of R in the ester residue may include: —CH₂CH═CH₂ {corresponding to allyl (meth)acrylate polymer described in JP-A-64-17047}, —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and CH₂CH₂O—X⁵¹ (where X⁵¹ is a dicyclopentadienyl residue). Specific examples of R in the amide residue may include: —CH₂CH═CH₂, —CH₂CH₂—X⁵² (where X⁵² is a 1-cyclohexenyl residue), and —CH₂CH₂—OCO—CH═CH₂, and —CH₂CH₂—OCO—C(CH₃)═CH₂.

In the dispersant having the ethylenically unsaturated group, to the unsaturated bond group, a free radical (a polymerization initiator radial or a growing radical in the process of polymerization of a polymerizable compound) is added, and addition polymerization occurs directly or through chain polymerization of the polymerizable compound between the molecules. This results in the formation of crosslinking, which causes curing. Alternatively, the atoms in the molecules (such as hydrogen atoms on the carbon atoms adjacent to the unsaturated bond groups) are attracted by free radicals to generate polymer radicals. These combine with each other to form crosslinking between the molecules, which causes curing.

The mass average molecular weight (Mw) of the dispersant having anionic groups, and crosslinkable or polymerizable functional groups, and having the crosslinkable or polymerizable groups at side chains has no particular restriction. However, it is preferably 1000 or more. The mass average molecular weight (Mw) of the dispersant is more preferably 2000 to 100000, further preferably 5000 to 200000, and in particular preferably 10000 to 100000.

The crosslinkable or polymerizable functional group-containing units may constitute all the repeating units other than the anionic group-containing repeating units. However, these account for 5 to 50 mol %, and in particular preferably 5 to 30 mol % of the total amount of the crosslinkable or polymerizable repeating units.

The dispersants may be copolymers with appropriate monomers other than the monomers having the crosslinkable or polymerizable functional groups and the anionic groups. The copolymerizable components have no particular restriction. However, these are selected from various viewpoints such as the dispersion stability, the compatibility with other monomer components, and the strength of the formed film. Preferred examples thereof may include methyl(meth)acrylate, n-butyl(meth)acrylate, t-butyl(meth)acrylate, cyclohexyl(meth)acrylate, and styrene.

The forms of the dispersants have no particular restriction. However, the dispersants are preferably block copolymers or random copolymers, and in particular preferably random copolymers in terms of the cost and the ease of synthesis.

The amount of the dispersant to be used based on the amount of the inorganic particles preferably falls within a range of 1 to 50 mass %, more preferably falls within a range of 5 to 30 mass %, and most preferably falls within a range of 5 to 20 mass %. Further, the dispersants may be used in combination of two or more thereof.

1-8. Stain Proof Agent

To the antireflection film of the invention, particularly, the uppermost layer thereof, it is preferable to appropriately add a known silicone type or fluorine type stain proof agent, a slipping agent, and the like for the purpose of imparting the characteristics such as the stain proof property, the water resistance, the chemical resistance, and the slipping property.

When these additives are added, these are preferably added in an amount in the range of 0.01 to 20 mass %, and more preferably added in an amount in the range of 0.05 to 10 mass %, and in particular preferably 0.1 to 5 mass % based on the total solid content of the low refractive index layer.

Preferred examples of the silicone type compound may include the ones having a plurality of dimethylsilyloxy units as repeating units, and having a substituent at the terminal of the compound chain and/or the side chain thereof. The compound chain containing dimethylsilyloxy as a repeating unit may contain therein other structural unit than dimethylsilyloxy.

The substituents may be the same or different, and a plurality of the substituents are preferably present. Preferred examples of the substituent may include the groups containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, an amino group, and the like.

The molecular weight of the silicone type compound has no particular restriction. However, it is preferably 100,000 or less, more preferably 500,000 or less, in particular preferably 3000 to 30000, and most preferably 10000 to 20000.

Whereas, the silicon content of the silicone type compound has no particular restriction. However, it is preferably 18.0 mass % or more, in particular preferably 25.0 to 37.8 mass %, and most preferably 30.0 to 37.0 mass %.

Preferred non-limiting examples of the silicone type compound may include “X-22-174DX”, “X-22-2426”, “X-22-164B”, “X22-164C” “X-22-170DX”, “X-22-176D”, “X22-1821”, and “X-22-160AS” (all are trade names) manufactured by Shin-Etsu Chemical Co., Ltd.; “Silaplane FM-0725”, “Silaplane FM-7725”, “Silaplane FM-4421”, “Silaplane FM-5521”, “Silaplane FM-6621”, “Silaplane FM-1121 ”, and “Silaplane FM-4425”, manufactured by Chisso Corporation; “DMS-U22”, “RMS-033”, “RMS-083”, “UMS-182”, “DMS-H21”, “DMS-H31”, “HMS-301”, “HMS121”, “FMS123”, “FMS131”, “FMS141”, “FMS221”, and “CMS-626” (all are trade names), manufactured by Gelest Co.

From the viewpoint of preventing transfer, the compounds each preferably contain a hydroxyl group or a functional group which reacts with a hydroxyl group, and forms a bond. The bond formation reaction preferably proceeds promptly under heating conditions and/or in the presence of a catalyst. As such a substituent, mention may be made of an epoxy group, a carboxyl group, or the like. Non-limiting preferred examples of the compounds may include the following:

(The Ones Containing a Hydroxyl Group)

“X-22-160AS”, “KF-6001”, “KF-6002”, “KF-6003”, “X-22-170DX”, “X-22-176DX”, “X-22-176D”, and “X-22-176F” {all, manufactured by Shin-Etsu Chemical Co., Ltd.}; “FM-4411”, “FM-4421”, “FM-4425”, “FM-0411”, “FM-0421”, “FM-0425”, “FM-DA11”, “FM-DA21”, and “FM-DA25 {all, manufactured by Chisso Corporation}; and “CMS-626” and “CMS-222” {all, manufactured by Gelest Co.}.

(The One Containing a Functional Group Which Reacts With a Hydroxyl Group)

“X-22-162C” and “KF-105” {all, manufactured by Shin-Etsu Chemical Co., Ltd.}; “FM-5511”, “FM-5521”, “FM-5525”, “FM-6611”, “FM-6621”, and “FM-6625” {all, manufactured by Chisso Corporation}.

The fluorine type compound is preferably a compound having a fluoroalkyl group. The fluoroalkyl group has preferably 1 to 20 carbon atoms, and more preferably 1 to 10 carbon atoms. It may be a straight chain {e.g., —CF₂CF₃, —CH₂(CF₂)₄H, —CH₂(CF₂)₈CF₃, or —CH₂CH₂(CF₂)₄H}, a branched structure {e.g., CH(CF₃)₂, CH₂CF(CF₃)₂, CH(CH₃)CF₂CF₃, or CH(CH₃)(CF₂)₅CF₂H), or an alicyclic structure (preferably a 5-membered ring or a 6-membered ring, e.g., a perfluorocyclohexyl group, a perfluorocyclopentyl group, or an alkyl group substituted therewith), and may have an ether linkage (e.g., CH₂OCH₂CF₂CF₃, CH₂CH₂OCH₂C₄F₈H, CH₂CH₂OCH₂CH₂C₈F₁₇, or CH₂CH₂OCF₂CF₂H). A plurality of the fluoroalkyl groups may be contained in the same molecule.

The fluorine type compound preferably further has a substituent which contributes to the formation of bonding with the low refractive index layer film, or the compatibility. The substituents may be the same or different, and a plurality of the substituents are preferably present. Preferred examples of the substituent may include an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group.

The fluorine type compound may be a copolymer or a cooligomer with a compound not containing a fluorine atom, and has no particular restriction on the molecular weight.

The fluorine atom content of the fluorine type compound has no particular restriction. However, it is preferably 20 mass % or more, in particular preferably 30 to 70 mass %, and most preferably 40 to 70 mass %.

Preferred non-limiting examples of the fluorine-containing compound may include “R-2020”, “M-2020”, “R-3833”, and “M-3833” (all are trade names) manufactured by DAIKIN Industries Ltd.; and “MEGAFAC F-171”, “MEGAFACF-172”, “MEGAFACF-179A”, “DEFENSA MCF-300” (all are trade names), manufactured by Dai-Nippon Ink & Chemicals Inc.

For the purpose of imparting the characteristics such as dust proof property and antistatic property, a dust proof agent such as a known cationic surfactant or a polyoxyalkylene type compound, an antistatic agent, and the like can also be appropriately added. The dust proof agent or the antistatic agent may have the structural unit contained in the silicone type compound or the fluorine type compound as a part of the function.

When these are added as additives, for example, these are preferably added in an amount in the range of 0.01 to 20 mass %, more preferably in an amount in the range of 0.05 to 10 mass %, and in particular preferably 0.1 to 5 mass % based on the total solid content of the low refractive index layer. Preferred non-limiting examples of the compound may include “MEGAFACF-150” (trade name) manufactured by Dai-Nippon Ink & Chemicals Inc., and “SH-3748” (trade name) manufactured by Dow Corning Toray Company Limited.

1-9. Surfactant

To the antireflection film of the invention, any of fluorine type and silicone type surfactant, or both of them are preferably contained in a coating solution for forming the antiglare layer or the hard coat layer in order to ensure the uniformity of surface conditions of, particularly, uneven coating, uneven drying, point defects, and the like. Particularly, a fluorine type surfactant in a smaller amount exhibits effects of improving the defective surface conditions of uneven coating, uneven drying, point defects, and the like. Therefore, it can be preferably used. By imparting the high speed coating suitability thereto while enhancing the uniformity of the surface conditions, it is possible to raise the productivity.

Preferred examples of the fluorine type surfactant may include a fluoroaliphatic group-containing copolymer (which may also be abbreviated as a “fluorine type polymer surfactant”). The fluorine type polymer surfactants are effectively an acrylic type copolymer or a methacrylic type copolymer containing a repeating unit corresponding to the following monomer (i) and/or a repeating unit corresponding to the following monomer (ii), and a copolymer with a vinyl type monomer copolymerizable therewith.

(i) Fluoroaliphatic group-containing monomer represented by the following formula (6):

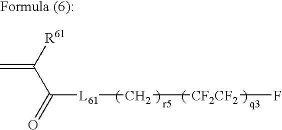

In the formula (6), R⁶¹ represents a hydrogen atom or a methyl group, L₆₁ represents an oxygen atom, a sulfur atom, or N(R⁶²)—, r represents an integer of 1 or more to 6 or less, and q3 represents an integer of 2 to 4. R⁶² represents a hydrogen atom or an alkyl group having 1 to 4 carbon atoms, specifically, a methyl group, an ethyl group, a propyl group, or a butyl group, and preferably a hydrogen atom or a methyl group. L₆₁ is preferably an oxygen atom.

(ii) Monomer represented by the following formula (7) copolymerizable with the item (i)

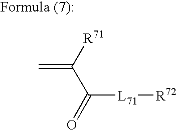

In the formula (7), R⁷¹ represents a hydrogen atom or a methyl group, L₇₁ represents an oxygen atom, a sulfur atoms, or N(R⁷³)—, R⁷³ represents a hydrogen atom or an alkyl group having 1 to 4 carbon atoms, specifically, a methyl group, an ethyl group, a propyl group, or a butyl group, and preferably a hydrogen atom or a methyl group. L₇₁ is preferably an oxygen atom, —N(H)—, or N(CH₃)—.

R⁷² represents a straight-chain, branched, or cyclic alkyl group having 4 or more and 20 or less carbon atoms which may have a substituent. As the substituent of the alkyl group of R⁷², mention may be made of a hydroxyl group, an alkyl carbonyl group, an aryl carbonyl group, a carboxyl group, an alkyl ether group, an aryl ether group, a halogen atom such as a fluorine atom, a chlorine atom, or a bromine atom, a nitro group, a cyano group, an amino group, or the like, which is non-exclusive. As the straight-chain, branched, or cyclic alkyl groups having 4 or more and 20 or less carbon atoms, a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, an eicosanyl group, or the like, which may be straight chain or branched, and further, a monocyclic cycloalkyl group such as a cyclohexyl group or a cycloheptyl group, and a polycyclic cycloalkyl group such as a bicycloheptyl group, a bicyclodecyl group, a tricycloundecyl group, a tetracyclododecyl group, an adamantyl group, a norbornyl group, or a tetracyclodecyl group are preferably used.

The amount of the fluoroaliphatic group-containing monomers represented by the formula (6) for use in the fluorine type polymer surfactant for use in the invention is in a range of 10 mol % or more, preferably 15 to 70 mol %, and more preferably 20 to 60 mol % based on amount of each monomer of the fluorine type polymer surfactant.

The preferred mass average molecular weight of the fluorine type polymer surfactant for use in the invention is preferably 3000 to 100,000, and more preferably 5,000 to 80,000.

Further, the preferred amount of the fluorine type polymer surfactant for use in the invention is in a range of 0.001 to 5 mass %, preferably in a range of 0.005 to 3 mass %, and further preferably in a range of 0.01 to 1 mass % based on the amount of the coating solution. When the amount of the fluorine type polymer surfactant to be added is 0.001 mass % or more, the effects are sufficiently exerted. Therefore, the amount is preferred. Whereas, when the amount is 5 mass % or less, disadvantages such as insufficient drying of the coating film, and adverse effects on the performances of the coating film (e.g., reflectance and scratch resistance) are not caused. Therefore, the amount is preferred.

1-10. Thickener

For the antireflection film of the invention, a thickener may be used for adjusting the viscosity of the coating solution for forming a functional layer.

The term “thickener” herein used denotes the one which increases the viscosity of the solution by being added thereto. The magnitude of the increase in viscosity of the coating solution by the addition is preferably 0.05 to 50 cP, further preferably 0.10 to 20 cP, and most preferably 0.10 to 10 cP.

Non-limiting examples of such a thickener may include the following:

poly-ε-caprolactone, poly-ε-caprolactone diol, poly-ε-caprolactone triol, polyvinyl acetate, poly(ethylene adipate), poly(1,4-butylene adipate), poly(1,4-butylene glutarate), poly(1,4-butylene succinate), poly(1,4-butylene terephthalate), poly(ethylene terephthalate ), poly(2-methyl-1,3-propylene adipate), poly(2-methyl-1,3-propylene glutarate), poly(neopentyl glycol adipate), poly(neopentyl glycol sebacate), poly(1,3-propylene adipate), poly(1,3-propylene glutarate), polyvinyl butyral, polyvinyl formal, polyvinyl acetal, polyvinyl propanal, polyvinyl hexanal, polyvinyl pyrrolidone, poly(meth)acrylic acid ester, cellulose acetate, cellulose propionate, and cellulose acetate butyrate.

Other than these, known viscosity modifiers and thixotropy imparting agents such as smectite, fluorine tetra silicon mica, bentonite, silica, montmorillonite, and sodium polyacrylate, described in JP-A-8-325491, ethyl cellulose, polyacrylic acid, and organic clay, described in JP-A-10-219136 can be used.

1-11. Coating Solvent

In the invention, as the solvents for use in the coating solution for forming each layer, there can be used various solvents selected from the following viewpoints: they can dissolve or disperse each component, they tend to form uniform surface conditions in the coating step and the drying step, the solution storability can be ensured, they have a proper saturated vapor pressure, and the like. The solvents can be used in mixture of two or more thereof. Particularly, the solvent preferably contains a solvent with a boiling point of 100° C. or less at room temperature under normal pressure as a main component from the viewpoint of drying load, and contains a solvent with a boiling point of 100° C. or more in a small amount for the adjustment of the drying rate.

Examples of the solvent with a boiling point of 100° C. or less may include hydrocarbons such as hexane (boiling point 68.7° C.), heptane (98.4° C.), cyclohexane (80.7° C.), and benzene (80.1° C.); hydrocarbon halides such as dichloromethane (39.8° C.), chloroform (61.2° C.), carbon tetrachloride (76.8° C.), 1,2-dichloroethane (83.5° C.), and trichloroethylene (87.2° C.); ethers such as diethyl ether (34.6° C.), diisopropyl ether (68.5° C.), dipropyl ether (90.5° C.), and tetrahydrofuran (66° C.); esters such as ethyl formate (54.2° C.), methyl acetate (57.8° C.), ethyl acetate (77.1° C.), and isopropyl acetate (89° C.); ketones such as acetone (56.1° C.) and 2-butanone (the same as methyl ethyl ketone, 79.6° C.); alcohols such as methanol (64.5° C.), ethanol (78.3° C.), 2-propanol (82.4° C.), and 1-propanol (97.2° C.); cyano compounds such as acetonitrile (81.6° C.) and propionitrile (97.4° C.), and carbon disulfide(46.2° C.). Out of these, esters are preferred, and ketones are particularly preferred. Out of the ketones, 2-butanone is particularly preferred.

Examples of the solvent with a boiling point of 100° C. or more may include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone {the same as with methyl isobutyl ketone (MIBK), 115.9° C.}, 1-butanol (117.7° C.), N,N-dimethylformamide (153° C.), N,N-dimethylacetamide (166° C.), and dimethylsulfoxide (189° C.). Cyclohexanone and 2-methyl-4-pentanone are preferred.

1-12. Others

For the antireflection film of the invention, other than the foregoing components, a resin, a coupling agent, a coloring inhibitor, a coloring agent (pigment or dye), an anti-foaming agent, a levelling agent, a flame retarder, an ultraviolet absorber, an infrared absorber, an adhesion imparting agent, a polymerization inhibitor, an antioxidant, a surface modifier, and the like can also be added to the layer-forming coating solution.

1-13. Support

The support of the antireflection film of the invention has no particular restriction, and may be a transparent resin film, a transparent resin plate, a transparent resin sheet, a transparent glass, or the like. The usable transparent resin films are cellulose acylate films (e.g., a cellulose triacetate film (refractive index 1.48), a cellulose diacetate film, a cellulose acetate butyrate film, and a cellulose acetate propionate film), a polyethylene terephthalate film, a polyether sulfone film, a polyacrylic type resin film, a polyurethane type resin film, a polyester film, a polycarbonate film, a polysulfone film, a polyether film, a polymethylpentene film, a polyether ketone film, and a (meth)acrylnitrile film.

[Cellulose Acylate Film]

Out of these, preferred are cellulose acylate films each of which has a high transparency, optically exhibits less birefringence, and is easy to manufacture, and commonly used as a protective film of a polarizing plate. A cellulose triacetate film is particularly preferred. Whereas, the thickness of the transparent support is generally set at about 25 μm to 1000 μm.

[Cellulose Acetate]

In the invention, for the cellulose acylate film, cellulose acetate with an acetylation degree of 59.0 to 61.5% is preferably used. The acetylation degree means the amount of the bound acetic acid per unit mass of the cellulose. The acetylation degree follows the measurement and the calculation of the acetylation degree in ASTM D-8 17-91 (the testing method of cellulose acetate and the like).

The viscosity average degree of polymerization (DP) of cellulose acylate is preferably 250 or more, and further preferably 290 or more. Whereas, for cellulose acylate for use in the invention preferably, the value of Mw/mn (where Mw is the mass average molecular weight, and Mn is the number average molecular weight) by gel permeation chromatography (GPC) is close to 1.0, in other words, the molecular weight distribution is narrow. The specific Mw/mn value is preferably 1.0 to 1.7, further preferably 1.3 to 1.65, and most preferably 1.4 to 1.6.

Generally, the 2, 3, and 6-position hydroxyl groups of cellulose acylate are not uniformly distributed to every ⅓ of the total substitution degree, and the substitution degree of the 6-position hydroxyl group tends to be smaller. In the invention, the substitution degree of the 6-position hydroxyl group of cellulose acylate is preferably higher than that at the 2- or 3-position. The 6-position hydroxyl group is preferably substituted in an amount of 32% or more, further preferably 33% or more, and in particular preferably 34% or more with an acyl group based on the total substitution degree. Further, the substitution degree of the 6-position acyl group of cellulose acylate is preferably 0.88 or more. The 6-position hydroxyl group may be substituted with an acyl group having 3 or more carbon atoms, such as a propionyl group, a butyroyl group, a valeroyl group, a benzoyl group, or an acryloyl group, other than an acetyl group. The substitution degree of each position can be determined by NMR.

In the invention, as cellulose acylate, cellulose acetate obtained by the processes described in paragraphs [0043] and [0044], [Examples], and [Synthetic Example 1], and paragraphs [0048] and [0049], [Synthetic Example 2], or paragraphs [0051] and [0052], and [Synthetic Example 3] of JP-A-11-5851 can be used.

[Polyethylene Terephthalate Film]

In the invention, a polyethylene terephthalate film is also excellent in transparency, mechanical strength, flatness, chemical resistance, and moisture resistance, and further it is inexpensive, and hence it is preferably used.

In order to more improve the adhesion strength between the transparent plastic film and a hard coat layer provided thereon, the transparent plastic film is further preferably the one subjected to an easy adhesion treatment. As commercially available PET films each with an easy adhesion layer, mention may be made of “COSMOSHINE A4100, and A4300” manufactured by Toray Industries, Inc., and the like.

2. Antireflection Film Forming Layer

The antireflection film of the invention can be obtained by mixing the foregoing various compounds, and coating the mixtures, and forming various functional layers. Then, the respective functional layers forming the antireflection film of the invention will be described.

2-1. Antiglare Layer

The antiglare layer is formed for the purpose of imparting the antiglare property due to the surface scattering specified in the invention, and preferably the hard coat property for improving the scratch resistance of the resulting antireflection film, to the film.

As the methods for forming an antiglare property, there are known the method in which a mat-like shape film having fine unevenness on the surface is laminated for the formation as described in JP-A-6-16851; the method in which the formation is achieved by curing and shrinkage of a ionizing radiation curable resin due to the difference in ionizing radiation dose as described in JP-A-2000-206317; the method in which the mass ratio of the good solvent to the light transmissive resin is reduced by drying, and thereby, the light transmissive fine particles and the light transmissive resin are solidified while causing gelation thereof to form unevenness on the coating film surface as described in JP-A-2000-338310; the method in which surface unevenness is given by external pressure as described in JP-A-2000-275404; and other methods. Also in the invention, these known methods can be used.

Preferably, the antiglare layer usable in the invention contains a binder capable of imparting a hard coat property, light transmissive particles (mat particles) for imparting the antiglare property, and a solvent as essential components, and has the surface unevenness formed by the projections of the light transmissive particles themselves, or the projections formed of aggregates of a plurality of particles.

The antiglare layer formed by dispersion of mat particles includes a binder, and light transmissive particles dispersed in the binder. The antiglare layer having an antiglare property preferably has both the antiglare property and the hard coat property.

The refractive index of the light transmissive resin is adjusted in accordance with the refractive index of each light transmissive particle selected from the particles. As a result, it is possible to implement the internal haze and the surface haze in the invention. Specifically, preferred is a combination of a light transmissive resin (the refractive index after curing is 1.55 to 1.70) containing a tri- or more functional (meth)acrylate monomer as a main component to be preferably used for the antiglare layer in a preferred embodiment of the invention described later, and light transmissive particles including a crosslinked poly(meth)acrylate polymer with a styrene content of 50 to 100 mass %, and/or benzoguanamine particles. Particularly preferred is a combination of the light transmissive resin and the light transmissive particles (the refractive index is 1.54 to 1.59) including crosslinked poly(styrene-acrylate) copolymer with a styrene content of 50 to 100 mass %.

The light transmissive particles are preferably added in the formed antiglare layer in an amount of 3 to 30 mass % based on the total solid content of the antiglare layer. More preferably, the particles are added therein in an amount of 5 to 20 mass %. By using the light transmissive particles in an amount of 3 mass % or more, it is possible to allow favorable antiglare property to be exerted. When the particles are used in an amount of 30 mass % or less, problems such as image blur, whitening of the surface, and glare do not occur.

The density of the light transmissive particles used is preferably 10 to 1000 mg/m², and more preferably 100 to 700 mg/m².

Whereas, the absolute value of the difference between the refractive index of the light transmissive resin and the refractive index of the light transmissive particles is preferably 0.04 or less. The absolute value of the difference between the refractive index of the light transmissive resin and the refractive index of the light transmissive particles is preferably 0.001 to 0.030, more preferably 0.001 to 0.020, and further preferably 0.001 to 0.015. When the difference is 0.040 or less, problems such as film character blur, the reduction of the darkroom contrast, and whitening of the surface do not occur.

Herein, the refractive index of the light transmissive resin can be quantitatively evaluated by direct measurement with an Abbe refractometer, or measurement of spectral reflection spectrum, spectral ellipsometry, or the like. The refractive index of the light transmissive particles can be measured in the following manner. Two solvents having different refractive indices are mixed in varying ratios. In the resulting solvents with varying refractive indices, the light transmissive particles are dispersed in equal amounts to determine the turbidities. Then, the refractive index of the solvent when the turbidity is minimum is measured by an Abbe refractometer.

Whereas, two or more types of mat particles having different particle diameters may be used in combination. This enables the following: mat particles with a larger particle diameter imparts the antiglare property, while mat particles with a smaller particle diameter impart another optical characteristic. For example, when an antiglare antireflection film is bonded to a 133-, or more ppi high definition display, a deficiency in displayed image quality referred to as “glare” may occur. The “glare” results from the following phenomenon. The pixels are enlarged or reduced due to the unevenness present on the antiglare antireflection film surface, so that the uniformity of the luminance is lost. However, this can be largely improved by using mat particles with a smaller particle diameter than that of the mat particles imparting the antiglare property, and with a different refractive index from that of the binder in combination.

The film thickness of the antiglare layer is preferably in a range of 1 to 10 μm, and more preferably in a range of 1.2 to 8 μm. When the film thickness is equal to or more than the lower limit value, the hard coat property will not become insufficient. When the film thickness is equal to or less than the upper limit value, problems such as degradation of the process suitability due to the generation of curl or the reduction of brittleness do not occur. Therefore, the film thickness is preferably set within the film thickness range.

On the other hand, the centerline average roughness (Ra) of the antiglare layer preferably falls within a range of 0.10 to 0.40 μm. When the Ra is 0.40 μm or less, problems such as glare and whitening of the surface when external light is reflected do not occur. Whereas, the value of the transmitted image visibility is preferably set at 5 to 60%.

The hardness of the antiglare layer is preferably H or more, further preferably 2H or more, and most preferably 3H or more in the pencil hardness test.

2-2. Hard Coat Layer

To the antireflection film of the invention, a hard coat layer can be provided in addition to the antiglare layer for imparting the physical strength of the film. Whereas, the hard coat layer contains light transmissive particles, and thereby it can also serve as an antiglare layer. Preferably, on the hard coat layer, a low refractive index layer is provided, further preferably, an intermediate refractive index layer, and a high refractive index layer are provided between the hard coat layer and the low refractive index layer. It is preferable that the antireflection film is thus formed.

The hard coat layer may also include a lamination of two more layers.

As for the refractive index of the hard coat layer in the invention, the refractive index preferably falls within a range of 1.48 to 2.00, more preferably 1.52 to 1.90, and further preferably 1.55 to 1.80 from the viewpoint of the optical design for obtaining an antireflection film. In a preferred embodiment of the invention, on the hard coat layer, at least one layer of the low refractive index layer is present. Therefore, when the refractive index is too smaller than this range, the antireflection property is reduced. When the refractive index is too large, the color taste of the reflected light tends to be intensified.

As for the film thickness of the hard coat layer, from the viewpoint of imparting sufficient durability and impact resistance to the film, the thickness of the hard coat layer is generally about 0.5 to 50 μm, preferably 1 to 20 μm, further preferably 2 to 10 μm, and most preferably 3 to 7 μm.

The hardness of the hard coat layer is preferably H or more, further preferably 2H or more, and most preferably 3H or more in the pencil hardness test.

Further, in a Taber test according to JIS K-5400, a smaller amount of the test piece to be worn between before and after the test is more preferred.

The hard coat layer is preferably formed by the crosslinking reaction or the polymerization reaction of an ionizing radiation curable compound. For example, it can be formed in the following manner. A coating solution containing ionizing radiation curable multifunctional monomers or multifunctional oligomers is coated on a transparent support. This effects the crosslinking reaction or the polymerization reaction of the multifunctional monomers or the multifunctional oligomers.

The functional groups of ionizing radiation curable multifunctional monomers and multifunctional oligomers are preferably photo-, electron beam, or radiation polymerizable ones. Out of these, photopolymerizable functional groups are preferred. As the photopolymerizable functional groups, mention may be made of unsaturated polymerizable functional groups such as a (meth)acryloyl group, a vinyl group, a styryl group, and an allyl group, and the like. Out of these, a (meth)acryloyl group is preferred.

In the hard coat layer, mat particles having an average particle diameter of 1.0 to 10.0 μm, and preferably 1.5 to 7.0 μm, such as inorganic compound particles or resin particles may be allowed to be contained for the purpose of imparting the internally scattering property thereto.

To the binder of the hard coat layer, high refractive index monomers or inorganic particles, or both of them can be added for the purpose of controlling the refractive index of the hard coat layer. The inorganic particles also have an effect of suppressing the curing and shrinkage due to the crosslinking reaction in addition to the effect of controlling the refractive index. In the invention, after the formation of the hard coat layer, the ones including the polymers generated from polymerization of the multifunctional monomers and/or high refractive index monomers, and the like, and inorganic particles dispersed therein are referred to as binders.

When the antireflection film of the invention is used for an image display device, preferably the uneven shape of the antireflection film surface is adjusted for the purpose of keeping the definition of the image, and in addition, the transmitted image visibility is adjusted. The transmitted image visibility of the clear antireflection film is preferably 60% or more. The transmitted image visibility is generally an index indicative of the degree of blur of the image shown through the film. A larger value thereof indicates that the image shown through the film is clearer and better. The transmitted image visibility is preferably 70% or more, and further preferably 80% or more.

2-3. High Refractive Index Layer, Intermediate Refractive Index Layer

To the antireflection film of the invention, as described above, the high refractive index layer, and the intermediate refractive index layer are provided. This can enhance the antireflection property.

In this specification, below, the high refractive index layer and the intermediate refractive index layer may be generically referred to as a high refractive index layer. Incidentally, in the invention, the terms “high”, “intermediate”, and “low” of the high refractive index layer, the intermediate refractive index layer, and the low refractive index layer, respectively, denote the relation in relative magnitude of refractive index among the layers. Further, in terms of the relation with the transparent support, the refractive indices preferably satisfy the relation of transparent support>low refractive index layer, high refractive index layer>transparent support.

Whereas, in this specification, the high refractive index layer, the intermediate refractive index layer, and the low refractive index layer may be generically referred to as an antireflection layer.

In order to form the low refractive index layer on the high refractive index layer for forming the antireflection film, the refractive index of the high refractive index layer is preferably 1.55 to 2.40, more preferably 1.60 to 2.20, further preferably 1.65 to 2.10, and most preferably 1.80 to 2.00.

When the intermediate refractive index layer, the high refractive index layer, and the low refractive index layer are sequentially coated in the increasing order of distance from the support to form an antireflection film, the refractive index of the high refractive index layer is preferably 1.65 to 2.40, and further preferably 1.70 to 2.20. The refractive index of the intermediate refractive index layer is adjusted so as to be the value between the refractive index of the low refractive index layer and the refractive index of the high refractive index layer. The refractive index of the intermediate refractive index layer is preferably 1.55 to 1.80.

The inorganic particles containing TiO₂ as a main component for use in the high refractive index layer and the intermediate refractive index layer are used in the form of a dispersion for the formation of the high refractive index layer and the intermediate refractive index layer.

The inorganic particles are desirably dispersed in the dispersion medium in the presence of a dispersant.

The high refractive index layer and the intermediate refractive index layer for use in the invention are preferably formed in the following manner. In the dispersion prepared by dispersing the inorganic particles in the dispersion medium, preferably, a binder precursor (such as the ionizing radiation curable multifunctional monomer or multifunctional oligomer) necessary for the matrix formation, a photopolymerization initiator, and the like are further added to prepare coating solutions for forming the high refractive index layer and the intermediate refractive index layer. The resulting coating solutions for forming the high refractive index layer and the intermediate refractive index layer are coated on a transparent support, and cured by the crosslinking reaction or the polymerization reaction of an ionizing radiation curable compound (such as a multifunctional monomer or a multifunctional oligomer).

Further, the binder in the high refractive index layer and the intermediate refractive index layer is preferably allowed to undergo a crosslinking reaction or a polymerization reaction with the dispersant simultaneously with coating or after coating of the layers.

As for the binder in the high refractive index layer and the intermediate refractive index layer produced in this manner, for example, the preferred dispersant and the ionizing radiation curable multifunctional monomer or multifunctional oligomer undergo a crosslinking or polymerization reaction. This results in the form in which the anionic group of the dispersant is incorporated in the binder. Further, in the binder in the high refractive index layer and the intermediate refractive index layer, the anionic group has a function of keeping the dispersion state of the inorganic particles, and the crosslinked or polymerized structure imparts a film forming ability to the binder, resulting in improvements of the physical strengths, the chemical resistances, and the weather resistances of the high refractive index layer and the intermediate refractive index layer containing the inorganic particles.

The binder of the high refractive index layer is added in an amount of 5 to 80 mass % based on the solid content of the coating solution of the layer.

The content of the inorganic particles in the high refractive index layer is preferably 10 to 90 mass %, more preferably 15 to 80 mass %, and in particular preferably 15 to 75 mass % based on the mass of the high refractive index layer. Two types or more inorganic particles may be used in combination in the high refractive index layer.

For the high refractive index layer, it is also possible to preferably use a binder obtainable by the crosslinking or polymerization reaction of an ionizing radiation curable compound containing an aromatic ring, an ionizing radiation curable compound containing a halogen element other than fluorine (e.g., Br, I, or Cl), an ionizing radiation curable compound containing an atom such as S, N, or P, or the like.

It is possible to design the high refractive index layer with an appropriate thickness according to the intended purpose. When the high refractive index layer is used as an optical interference layer described later, the thickness is preferably 30 to 200 nm, more preferably 50 to 170 nm, and in particular preferably 60 to 150 nm.

When the high refractive index layer does not contain particles imparting the antiglare function, it preferably has a lower haze. The haze is preferably 5% or less, further preferably 3% or less, and in particular preferably 1% or less.

The high refractive index layer is preferably formed on the transparent support directly, or with another layer interposed therebetween.

2-4. Low Refractive Index Layer

In order to reduce the reflectance of the antireflection film of the invention, a low refractive index layer is used.

The refractive index of the low refractive index layer is preferably 1.20 to 1.46, more preferably 1.25 to 1.46, and in particular preferably 1.30 to 1.46.

The thickness of the low refractive index layer is preferably 50 to 200 nm, and further preferably 70 to 100 nm. The haze of the low refractive index layer is preferably 3% or less, further preferably 2% or less, and most preferably 1% or less. The specific hardness of the low refractive index layer is preferably H or more, further preferably 2H or more, and most preferably 3H or more in the pencil hardness test under a load of 500 g.

Whereas, in order to improve the stain proof performance of the antireflection film, the contact angle to water of the surface is preferably 90° or more, further preferably 95° or more, and in particular preferably 100° or more.

The curable compositions to be preferably used for the formation of the low refractive index layer include a salt formed from a base satisfying the specific basicity and an acid of the item (1), and/or a salt formed from a base satisfying the specific boiling point range and an acid of the item (2), and if required, contain the fluorine-containing polymer, a crosslinking agent, further inorganic particles, and an organosilane compound.

For the low refractive index layer, the binder described in connection to the hard coat layer can also be used. However, for the binder itself, a low refractive index fluorine-containing polymer can be preferably used. Further, a fluorine-containing sol-gel material or the like can be used in combination. For the binder, a thermosetting compound of the invention is used. Other than this, a compound crosslinkable with ionizing radiation can be used in combination. Preferred is a material allowing the low refractive index layer surface to have a kinetic friction coefficient of 0.03 to 0.30, and a contact angle to water of 85 to 120°.

2-5. Antistatic Layer, Electrically Conductive Layer

In the invention, provision of the antistatic layer is preferable in terms of the antistatic property on the antireflection film surface. Examples of the method for forming an antistatic layer may include: conventionally known methods such as a method in which an electrically conductive coating solution containing electrically conductive fine particles and a reactive curable resin is coated; or a method in which a transparent film-forming metal, metal oxide, or the like is evaporated or sputtered to form an electrically conductive thin film. The electrically conductive layer can be formed on a support directly, or with a primer layer for strengthening the adhesion with the support interposed therebetween. Alternatively, the antistatic layer can also be used as a part of the antireflection film. In this case, in the case where it is used as a layer closer to the outermost layer, it is possible to obtain sufficient antistatic property even when the film thickness is small.

The thickness of the antistatic layer is preferably 0.01 to 10 μm or more, more preferably 0.03 to 7 μm, and further preferably 0.05 to 5 μm. The surface resistance of the antistatic layer is preferably 10⁵ to 10¹² Ω/sq, further preferably 10⁵ to 10⁹ Ω/sq, and most preferably 10⁵ to 10⁸ Ω/sq. The surface resistance of the antistatic layer can be measured by a four probe method.

The antistatic layer is preferably substantially transparent. Specifically, the haze of the antistatic layer is preferably 10% or less, more preferably 5% or less, further preferably 3% or less, and most preferably 1% or less. Whereas, the transmittance of light with a wavelength of 550 nm is preferably 50% or more, more preferably 60% or more, further preferably 65% or more, and most preferably 70% or more.

The antistatic layer in the invention is preferably excellent in hardness. The specific hardness of the antistatic layer is preferably H or more, more preferably 2H or more, further preferably 3H or more, and most preferably 4H or more in the pencil hardness under a load of 1 kg.

2-6. Stain Proof Layer

On the outermost surface of the antireflection film of the invention, a stain proof layer can be provided. The stain proof layer reduces the surface energy of the antireflection layer, which makes hydrophilic or oleophilic stains less likely to be attached thereon.

The stain proof layer can be formed using a fluorine-containing polymer or a stain proof agent.

The thickness of the stain proof layer is preferably 2 to 100 nm, and further preferably 5 to 30 nm.

2-7. Interference Unevenness (Spectral Unevenness) Preventive Layer

When there is a substantial difference in refractive index between the transparent support and the hard coat layer, or the transparent support and the antiglare layer in the antireflection film of the invention (the difference in refractive index is 0.03 or more), a reflected light occurs at the transparent support/hard coat layer, or transparent support/antiglare layer interface. The reflected light may interfere with a reflected light on the antireflection layer surface to generate interference unevenness caused by the subtle film thickness unevenness of the hard coat layer (or the antiglare layer). In order to prevent such an interference unevenness, for example, such an interference unevenness preventive layer as to have an intermediate refractive index nₚ, and to have a film thickness dₚ satisfying the following mathematic expression (2) can also be provided between the transparent support and the hard coat layer (or the antiglare layer):
dp=(2N−1)×λ/(4nₚ) Mathematical expression (2):
where λ is the wavelength of the visible light, and any value within a range of 450 to 650 nm, and N is a natural number.

Whereas, when the antireflection film is bonded to an image display or the like, on the side of the transparent support not having an antireflection layer stacked thereon, a self-adhesive layer (or an adhesive layer) may be stacked. In such an embodiment, when there is a substantial difference in refractive index (0.03 or more )between the transparent support and the self-adhesive layer (or the adhesive layer), a reflected light occurs at the transparent support/self-adhesive layer (or the adhesive layer). The reflected light may interfere with a reflected light at the antireflection layer surface to generate interference unevenness caused by the film thickness unevenness of the support or the hard coat layer in the same manner as described above. For the propose of preventing such an interference unevenness, the same interference unevenness preventive layer as described above can also be provided on the side of the transparent support not having an antireflection layer stacked thereon.

Incidentally, such an interference unevenness preventive layer is described in details in JP-A-2004-345333. In the invention, the interference unevenness preventive layer herein introduced can also be used.

2-8. Easy Adhesion Layer

On to the antireflection film of the invention, an easy adhesion layer can also be coated. The easy adhesion layer represents, for example, the layer for imparting the function of facilitating the adhesion between the protective film and the adjacent layer, or the hard coat layer and the support, when the antireflection film of the invention is used as a protective film for a polarizing plate.

As the easy adhesion treatment, mention may be made of a treatment of providing an easy adhesion layer on a transparent plastic film with an easy adhesive including polyester, an acrylic acid ester, polyurethane, polyethyleneimine, a silane coupling agent, or the like.

Examples of the easy adhesion layer to be preferably used in the invention may include the one containing a layer containing a polymer compound having a —COOM (where M represents a hydrogen atom or cation) group. A further preferred embodiment is the one configured such that a layer containing a polymer compound having a —COOM group is provided on the support side of the antireflection film, and a layer containing a hydrophilic polymer compound as a main component is provided on the polarizing film side adjacently thereto.

Examples of the —COOM group-containing polymer compound may include a —COOM group-containing styrene-maleic acid copolymer, a —COOM group-containing vinyl acetate-maleic acid copolymer, and a vinyl acetate-maleic acid-maleic anhydride copolymer. Particularly, a —COOM group-containing vinyl acetate-maleic acid copolymer is preferably used. Such polymer compounds can be used alone, or in combination of two or more thereof.

The preferred mass average molecular weight of the polymer compound is desirably about 500 to 500,000. As the particularly preferred examples of the —COOM group-containing polymer compound, the ones described in JP-A-6-094915, JP-A-7-333436, and the like are preferably used.

Whereas, as the hydrophilic polymer compounds, preferably, mention may be made of hydrophilic cellulose derivatives (e.g., methyl cellulose, carboxymethyl cellulose, and hydroxy cellulose), polyvinyl alcohol derivatives (e.g., polyvinyl alcohol, a vinyl acetate-vinyl alcohol copolymer, polyvinyl acetal, polyvinyl formal, and polyvinyl benzal), natural polymer compounds (e.g., gelatin, casein, and gum arabic), hydrophilic polyester derivatives (e.g., partially sulfonated polyethylene terephthalate), hydrophilic polyvinyl derivatives (e.g., poly-N-vinyl pyrrolidone, polyacrylamide, polyvinyl indazole, and polyvinyl pyrazole). These are used alone, or in combination of two or more thereof.

The thickness of the easy adhesion layer preferably falls within a range of 0.05 to 1.0 μm. When the thickness is 0.05 μm or more, sufficient adhesion can be obtained. Whereas, even when the thickness is larger than 1.0 μm, the effect of adhesion is not improved any more. Therefore, the easy adhesion layer preferably has a thickness within the range.

2-9. Anticurling Layer

The antireflection film of the invention can also be subjected to anticurling processing. The anticurling processing imparts a function for the film to tend to curl with the processed side inside. When the foregoing various functional layers are formed only on one side of a transparent resin film such as an antireflection film, the film becomes more likely to curl with the side having the various function layers formed thereon inside. The anticurling layer functions as preventing such curling from occurring.

Mention may be made of an embodiment in which the anticurling layer is provided on the back side of the antireflection film, i.e., on the surface on the side of the support opposite from the side having the antiglare layer or the antireflection layer. However, in the invention, for example, the easy adhesion layer may also be coated on the back side of the antireflection film. Mention may also be made of another embodiment in which the anticurling processing is applied onto the reverse side, i.e., on the side having the antiglare layer or the antireflection layer according to how curling occurs.

As the specific methods of anticurling processing, mention may be made of a method by solvent coating, and methods by coating of a solvent and a transparent resin layer of cellulose triacetate, cellulose diacetate, cellulose acetate propionate, or the like.

The method by solvent coating is specifically carried out by coating of a composition containing a solvent which dissolves a cellulose acylate film used as the support of an antireflection film, or a solvent which swells it. The coating solutions for the layer having an anticurling function are therefore preferably the ones containing ketone type or ester type organic solvents.

Preferred examples of the ketone type organic solvent may include acetone, methyl ethyl ketone, methyl isobutyl ketone, cyclohexanone, acetylacetone, diacetone alcohol, isophorone, ethyl-n-butyl ketone, diisopropyl ketone, diethyl ketone, di-n-propyl ketone, methyl cyclohexanone, methyl-n-butyl ketone, methyl-n-propyl ketone, methyl-n-hexyl ketone, and methyl-n-heptyl ketone. Preferred examples of the ester type organic solvent may include methyl acetate, ethyl acetate, butyl acetate, methyl lactate, and ethyl lactate.

However, the solvents to be used may include, other than the solvent which dissolves a cellulose acylate film and/or a solvent which swells it, further, a solvent which does not dissolve the film. The method is carried out using a composition obtained by mixing these in an appropriate ratio and in a coating amount according to the degree of curling of the transparent resin film, or the type of the resin. Other than this, even when transparent hard processing or antistatic processing is applied thereto, the anticurling function is exerted.

2-10. Water Absorption Layer

The antireflection film of the invention can be provided with a layer containing a water absorber. The water absorber can be selected from compounds having a water absorbing function, mainly from alkaline-earth metals. Examples thereof may include BaO, SrO, CaO, and MgO. Further, these can be also selected from metal elements such as Ti, Mg, Ba, and Ca. The particle size of the particles of these absorbers is preferably 100 nm or less, and further preferably 50 nm or less.

The water absorber-containing layers may be formed by using a vacuum deposition method or the like as with the antistatic layer. Nanoparticles may be formed with various methods. The thickness of the layer is preferably 1 to 100 nm, and more preferably 1 to 10 nm.

The water absorber-containing layer may be added between the support and the stacked layers (various functional layers containing an antireflection layer), at the uppermost layer of the stacked layers, in between the stacked layers, or in the organic layer or the antistatic layer in the stacked layers. When it is added to the antistatic layer, a co-deposition process is preferably used.

2-11. Primer Layer/Inorganic Thin Film Layer

For the antireflection film of the invention, a known primer layer or inorganic thin film layer is provided between the support and the stacked layers, which can enhance the gas barrier property, or the like.

Examples of the usable primer layer may include an acrylic resin, an epoxy resin, an urethane resin, and a silicone resin. In the invention, as the primer layers, organic/inorganic hybrid layers of these resin layers and inorganic thin film layers in combination are preferably provided. The inorganic thin film layer is preferably an inorganic vapor deposition layer or a dense inorganic coating thin film by a sol-gel process. The inorganic vapor deposition layers are preferably vapor deposition layers of silica, zirconia, alumina, and the like. The inorganic vapor deposition layer can be formed by a vacuum vapor deposition process, a sputtering process, or the like.

3. Layer Structure of Antireflection Film

For the antireflection films of the invention, the layers as described above can be used, and known layer structures can be used. For example, typical examples thereof may include the following ones:

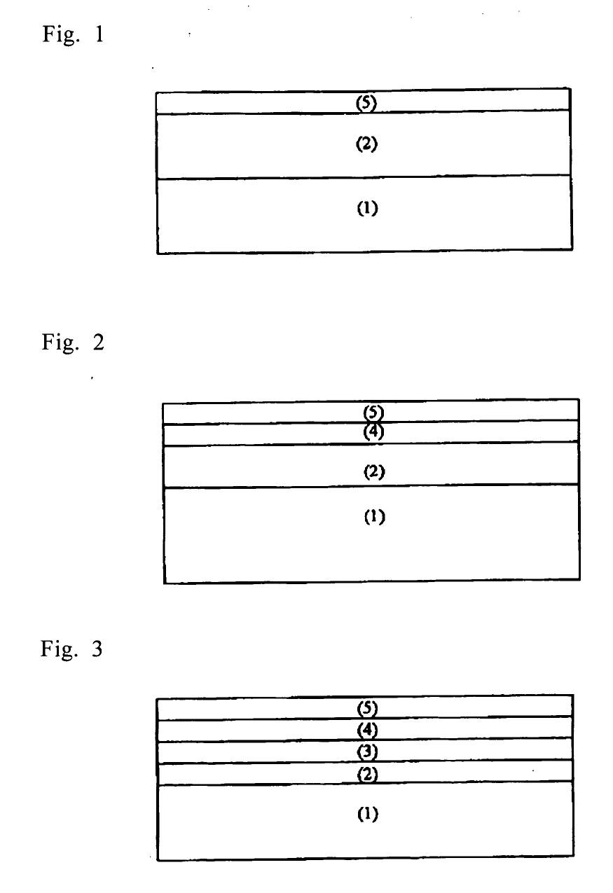

b. Support/hard coat layer/low refractive index layer (FIG. 1)

c. Support/hard coat layer/high refractive index layer/low refractive index layer (FIG. 2)

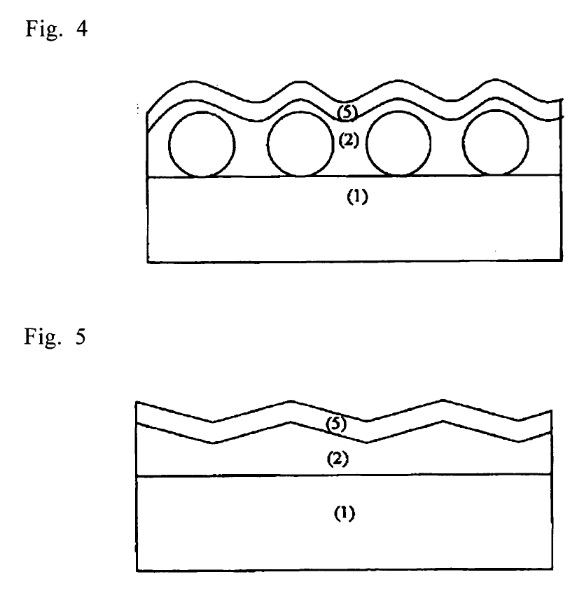

d. Support/hard coat layer/intermediate refractive index layer/high refractive index layer/low refractive index layer (FIG. 3)

The salts described in the first embodiment and the second embodiment of the invention, the fluorine-containing polymer having at least respective ones of a fluorine-containing vinyl monomer polymerization unit, and a hydroxyl group-containing vinyl monomer polymerization unit, and the crosslinking agents, are preferably contained in any layer of the foregoing constituent layers. However, they are most preferably contained in the low refractive index layer.

As with the foregoing item b (FIG. 1), on the support, the hard coat layer is coated, and the low refractive index layer is stacked thereon. The resulting film can be preferably used as an antireflection film. The low refractive index layer is configured as follows. On the hard coat layer, a low refractive index layer 4 is formed with a thickness equal to around ¼ the wavelength of light. As a result, it can reduce the surface reflection by the principle of thin-film interference.

Whereas, as with the item b (FIG. 2), on the support, the hard coat layer is coated, and the high refractive index layer and the low refractive index layer are stacked thereon. Even with this configuration, the resulting film can be preferably used as an antireflection film. Further, as with the item d (FIG. 3), by setting the layer structure in which the support, the hard coat layer, the intermediate refractive index layer, the high refractive index layer, and the low refractive index layer are stacked in this order, it is possible to set the reflectance to 1% or less.

In each layer structure of the antireflection films a to d, the hard coat layer (2) can be an antiglare layer having an antiglare property. The antiglare property may be imparted by dispersion of mat particles as shown in FIG. 4. Alternatively, it may also be formed by shaping the surface with a process of embossing or the like as shown in FIG. 5. The antiglare layer formed by dispersion of mat particles include a binder, and light transmissive particles dispersed in the binder. The antiglare layer having an antiglare property preferably has both the antiglare property and the hard coat property, and it may be configured in a multilayer form, for example, in a two-layer to 4-layer form.

Whereas, as a layer which can be provided between the support and a layer closer to the surface side than that, or the outermost surface, mention may be made of an interference unevenness (spectral unevenness) preventive layer, an antistatic layer (when a request to reduce the surface resistance value from the display side, or other requests are demanded, and when deposition of dust on the surface or the like becomes troublesome), another hard coat layer (when the hardness is insufficient with only one hard coat layer or antiglare layer), a gas barrier layer, a water absorption layer (moisture proof layer), an adhesion improvement layer, a stain proof layer (anti-contamination layer), or the like.

The refractive indices of respective layers forming the antiglare antireflection film having the antireflection layer in the invention preferably satisfy the following relationship:

Refractive index of hard coat layer>refractive index of transparent support>refractive index of low refractive index layer

4. Manufacturing Method of an Antireflection Film

The antireflection film of the invention can be formed by the following method. However, the invention is not limited to the method.

4-1. Preparation of Coating Solution

[Preparation of Each Layer-forming Coating Solution]

First, a coating solution containing the components for forming each layer is prepared. At this step, by minimizing the amount of the solvent to be vaporized, it is possible to suppress the increase in moisture content of the coating solution. The moisture content in the coating solution is preferably 5 mass % or less, and more preferably 2 mass % or less. The suppression of the amount of the solvent to be vaporized is achieved by the improvement of the airtightness of a tank during stirring after charging of each material into the tank, minimization of the contact area of the coating solution with air during solution transferring operation, and the like. Alternatively, a means for reducing the moisture content in the coating solution during coating, or before and after the process may also be provided.

[Coating Solution Physical Property]

With the coating process in the invention, the maximum speed at which coating thereof is possible is largely affected by the solution physical properties. Therefore, it is necessary to control the solution physical properties at the instant when coating is carried out, particularly, the viscosity and the surface tension.

The viscosity is preferably 2.0 mPa.sec or less, further preferably 1.5 mPa.sec or less, and most preferably 1.0 mPa.sec or less. Some coating solutions may vary in viscosity according to the shear rate. Therefore, the value represents the viscosity at the shear rate at the instant when coating is carried out. To the coating solution, a thixotropy agent is added. As a result, the viscosity is low at the time of coating under high shear, while the viscosity is high at the time of drying under almost no shear. Accordingly, favorably, nonuniformity during drying becomes less likely to occur.

Further, the amount of the coating solution to be applied onto the transparent support, which is not the solution physical property, also affects the maximum speed at which coating is possible. The amount of the coating solution to be applied onto the transparent support preferably falls within a range of 2.0 to 5.0 cc/m². When the amount of the coating solution to be applied onto the transparent support is increased, the maximum speed at which coating is possible increases. Therefore, the increase in amount is preferred. Whereas, when the amount of the coating solution to be applied onto the transparent support is excessively increased, the load required for drying increases. Therefore, the optimum amount of the coating solution to be applied onto the transparent support is preferably determined according to the solution formulation/process conditions.

The surface tension preferably falls within a range of 15 to 36 mN/m. The addition of a levelling agent, or the like for reducing the surface tension is preferred, because it suppresses the nonuniformity during drying. On the other hand, when the surface tension excessively decreases, the maximum speed at which coating is possible is reduced. Therefore, the surface tension more preferably falls within a range of 17 to 32 mN/m, and further preferably falls within a range of 19 mN/m to 26 mN/m.

[Filtration]

The coating solution to be used for coating is preferably filtrated before coating. The filter for filtration to be used preferably has the minimum pore diameter so long as it does not remove the components in the coating solution. For the filtration, a filter having an absolute filtration accuracy of 0.1 to 10 μm, and further preferably a filter having an absolute filtration accuracy of 0.1 to 5 μm is used. The thickness of the filter is preferably 0.1 to 10 mm, and further preferably 0.2 to 2 mm. In that case, filtration is carried out preferably under a filtration pressure of 1.5 MPa or less, more preferably 1.0 MPa or less, and further preferably 0.2 MPa or less.

The filtration filter member has no particular restriction unless it affects the coating solution. Specifically, mention may be made of the same ones as the filtration members for the wet dispersions of the inorganic compounds.

Whereas, it is also preferable that the filtered coating solution is ultrasonically dispersed immediately before coating, thereby to aid defoaming, and dispersing and holding of the dispersion.

4-2. Treatment Before Coating

The support for use in the invention is preferably subjected to a surface treatment before coating. As the specific methods, mention may be made of a corona discharge treatment, a glow discharge treatment, a flame treatment, an acid treatment, an alkali treatment, or an ultraviolet irradiation treatment. Whereas, as described in JP-A-7-333433, provision of an undercoat layer is also preferably utilized.

Further, as the dust removing methods for use in the dust removing steps as the steps to be carried out prior to coating, mention may be made of: dry dust removing methods such as a method in which a nonwoven fabric, a blade, or the like is pressed against the film surface described in JP-A-59-150571; a method in which an air with a high cleanliness is blown at a high speed, so that the deposited substances are peeled off from the film surfaces, and sucked from the adjacent suction port described in JP-A-10-309553; and a method in which an ultrasonically vibrating compressed air is blown, so that the deposited substances are peeled off, and sucked as described in JP-A-7-333613 (“New Ultracleaner” manufactured by SHINKO Co., Ltd., and the like).

Alternatively, there can be used wet dust removing methods such as a method in which a film is introduced in a cleaning tank, and the deposited substances are peeled off by means of an ultrasonic oscillator; a method in which to a film, a cleaning solution is fed, and then high speed air blowing and sucking are carried out, described in JP-B-49-13020; and a method in which a web is continuously rubbed with a roll wetted with a liquid, and then, a liquid is sprayed onto the rubbed surface for cleaning as described in JP-A-2001-38306. Out of such dust removing methods, the method by ultrasonic dust removal, or the method by wet dust removal is particularly preferred in terms of the dust removing effect.

Further, it is particularly preferable in terms of raising the dust removing efficiency, and suppressing the deposition of dust that the electrostatic charges on the film support is eliminated prior to carrying out such a dust removing step. For such a charge eliminating method, a corona discharge type ionizer, an ionizer of light irradiation type of UV, soft X rays, or the like can be used. The charged voltages of the film support before and after dust removal and coating is desirably 1000 V or less, preferably 300 V or less, and in particular preferably 100 V or less.

From the viewpoint of holding the flatness of the film, in these treatments, preferably the temperature of the cellulose acylate film is set at Tg or less, specifically, 150° C. or less.

When the cellulose acylate film is bonded with a polarizing film as in the case where the antireflection film of the invention is used as the protective film of the polarizing plate, an acid treatment or an alkali treatment, i.e., a saponification treatment on the cellulose acylate is in particular preferably carried out from the viewpoint of the adhesion with the polarizing film.

From the viewpoints of adhesion and the like, the surface energy of the cellulose acylate film is preferably 55 mNm or more, and further preferably 60 mNm or more and 75 mNm or less, and it can be adjusted by the foregoing surface treatments.

4-3. Coating

The respective layers of the antireflection film of the invention can be formed by the following coating methods, but the methods are non-limiting.

There are used known methods such as a dip coating method, an air knife coating method, a curtain coating method, a roller coating method, a wire bar coating method, a gravure coating method, and an extrusion coating method (die coating method) (see, U.S. Pat. No. 2,681,294), and a micro gravure coating method. Out of these, the micro gravure coating method and the die coating method are preferred.

The micro gravure coating method for use in the invention is a coating method characterized by rotating, a gravure roll having a diameter of about 10 to 100 mm, and preferably about 20 to 50 mm, and having a gravure pattern engraved in the entire circumferential surface, under the support and oppositely to the direction of transfer of the support; scraping off the excess coating solution from the surface of the gravure roll by a doctor blade; and thereby transferring a constant amount of the coating solution to the underside of the support at the position where the top side of the support is in the free state for coating. The transparent support in the rolled form is continuously wound. Onto one side of the wound support, at least one layer of the hard coat layer and the low refractive index layer including a fluorine-containing olefin type polymer can be coated by a micro gravure coating method.

As the coating conditions by the micro gravure coating method, the number of lines of the gravure pattern engraved in the gravure roll is preferably 50 to 800 lines/in, and more preferably 100 to 300 lines/in. The depth of the gravure pattern is preferably 1 to 600 μm, and more preferably 5 to 200 μm. The number of revolutions of the gravure roll is preferably 3 to 800 rpm, and more preferably 5 to 200 rpm. The transfer speed of the support is preferably 0.5 to 100 m/min, and more preferably 1 to 50 m/min.

In order to supply the film of the invention with a high productivity, the extrusion method (die coating method) is preferably used. A die coater preferably usable for the area small in wet coating amount (20 cc/m² or less) as with the hard coat layer or the antireflection layer is explained in JP-A-2006-122889 in detail

4-4. Drying

The antireflection film of the invention is preferably coated on the support directly, or with another layer interposed therebetween, and then it is transferred in the form of a web to a zone heated for drying the solvent. As the methods for drying the solvent, various findings can be utilized. As specific findings, mention may be made of the descriptions in JP-A-2001-286817, JP-A-2001-314798, JP-A-2003-126768, JP-A-2003-315505, JP-A-2004-34002, and the like.

The temperature of the drying zone is preferably 25° C. to 140° C. Preferably, the first half of the drying zone is at a relatively low temperature, and the latter half thereof is at a relatively high temperature. However, the temperature is preferably equal to, or less than the temperature at which other components than the solvents contained in the coating solutions for respective layers start to volatize. For example, out of commercially available photoradical generators to be used in combination with a UV curable resin, some volatize in an amount of around several tens mass % in 120° C. hot air in several minutes. Whereas, for some monofunctional or bifunctional acrylate monomers, and the like, volatilization thereof proceeds in 100° C. hot air. In such a case, as described above, the temperature is preferably equal to, or less than the temperature at which other components than the solvents contained in the coating solutions for respective layers start to volatize.

Whereas, the drying air after coating the coating solutions for respective layers on the support preferably has an air speed on the coating film surface of within a range of 0.1 to 2 m/sec in the period during which the solid content concentration of the coating solution is 1 to 50 mass %, for preventing uneven drying.

Further, when, after coating the coating solutions for respective layers on the support, the difference in temperature between a transfer roll in contact with the opposite side of the support from the coated side thereof and the support falls within a range of 0° C. to 20° C. in the drying zone, uneven drying caused by uneven heat transfer on the transfer roll can be prevented, and hence such a temperature difference is preferred.

4-5. Curing

The antireflection film of the invention is allowed to pass through a zone for curing each coating film by ionizing radiation and/or heat in the form of a web after drying the solvent. This can cure the coating film.

T The antireflection film of the invention is prepared preferably by being heat cured (heated) and cured with an active energy ray, in view of the curing of the low refractive index layer and strengthening of the bonding between the low refractive index layer and lower layer. The order of the heat curing and the curing with an active energy ray is not particulary limited, and for example, following combinations ( ) (1) to (5) can be applied.
(1): The heat curing and the curing with an active energy ray are conducted in this order.
(2): The curing with an active energy ray and the heat curing are conducted in this order.
(3): The first heat curing, the curing with an active energy ray and the second heat curing are conducted in this order.
(4): The first curing with an active energy ray, the heat curing and the second curing with an active energy ray are conducted in this order.
(5) The heat curing and the curing with an active energy ray are conducted simultaneously.

In the invention, the above combination (1) or (3) is particulary preferable in view of strengthening of the bonding between the low refractive index layer and lower layer. For example, in the case of the combination (1), it may be heated at a temperature of 70° C. or more and 130° C. or less for 5 minutes to 20 minutes, and after the heating, be cured by an active energy ray such as ultraviolet ray. The temperature of heat curing is preferably 70° C. or more and 120° C. or less, and still more preferably 80° C. or more and 115° C. or less.

The ionizing radiation species in the invention has no particular restriction. It can be appropriately selected from ultraviolet ray, electron beam, near-ultraviolet ray, visible light, near-infrared ray, infrared ray, X ray, and the like according to the type of the curable composition forming the film. An ultraviolet ray and an electron beam are preferred. An ultraviolet ray is particularly preferred in that handling thereof is easy, and high energy can be obtained with ease.

Any can be used as a light source of ultraviolet ray for photopolymerizing an ultraviolet ray reactive compound so long as it is a light source for generating an ultraviolet ray. For example, a low pressure mercury lamp, an intermediate pressure mercury lamp, a high pressure mercury lamp, a super high pressure mercury lamp, a carbon arc lamp, a metal halide lamp, or a xenon lamp can be used. Whereas, an ArF excimer laser, a KrF excimer laser, an excimer lamp, a synchrotron radiation, or the like can also be used. Out of these, a super high pressure mercury lamp, a high pressure mercury lamp, a low pressure mercury lamp, carbon arc, xenon arc, or a metal halide lamp can be preferably utilized.

Further, an electron beam can also be used similarly. As the electron beams, mention may be made of electron beams having an energy of 50 to 1000 keV, and preferably 100 to 300 keV, emitted from various electron beam accelerators of Cockroft Walton type, van de Graaff type, resonance transform type, insulating core transformer type, linear type, Dynamitron type, high frequency type, and the like.

The exposure conditions vary according to the respective lamps. The exposure dose is preferably 10 mJ/cm or more, further preferably, 50 mJ/cm² to 10000 mJ/cm², and in particular preferably 50 mJ/cm² to 2000 mJ/cm². In this step, the exposure dose distribution along the direction of width of the web is preferably 50 to 100% distribution, and more preferably 80 to 100% distribution covering opposite sides based on the maximum dose of the center.

In the invention, at least one layer stacked on the support is irradiated with ionizing radiation, and ionizing radiation is applied in an atmosphere with an oxygen concentration of 10% by volume or less with the film surface temperature heated to 60° C. or more for 0.5 second or more from the start of irradiation with ionizing radiation. It is preferable that curing is carried out by this step. Whereas, it is also preferable that heating is carried out in an atmosphere with an oxygen concentration of 3% by volume or less simultaneously and/or continuously with ionizing radiation irradiation. Particularly, it is preferable that the low refractive index layer which is the outermost layer and has a small film thickness is cured with this method. The curing reaction is accelerated with heat, which enables the formation of a film excellent in physical strength and chemical resistance.

The ionizing radiation exposure time is preferably 0.7 second or more and 60 seconds or less, and more preferably 0.7 second or more and 10 seconds or less. When the exposure time is 0.7 second or more, the curing reaction can be completed, and sufficient curing can be carried out. Whereas, when the exposure time is 60 seconds or less, the low-oxygen condition is not required to be kept for so long time. This does not result in the following disadvantages: the equipment is increased in scale, and a large quantity of inert gases become necessary. Therefore, such an exposure time is preferred.

The formation is preferably carried out by the crosslinking reaction or the polymerization reaction of the ionizing radiation curable compound in an atmosphere with an oxygen concentration of 6% by volume or less. Further preferably, the oxygen concentration is 4% by volume or less, in particular preferably, the oxygen concentration is 2% by volume or less, and most preferably, it is 1% by volume or less. Unless the oxygen concentration is reduced more than necessary, the amount of inert gases such as nitrogen to be used is not so large. Thus, such an amount is preferable from the viewpoint of the manufacturing cost.

The oxygen concentration is set at 10% by volume or less in the following manner. The air (nitrogen concentration: about 79% by volume, oxygen concentration: about 21% by volume) is preferably replaced with another gas, and in particular preferably replaced with nitrogen (purged with nitrogen).

By setting the conditions in which inert gases are supplied to an ionizing radiation exposure chamber, and slightly blows toward the web inlet of the exposure chamber, the air guided with web transfer is eliminated, which can effectively reduce the oxygen concentration of the reaction chamber, and can efficiently reduce the substantial oxygen concentration on the top surface on which high inhibition on curing due to oxygen is caused. The direction of flow of inert gases on the web inlet side of the exposure chamber can be controlled by adjusting the balance between air supply and exhaust of the exposure chamber, and the like. Direct blowing of inert gases onto the web surface is also preferably used as a method for eliminating the transferred air.

Further, by providing a front room in front of the reaction chamber, and previously eliminating the oxygen on the web surface, it is possible to promote curing with efficiency. Whereas, with the side forming the web inlet side of the ionizing radiation reaction chamber or the front chamber, the gap from the web surface is preferably 0.2 to 15 mm, more preferably 0.2 to 10 mm, and most preferably 0.2 to 5 mm in order to use inert gases with efficiency.

However, in order to continuously manufacture webs, the webs are required to be bonded together, and connected. For bonding, a method for bonding with a bonding tape is widely used. Thus, when the gap between the inlet side of the ionizing radiation reaction chamber or the front chamber and the web is set to be too narrow, unfavorably, a bonding member such as a bonding tape is caught therein. For this reason, for narrowing the gap, preferably, at least a part of the inlet side of the ionizing radiation reaction chamber or the front chamber is set movable. Thus, when the bonded part enters, the gap is expanded by the bonding thickness. For implementing this, there can be employed a method in which the inlet side of the ionizing radiation reaction chamber or the front chamber is set movable to and fro along the direction of advance, so that the inlet side moves to and fro when the bonded part passes therethrough, thereby to expand the gap; and a method in which the inlet side of the ionizing radiation reaction chamber or the front chamber is set movable perpendicularly to the web side, so that the inlet side moves vertically when the bonded part passes therethrough, thereby to expand the gap.

For curing, the film side is heated preferably to 60° C. or more and 170° C. or less. When it is heated to 60° C. or more, curing with heating is sufficiently carried out. When it is heated to 170° C. or less, the problem such as deformation of the base material does not occur. The further preferred temperature is 60° C. to 100° C. The film side denotes the film side of the layer to be cured. Whereas, the time during which the film is at this temperature is preferably 0.1 second or more and 300 seconds or less, and further preferably 10 seconds or less, from the start of UV exposure. Unless the time during which the temperature of the film side is kept within the foregoing temperature range is too short, it is possible to sufficiently promote the reaction of the curable composition forming the film. Whereas, unless the time is too long, the problems in manufacturing such as reduction of the optical performances of the film, and the increase in scale of equipment do not occur.

The heating method has no particular restriction. However, a method in which a roll is heated, and brought in contact with the film, a method in which heated nitrogen is blown thereto, irradiation with far infrared radiation or infrared radiation, or the like is preferred. The method in which a medium such as hot water or vapor/oil is flowed to a rotary metal roll for heating, described in Japanese Patent No. 2523574 can also be employed. As a heating means, a dielectric heating roll or the like can also be used.

For ultraviolet irradiation, the irradiation may be carried out for each of a plurality of the constituent layers every time one layer is provided, or the irradiation may be carried out after lamination. Alternatively, the irradiation may be carried out with the combined method thereof. From the viewpoint of the productivity, preferably, a multilayer structure is laminated, and then irradiated with ultraviolet radiation.

In the invention, at least one layer stacked on the support can be cured through a plurality of cycles of ionizing radiation exposure. In this case, at least two cycles of ionizing radiation exposure are preferably carried out in continuous reaction chambers with an oxygen concentration of not more than 3% by volume. By carrying out a plurality of cycles of ionizing radiation exposure in the reaction chambers with the same low oxygen concentration, it is possible to effectively ensure the reaction time required for curing. Especially when the manufacturing rate is raised for the high productivity, a plurality of cycles of ionizing radiation exposure become necessary for ensuring the energy of ionizing radiation required for the curing reaction.

Further, when the curing rate (100−residual functional group content) is a value of less than 100%, and another layer is provided thereon, and cured with ionizing radiation and/or heat, the curing rate of the lower layer becomes higher than that before the provision of the upper layer. As a result, the adhesion between the lower layer and the upper layer is improved, which is preferable.

4-6. Handling

In order to continuously manufacture the antireflection film of the invention, a step of continuously feeding a roll-like support film, a step of coating/drying the coating solution, a step of curing the coating film, and a step of coiling the support film having the cured layer are carried out.

A film support is continuously fed from the roll-like film support to a clean chamber. In the clean chamber, electrostatic charges accumulated on the film support are eliminated by an electrostatic charge eliminating device. Subsequently, foreign matters deposited on the film support are removed by a dust removing device. Subsequently, at a coating part set in the clean chamber, a coating solution is coated on the film support, and the coated film support is fed to a drying chamber, and dried.

The film support having the dried coated layer is fed from the drying chamber to a curing chamber, where the monomers contained in the coated layer are polymerized and cured. Further, the film support having the cured layer is fed to a curing part, where the curing is completed. The film support having the completely cured layer is coiled in a roll.

The foregoing steps may be carried out for every formation of each layer. Alternatively, a plurality of sections of coating part—drying chamber—curing part are provided, which enables continuous formation of respective layers.

For manufacturing of the antireflection film of the invention, as described above, the following procedure is preferred. Simultaneously with the precision filtering operation of the coating solution, the coating step at the coating part, and the drying step in the drying chamber are carried out under an air atmosphere with high cleanliness. In addition, dust and dirt on the film are sufficiently removed prior to carrying out coating. The air cleanliness in the coating step and the drying step is desirably Class 10 (353 particles of 0.5 μm or more/m³ or less) or more, and, desirably, further preferably Class 1 (35.5 particles of 0.5 μm or more/m³ or less ) or more, based on the standard of the air cleanliness in United States Federal Standard 209E. Further, the air cleanliness is more preferably high also in other feeding and coiling parts, and the like, than in the coating—drying step.

4-7. Saponification Treatment

When the antireflection film of the invention is used as one of two surface protective films of a polarizing film for manufacturing a polarizing plate, preferably, the surface on the side to be bonded with the polarizing film is made hydrophilic, thereby to improve the adhesion of the bonding side.

a. Method of Immersion in an Alkali Solution

This is a method for immersing the film in an alkali solution under appropriate conditions, and subjecting the portions having a reactivity with an alkali in the entire film surface to a saponification treatment. This method does not require specific equipment, and hence it is preferred from the viewpoint of the cost. The alkali solution is preferably a sodium hydroxide aqueous solution. The concentration is preferably 0.5 to 3 mol/L, and in particular preferably 1 to 2 mol/L. The solution temperature of the alkali solution is preferably 30 to 75° C., and in particular preferably 40 to 60° C. The combination of the saponification conditions is preferably a combination between relatively mild conditions. However, it can be set according to the material and the structure of the film, and the objective contact angle.

Preferably, after immersion in the alkali solution, the film is sufficiently washed with water, or immersed in a dilute acid to neutralize the alkali component for preventing the alkali component in the film from remaining.

By carrying out the saponification treatment, both of the surface having the coating layer and the opposite surface are made hydrophilic. The protective film for a polarizing plate is used with the surface of the transparent support which has been made hydrophilic, bonded to the polarizing film.

The surface which has been made hydrophilic is effective for improving the adhesion with the adhesion layer containing polyvinyl alcohol as a main component.

For the saponification treatment, a lower contact angle to water of the surface of the transparent support opposite from the side having the coating layer is more preferred from the viewpoint of the adhesion with the polarizing film. On the other hand, with the immersion method, the region from the surface having the coating layer to the inside may be damaged simultaneously by an alkali. Therefore, it is important to set the necessary minimum reaction conditions. In the case where the contact angle to water of the surface on the opposite side of the transparent support is used as the index of damage imposed on each layer by alkali, it is preferably 10 to 50°, more preferably 30 to 50°, and further preferably 40 to 50°, especially when the transparent support is triacetyl cellulose. When the contact angle to water is 50° or less, no problem occurs in the adhesion with the polarizing film. Thus, such a contact angle is preferred. On the other hand, when the contact angle to water is 10° or more, the following problems do not occur: the damages imposed on the film are too large, so that the physical strength is impaired, and other problems. Thus, such a contact angle is preferred.

b. Method for Coating an Alkali Solution

As a means for avoiding damages on respective layers with the immersion method, the following alkali solution coating method is preferably used. Under proper conditions, the alkali solution is applied only onto the surface on the opposite side from the side having the coating layer, and heated, washed with water, and dried. Incidentally, the term “coating” in this case means the contact of an alkali solution or the like only with the side to be subjected to saponification, and it covers, other than coating, the cases where it is carried out by spraying, contact with a belt containing the solution or the like. By adopting these methods, additionally, equipment and steps for coating an alkali solution become necessary. For this reason, the methods are inferior to the immersion method of a from the viewpoint of the cost. On the other hand, the alkali solution comes in contact with only the side to be subjected to a saponification treatment. Therefore, the surface on the opposite side can have a layer using a material less resistant to an alkali solution. For example, a vapor deposition film or a sol-gel film may undergo various effects such as corrosion, dissolution, and peeling by the alkali solution. Therefore, with the immersion method, it is not easy to provide these layers. However, with this coating method, it is possible to provide these layers with no problems because the layers do not come in contact with the solution.

Either saponification method of the items a and b can be carried out after winding the support from the roll-like support, and forming respective layers. Therefore, a series of operations may also be carried out additionally after the antireflection film manufacturing steps. Further, similarly, by continuously carrying out the step of bonding with the polarizing film including the wound support in combination, it is possible to manufacture a polarizing plate more efficiently than when the same operation is carried out on the sheet form.

c. Method of Protection with a Laminate Film for Saponification

As with the item b, when the coating layer has an insufficient resistance to an alkali solution, the following procedure is possible. After the formation of up to the final layer, a laminate film is bonded to the side having the final layer formed thereon. Then, the lamination is immersed in an alkali solution. As a result, only the triacetyl cellulose side opposite from the side having the final layer formed thereon can be made hydrophilic. In this case, the laminate film may be peeled off after the saponification treatment. Also with this method, an enough hydrophilization treatment for the polarizing plate protective film can be carried out only on the side opposite from the side having the final layer of the triacetyl cellulose film formed thereon without damages onto the coating layer. As compared with the method of the item b, the laminate film is produced as a waste, while there is an advantage that a specific apparatus for coating an alkali solution is not necessary.

d. Method of Immersion in an Alkali Solution After the Formation Up to the Middle Layer

When the layers down to the lower layer have a resistance to an alkali solution, but the upper layer has an insufficient resistance to an alkali solution, the following procedure is also possible. After the formation of down to the lower layer, the lamination is immersed in an alkali solution, so that the opposite sides are subjected to a hydrophilization treatment. Then, the upper layer is formed. This results in a complicated manufacturing step. However, for example, for a film including an antiglare layer and a low refractive index layer of a fluorine-containing sol/gel film, there is an advantage that the interlayer adhesion between the antiglare layer and the low refractive index layer is improved when the low refractive index layer has a hydrophilic group.

e. Method for Forming a Coating Film on a Previously Saponified Triacetyl Cellulose Film

A triacetyl cellulose film is previously immersed in an alkali solution, or subjected to other procedures, to be saponified. Thus, the coating layer may be formed on any one side directly, or with another layer interposed therebetween. When saponification is accomplished through immersion in an alkali solution, the interlayer adhesion between the triacetyl cellulose side which has been made hydrophilic by saponification and the coating layer formed may be deteriorated. In such a case, the problem can be solved in the following manner. After saponification, only the side on which the coating layer is formed is subjected to a treatment of corona discharge, glow discharge, or the like. Thus, the side which has been made hydrophilic is removed, and then, the coating layer is formed. Whereas, when the coating layer has a hydrophilic group, the interlayer adhesion may be favorable.

4-8. Manufacturing of Polarizing Plate

The antireflection film of the invention can be used as a protective film to be disposed on one side or opposite sides of a polarizing film, thereby to manufacture a polarizing plate.

In that case, as one protective film, the antireflection film of the invention can be used, and as the other protective film, a general cellulose acetate film can be used. Whereas, a cellulose acetate film manufactured by the solution film forming method, and drawn along the direction of width in the roll film form at a draw ratio of 10 to 100%, and the antireflection film of the invention obtained by forming a coating film on the film in such a roll film form by means of the die coater or the like are preferably used.

Further, in accordance with a preferred embodiment of the polarizing plate in the invention, one side thereof is an antireflection film, while the other protective film is an optical compensation film having an optically anisotropic layer including a liquid crystalline compound.

The polarizing films include an iodine type polarizing film, and a dye type polarizing film and a polyene type polarizing film using a dichroic dye. The iodine type polarizing film and the dye type polarizing film are generally manufactured by the use of a polyvinyl alcohol type film.

The alignment was set so that the slow axis of the transparent support of the antireflection film or the cellulose acetate film, and the transmission axis of the polarizing film are substantially in parallel to each other.

For the productivity of the polarizing plate, the moisture permeability of the protective film is important. The polarizing film and the protective film are bonded to each other with an aqueous adhesive. The solvent for this adhesive is dispersed in the protective film, and thereby dried. The higher the moisture permeability of the protective film is, the higher the drying speed is. This results in an improvement of the productivity. When the moisture permeability becomes too high, moisture may enter into the polarizing film according to the use environment (under high humidities) of a liquid crystal display device.

The moisture permeability of the protective film is determined by the thickness, free volume, hydrophilicity or hydrophobicity, or the like of the polymer film (and the polymerizable liquid crystalline compound) which is a transparent support.

When the antireflection film of the invention is used as a protective film of the polarizing plate, the moisture permeability is preferably 100 to 1000 g/m²·24 hrs, and further preferably 300 to 700 g/m²·24 hrs.

The thickness of the transparent support can be adjusted by the lip flow rate and the line speed, or drawing and compression, for film formation. The moisture permeability varies according to the main material to be used, and hence it can be set within a preferred range by the thickness adjustment.

The free volume of the transparent support can be adjusted by the drying temperature and time for film formation. Also in this case, the moisture permeability varies according to the main material used, and hence it can be set in a preferred range by the free volume adjustment.

The hydrophilicity and the hydrophobicity of the transparent support can be adjusted by additives. Addition of a hydrophilic additive in the free volume results in an increase in moisture permeability. Conversely, addition of a hydrophobic additive can reduce the moisture permeability.

By independently controlling the moisture permeability, it becomes possible to manufacture a polarizing plate having an optical compensation ability at a low cost with high productivity.

As the polarizing films, there may be used known polarizing film, and a polarizing film cut out from a long length of polarizing film of which the absorption axis is not in parallel with, nor perpendicular to the longitudinal direction. The long length of the polarizing film of which the absorption axis is not in parallel with, nor perpendicular to the longitudinal direction is fabricated in the following manner.

Namely, it is a polarizing film obtained by drawing a continuously fed polymer film under a tension while holding the opposite sides of the film by a holding means. It can be manufactured by the following drawing method. The film is drawn at least to 1.1 to 20.0 times its original length in the direction of film width; the difference in advance speed along the longitudinal direction of the holding device for the film opposite sides falls within 3%; and the direction of advance of the film is bent with the opposite sides being held so that the angle of inclination formed between the direction of advance of the film at the outlet in the step of holding the film opposite sides and the substantial drawing direction of the film is 20 to 70°. Particularly, the one with an angle of inclination of 45° is preferably used from the viewpoint of the productivity.

The drawing method of the polymer film is described in details in paragraph Nos. [0020] to [0030] of JP-A-2002-86554.

It is also preferable that out of the two protective films of the polarizing film, the other film than the antireflection film is an optical compensation film including an optical compensation layer having optical anisotropy. The optical compensation film (phase film) can improve the viewing angle characteristics of the liquid crystal display screen. As the optical compensation films, known ones can be used. However, the optical compensation film described in JP-A-2001-100042 is preferred in terms of expansion of the viewing angle.

5. Use Form of Antireflection Film of the Invention

The antireflection film of the invention is used for an image display device such as a liquid crystal display device (LCD), a plasma display panel (PDP), an electroluminescence display (ELD), or a cathode ray tube (CRT). The antireflection filter in accordance with the invention can be used on a known display such as a plasma display panel (PDP) or a cathode ray tube (CRT).

5-1. Liquid Crystal Display Device

The antireflection film of the invention, and a polarizing plate using the same can be advantageously used for an image display device such as a liquid crystal display device, and they are preferably used for the outermost layer of the display.

The liquid crystal display device has a liquid crystal cell, and two polarizing plates disposed on the opposite sides thereof. The liquid crystal cell carries a liquid crystal between two electrode substrates. Further, one optically anisotropic layer is disposed between the liquid crystal cell and one polarizing plate, or two layers may be disposed between the liquid crystal cell and both the polarizing plates.

The liquid crystal cell is preferably of the TN mode, the VA mode, the OCB mode, the IPS mode or the ECB mode.

[TN Mode]

In the TN mode liquid crystal cell, when applied with no voltage, rod-like liquid crystalline molecules are substantially horizontally oriented, and further twistedly oriented at 60 to 120°.

The TN mode liquid crystal cells are most often used for color TFT liquid crystal display devices, and described in a large number of documents.

[VA Mode]

In the VA mode liquid crystal cell, when applied with no voltage, rod-like liquid crystalline molecules are substantially vertically oriented.

The VA mode liquid crystal cells include:
(1) a VA mode liquid crystal cell in a narrow sense (described in JP-A-2-176625) in which rod-like liquid crystalline molecules are substantially vertically oriented when applied with no voltage, and substantially horizontally oriented when applied with a voltage; in addition to this,
(2) (MVA mode) liquid crystal cell in which the VA mode has been rendered in a multidomain alignment for expanding the viewing angle {described in SID97, Digest of tech. Papers (Digest of Papers), 28th, (1997), p. 845};
(3) Liquid crystal cell of the monde (n-ASM mode) in which rod-like liquid crystalline molecules are substantially vertically oriented when applied with no voltage, and oriented in a twisted multidomain alignment when applied with a voltage (described in Digest of Papers of the Japanese Liquid Crystal Forum, 58 to 59 (1998)); and
(4) SURVAIVAL mode liquid crystal cell (published in “LCD International 98”).
   [OCB Mode]

The OCB mode liquid crystal cell is a liquid crystal cell of the bend orientation mode in which rod-like liquid crystalline molecules are oriented substantially in opposite directions (symmetrically) at the upper portion and at the lower portion of the liquid crystal cell. It is disclosed in each specification of U.S. Pat. Nos. 4,583,825 and 5,410,422. The rod-like liquid crystalline molecules are symmetrically oriented at the upper portion and the lower portion of the liquid crystal cell, and hence the bend orientation mode liquid crystal cell has a self optical compensatory function. For this reason, this liquid crystal mode is also referred to as OCB (Optically Compensatory Bend) liquid crystal mode. The bend orientation mode liquid crystal display device has an advantage of having a high response speed.

[IPS Mode]

The IPS mode liquid crystal cell is of a system of applying a nematic liquid crystal with a horizontal electric field for switching. It is described in details in Proc. IDRC (Asia Display '95), p. 577 to 580, and p. 707 to 710.

[ECB Mode]

In the ECB mode liquid crystal cell, rod-like liquid crystalline molecules are substantially horizontally oriented when applied with no voltage. The ECB mode is one of the liquid crystal display modes having the simplest structure, and it is described in details, for example, JP-A-5-203946.

5-2. Other Display Than Liquid Crystal Display Devices

[PDP]

A plasma display panel (PDP) generally includes a gas, glass substrates, electrodes, an electrode lead material, a thick film printing material, and a phosphor. The glass substrates include two substrates of a front glass substrate and a rear glass substrate. On the two glass substrates, electrodes and insulating layers are formed. On the rear glass substrate, a phosphor layer is further formed. The two glass substrates are assembled, and a gas is filled therebetween.

The plasma display panels (PDPs) have been already commercially available. The plasma display panels are described in each publication of JP-A-5-205643 and JP-A-9-306366.

The front panel may be disposed at the front of the plasma display panel. The front panel preferably has a sufficient strength for protecting the plasma display panel. The front panel can be used on the plasma display panel with a gap interposed therebetween, or it can also be directly bonded to the plasma main body for use.

For an image display device such as a plasma display panel, as an optical filter, the antireflection film of the invention can be directly bonded to the display surface. Whereas, when a front panel is provided in front of a display, to the surface side (outer side) or the rear side (display side) of the front panel, an antireflection film as an optical filter can also be boded.

[Touch Panel]

The antireflection film of the invention can be applied to the touch panel described in JP-A-5-127822, JP-A-2002-48913, or the like.

[Organic EL Element]

The antireflection film of the invention can be sued as a substrate (base material film) or a protective film of an organic EL element, or the like.

When the antireflection film of the invention is used for an organic EL element, or the like, the contents described in various publications of JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617, JP-A-2002-056976, and the like are applicable. Further, these are preferably used in combination with the contents described in respective publications of JP-A-2001-148291, JP-A-2001-221916, and JP-A-2001-231443.

6. Various Characteristic Values

Below, various measuring methods and the preferred characteristic value for the antireflection film of the invention will be shown.

6-1. Reflectance

The mirror reflectance and the color taste can be measured in the following manner. A spectro photometer “V-550” [manufactured by JASCO Corporation] is equipped with an adaptor “ARV-474”. Thus, the mirror reflectance at an output angle of −5° with an incident angle of 5° within a wavelength region of 380 to 780 nm is measured. Then, the average reflectance over 450 to 650 nm is calculated. As a result, the antireflection property can be evaluated.

The antiglare antireflection film of the invention preferably has a mirror reflectance of 2.0% or less, and a transmittance of 90% or more, because such a film can inhibit the reflection of external light, so that the visibility is improved. The mirror reflectance is in particular preferably 1.5% or less. Most preferably, the reflectance is set to be 1.0% or less by using such a layer structure as described in the item d of the above-described paragraph starting from “3. Layer structure of Antireflection film”.

6-2. Color Taste

As for a polarizing plate using the antireflection film of the invention as the protective film, the color taste can be evaluated in the following manner. The color taste of the regular reflection light, i.e., the L*, a*, and b* values in the CIE 1976 L*a*b* color space are determined for the incident light at an incident angle of 5° within a wavelength region of from 380 nm to 780 nm of the CIE standard source D₆₅.

The L*, a*, and b* values preferably fall within the ranges of 3≦L*≦20, −7≦a*≦7, and −10≦b*≦10, respectively. By setting the values within these ranges, respectively, the color taste of the red-purple to blue-purple reflection light, which has become a problem for a conventional polarizing plate, is reduced. Further, it is largely reduced by setting the values within the ranges of 3≦L*≦10, 0≦a*≦5, and −7≦b*≦0, respectively. In the case where the film is applied to a liquid crystal display device, the color taste when an external light with a high luminance such as a light from a fluorescent lamp has been slightly reflected therein is neutral, and not annoying. Specifically, when a*≦7, the red tinge does not become too intense. When a*≧−7, the cyan tinge does not become too intense. Thus, these cases are preferable. Whereas, when b*≧−7, the blue tinge does not become too intense. When b*≦0, the yellow tinge does not become too intense. Thus, these cases are preferable.

Further, the color taste uniformity of a reflection light can be obtained as the rate of change in color taste according to the following mathematical expression (3) from a*, and b* on the L*a*b* chromaticity diagram determined by the reflection spectrum at 380 nm to 680 nm of the reflected light.

$$\begin{matrix}Mathematical expression ( 3 ) \text{:} & \\ Rate of change in color taste ( {a}^{*} ) = \frac{{a}_{max}^{*} - {a}_{min}^{*}}{{a}_{av}^{*}} \times 100 \\ Rate of change in color taste ( {b}^{*} ) = \frac{{b}_{max}^{*} - {b}_{min}^{*}}{{b}_{av}^{*}} \times 100 & \end{matrix}$$

where a*ₘₐₓ and a*ₘᵢₙ are the maximum value and the minimum value of the a* value, respectively; b*ₘₐₓ and b*ₘᵢₙ are the maximum value and the minimum value of the b* value, respectively; and a*ₐᵥ and b*ₐᵥ are the average values of the a* values and the b* values, respectively. Each rate of change in color is preferably 30% or less, more preferably 20% or less, and most preferably 8% or less.

Whereas, for the film of the invention, the ΔE_{w} which is the change in color taste between before and after the weather resistance test, is preferably 15 or less, more preferably 10 or less, and most preferably 5 or less. Within this range, it is possible to implement both low reflection and reduction of color taste of reflected light. Therefore, for example, when the film is applied to the outermost surface of an image display device, the color taste when an external light with a high luminance such as a light from an indoor fluorescent lamp has been slightly reflected therein is neutral, and the quality of the displayed images is favorable. Thus, such a case is preferable.

The change in color taste ΔE_{w} can be determined according to the following mathematical expression (4).
ΔE_{w}=[(ΔL_{w})²+(Δa_{w})²+(Δb_{w})²]^{1/2} Mathematical expression (4):

where ΔL_{w}, Δa_{w}, and Δb_{w} are the amounts of changes in L* value, a* value, and b* value between before and after the weather resistance test, respectively.

6-3. Transmitted Image Visibility

The transmitted image visibility can be measured by the use of an optical comb with a slit width of 0.5 mm with an image clarity measuring device “ICM-2D model” manufactured by SUGA TEST Instruments Co., Ltd., according to JIS K-7105.

The transmitted image visibility is generally an index indicative of the degree of blur of the image seen through the film. A larger value thereof indicates that the image shown through the film is clearer and better. The transmitted image visibility of the antireflection film of the invention is preferably 60% or more, and further preferably 70 to 97%. It is most preferably 80 to 95% for achieving both sufficient antiglare property, and the improvements of image blur and darkroom contrast reduction.

6-4. Surface Roughness

The measurement of the centerline average roughness (Ra) can be carried out according to JIS B-0601. The antiglare antireflection film of the invention is preferably designed so that, in terms of the surface uneven shape, the centerline average roughness Ra is 0.08 to 0.30 μm; the 10-point average roughness Rz, 10 times Ra, or less; the average peak to valley distance Sm, 1 to 100 μm; the standard deviation of the height of the concave portion from the deepest portion in the uneven surface, 0.5 μm or less; the standard deviation of the average peak to valley distance Sm with reference to the center line, 20 μm or less; and the side with a tilt angle of 0 to 5° accounts for 10% or more. This is because sufficient antiglare property, and visual uniform mat feeling are achieved. When Ra is 0.08 or more, a sufficient antiglare property is obtained. Whereas, when Ra is 0.30 or less, problems such as glare, and whitening of the surface when external light is reflected do not occur.

6-5. Haze

The haze of the antireflection film of the invention denotes the haze value specified according to JIS K7 105. It is automatically measured as haze=(diffused light/entire transmitted light)×100 (%) measured by means of a turbidity meter “NDH-1001DP” manufactured by Nippon Denshoku Industries Co., Ltd. based on the measuring method specified according to JIS K7136. The haze value determined in this manner is also referred to as a total haze value.

The total haze value in the invention is the total value of the internal haze and the surface haze described below. It is preferably 5 to 35%, more preferably 10 to 32%, and most preferably 17 to 30%.

Whereas, the antiglare antireflection film of the invention has a haze due to internal scattering (which is hereinafter referred to as an internal haze) of preferably 0% to 30%, more preferably 5% to 30%, further preferably 5% to 25%, and in particular preferably 7 to 20% as the optical characteristics. Even an internal haze of less than 5% is preferred from the viewpoint of bright room contrast improvement. However, when the internal haze is 5% or more, the combinations of usable materials increase in variety, and matching between the antiglare property and other characteristic values is relatively easy. Further, a high cost is not required. Thus, such a value is more preferred. When the internal scattering is 30% or less, the darkroom contrast is not be degraded.

Further, the haze due to surface scattering (which is hereinafter referred to as a surface haze) is required to be 1% or more and less than 10%, preferably 2% or more and less than 7%, and in particular preferably 2% to 5%. When the surface haze is 1% or more, favorable antiglare property is shown. When the surface haze is less than 10%, problems such as whitening of the surface when external light is reflected do not occur.

The surface haze and the internal haze can be set to fall within their respective desirable ranges by adjusting the refractive index of light transmissive particles.

Furthermore, the effect of improving the scratch resistance when the salt for use in the invention has been added was remarkable with the antireflection film having a surface haze of less than 10%. The fact that the effect of salt addition varies according to the surface haze is unexpected. However, a lower surface haze results in higher visibility of scratches. Thus, the effects of the invention are considered to be remarkably observable.

Incidentally, the surface haze and the internal haze can be measured in the following procedure.
(1) The total haze value (H) of the antireflection film is measured according to JIS K7136;
(2) Onto the surface on the low refractive index layer side and the opposite side of the antireflection film, several drops of silicone oil are added dropwise. Then, the film is sandwiched from the opposite sides by the use of two glass sheets with a thickness of 1 mm {“Micro slide glass product No. S9111”, manufactured by MATSUNAM1 Glass IND Ltd.}. Thus, a complete optical adhesion between the two glass sheets and the antireflection film is established. The haze is measured with the surface haze removed. Then, a value obtained by subtracting the value separately measured with only silicone oil sandwiched between two glass sheets therefrom is calculated as the internal haze(Hi) of the film; and
(3) A value obtained by subtracting the internal haze (Hi) calculated in the item (2) from the total haze (H) measured in the item (1) is calculated as the surface haze (Hs) of the film.
   6-6. Scratch Resistance
   [Steel Wool Abrasion Resistance Evaluation]

A rubbing test is carried out by means of a rubbing tester under the following conditions, so that the index of the scratch resistance can be obtained.

Evaluation environment conditions: 25° C., 60% RH

Rubbing material: steel wool {grade No. 0000 manufactured by Japan Steel Wool Co., Ltd.} is wound around the rubbing tip (1 cm×1 cm) of the tester to be in contact with a sample, and fixed with a band.

Stroke (one way): 13 cm

Rubbing speed: 13 cm/sec,

Load: 500 g/cm², and 200 g/cm²

Tip contact area: 1 cm×1 cm, and

Number of cycles of rubbing: 10 reciprocations.

To the back side of the sample which has been completely rubbed, an oil-based black ink is applied. Thus, the scratches at the rubbed part are visually observed with reflected light, or the difference in reflected light amount from the part other than the rubbed part is visually observed. Thus, the evaluation is carried out.

[Eraser Scratch Resistance Evaluation]

A rubbing test is carried out by means of a rubbing tester under the following conditions, so that the index of the scratch resistance can be obtained.

Evaluation environment conditions: 25° C., 60% RH

Rubbing material: plastic eraser {“MONO” manufactured by Tombow Pencil Co., Ltd.} is fixed at the rubbing tip (1 cm×1 cm) of the tester to be in contact with a sample.

Stroke (one way): 4 cm

Rubbing speed: 2 cm/sec,

Load: 500 g/cm²

Tip contact area: 1 cm×1 cm, and

Number of cycles of rubbing: 100 reciprocations.

To the back side of the sample which has been completely rubbed, an oil-based black ink is applied. Thus, the scratches at the rubbed part are visually observed with reflected light, or the difference in reflected light amount from the part other than the rubbed part is visually observed. Thus, the evaluation is carried out.

[Taber Test]

With the taber test according to JIS K-5400, it is possible to evaluate the scratch susceptibility from the abrasion loss of a test piece before and after the test. The smaller abrasion loss is more preferred.

6-7. Hardness

[Pencil Hardness]

The hardness of the antireflection film of the invention can be evaluated with the pencil hardness test according to JIS K-5400. The pencil hardness is preferably H or more, further preferably 2H or more, most preferably 3H or more.

[Surface Elastic Modulus]

The surface elastic modulus of the antireflection film of the invention is the value determined by the use of a micro surface harness meter {“Fischer scope H100VP-HCU”: manufactured by Fischer Instruments K. K.}. Specifically, it is the elastic modulus determined in the following manner. By the use of a quadrangular pyramid indenter made of diamond (apex angle between opposite faces; 136°), the indentation depth under an appropriate test load is measured so long as the indentation depth does not exceed 1 μm. Thus, the elastic modulus is determined from the changes in load and displacement with the load being removed.

[Universal Hardness]

Alternatively, the surface hardness can also be determined as a universal hardness by the use of the micro surface meter. The universal hardness is the value determined in the following manner. The indentation depth under a test load of a quadrangular pyramid indenter is measured. The surface area of the indentation formed under the test load is calculated from the geometrical form of the indention. Then, the test load is divided by the surface area of the indentation. It is known that the surface elastic modulus and the universal hardness has a positive correlation.

The universal hardness of the crosslinkable polymer defined in the invention is expressed as the universal hardness (N/mm²) determined for the crosslinkable polymer film with a thickness of about 20 to 30 μm cured and formed on a glass plate by means of a micro harness meter “H100” manufactured by Fischer Instruments K. K., in the following measuring procedure.

A coating solution with a solid content concentration of about 25 mass %, containing, other than the crosslinkable polymer, necessary catalyst, crosslinking agent, polymerization initiator, and the like is applied onto a polished slide glass (26 mm×76 mm×1.2 mm) manufactured by TOSHINRIKO. Co., Ltd., by selecting a proper bar coater so that the film thickness after curing is about 20 to 30 μm. When the crosslinkable polymer is heat curable, the heat curing conditions under which the film is sufficiently cured are previously determined (as one example, 125° C., 10 minutes). Also when the crosslinkable polymer is ionizing radiation curable, similarly, the heat curing conditions under which the film is sufficiently cured are previously determined (as one example, oxygen concentration 12 ppm, UV dose 750 mJ/cm²). For each film, the load is continuously increased from 0 to 4 mN. Thus, with the thickness 1/10 the film thickness not affecting the glass plate hardness of the base material as the maximum, a diamond pyramid indenter is pressed therein. Thus, the universal hardness is calculated from the N=6 measurement average value of F/A where F denotes each load in this case, and A denotes the indentation area (mm²) for the load F.

Further, the surface hardness can be determined by the nanoindentation described in JP-A-2004-354828. Preferably, the hardness in this case is 2 GPa to 4 aGPa, and the nanoindentation elastic modulus is 10 GPa to 30 GPa.

6-8. Stain Proof Property Test

[Magic Wiping Property]

An antireflection film is fixed on a glass plate with a self adhesive. Under the conditions of 25° C., 60 RH %, a 5-mm dia circle is drawn three times with a pen tip (fine) of a black “Magic Ink” (“Mckee extra fine”) {trade name: manufactured by Zebra Co., Ltd.}. After 5 seconds, it is wiped off through 20 reciprocations of “BEMCOT” folded in ten layers {trade name: manufactured by Asahi Kasei Corporation} under such a degree of load that the bundle of “BEMCOT” is dented. Until the “Magic Ink” mark is eliminated with wiping off, the writing and the wiping off are repeated under the same conditions. Thus, the stain proof property can be evaluated by the number of cycles of wiping off whereby the wiping off can be completed.

The number of cycles required until the wiping operation becomes incapable of elimination is preferably 5 or more, and further preferably 10 or more.

The evaluation can also be carried out in the following manner. For the black “Magic Ink”, “Magic Ink No. 700 (M700-T1 black) extra fine” is used. On a sample, a 1-cm dia circle is drawn and filled in, and it is rubbed with “BEMCOT” after 24-hour standing. Then, the evaluation is carried out based on whether the “Magic Ink” can be wiped off, or not.

6-9. Contact Angle

By the use of a contact angle meter [“CA-X” model contact angle meter, manufactured by KYOWA INTERFACE SCIENCE Co., Ltd.], a droplet with a diameter of 1.0 mm is formed on the needle tip using pure water as a liquid in dry state (20° C., 65% RH). This is brought in contact with the surface of the film to form a droplet on the film. Out of the angles formed between the tangent to the liquid surface and the film surface at a point at which the film comes in contact with the liquid, the angle on the side inclusive of the liquid is referred to as a contact angle.

The contact angle of the film of the invention is preferably 94° or more, further preferably 97° or more, and most preferably 101° or more, to the pure water.

6-10. Surface Free Energy

The surface energy can be determined by a contact angle method, a wet heat method, and an adsorption method, as described in NURE NO KISO TO OUYOU, published by REALIZE Inc., issued in 1989, Dec., 10. For the film of the invention, the contact angle method is preferably used. Specifically, two solutions having known surface energies are added dropwise on a cellulose acylate film. Out of the angles formed between the tangent drawn to the droplet and the film surface at the point of intersection of the droplet surface and the film surface, the angle inclusive of the droplet is defined as the contact angle. It is possible to calculate the surface energy of the film by calculation.

The surface free energy (γS^{v}: unit, mN/m) of the antireflection film of the invention represents the surface tension of the antireflection film defined as the value γS^{v}(=γS^{d}+γS^{h}) expressed as the sum of γS^{d} and γS^{h} determined by the following simultaneous equations a and b, from the respective contact angles θ_{H2O} and θ_{CH212} of pure water H₂O and methylene iodide CH₂I₂ experimentally determined on the antireflection film, using for reference, J. Appl. Polym. Sci., vol. 13, p. 1741 (1961) of D. K. Owens. A smaller γS^{v} and a lower surface free energy result in higher surface repellency, so that the stain proof property is generally excellent.
1+cos θ_{H2O}=2√γs^{d}(√γ_{H2O}^{d}/γ_{H2O}^{v})+2√γs^{h}(√γ_{H2O}^{h}/γ_{H2O}^{v}) a.
1+cos θ_{CH2I2}=2γs^{d}(√γ_{CH2I2}^{d}/γ_{CH2I2}^{v})+2√γs^{h}(√γ_{CH2I2}^{h}/γ_{CH2I2}^{v}) b.
γ_{H2O}^{d}=21.8, γ_{H2O}^{h}=51.0, γ_{H2O}^{v}=72.8,
γ_{CH2I2}^{d}=49.5, γ_{CH2I2}^{h}=1.3, γ_{CH2I2}^{v}=50.8
Under the foregoing conditions, the measurement of the contact angle was carried out in the following manner. The antireflection film was humidity controlled under the conditions of 25° C., 60% RH for 1 hour or more. Then, by the use of an automatic contact angle meter “CA-V 150 model”, manufactured by KYOWA INTERFACE SCIENCE Co., Ltd., 2 μL of droplets was added dropwise on the film. Then, after 30 seconds, the contact angle was determined.

The surface free energy of the antireflection film of the invention is preferably 25 mN/m or less, and in particular preferably 20 mN/m or less.

6-11. Curl

The measurement of the curl is carried out using a template for curl measurement of the method A in “Method for measuring the curl of a photographic film” of JIS K-7619-1988.

The measurement conditions are 25° C., 60% RH, and a humidity control time of 10 hours.

For the antireflection film in the invention, the value indicative of the curl expressed as the following mathematical expression (5) preferably falls within a range of −15 to +15, more preferably in a range of −12 to +12, and further preferably −10 to +10. The measuring direction in the sample for curl is along the direction of transfer of the base material when coating is carried out in the web form.
Curl=1/R Mathematical expression (5):
where R is the radius of curvature (m)

This is an important characteristic for preventing crack or film peeling from occurring in film manufacturing or processing, or handling in the market. It is preferable that the curl value falls within the foregoing range, and that the curl is small. Herein, the curl being “+” represents the curl such that the coated side of the film is the inside of the curve. Whereas, “−” represents the curl such that the coated side is the outside of the curve.

Whereas, for the film in the invention, the absolute value of the difference between respective curl values when only the relative humidity has been changed to 80% and 10% based on the curl measuring method is preferably 24 to 0, further preferably 15 to 0, and most preferably 8 to 0. This is the characteristic related to the handling property, peeling, and crack when the film has been bonded under various humidities.

6-12. Adhesion Evaluation

The adhesion between layers of the antireflection film, or between the support and the coating layer can be evaluated in the following manner.

In the surface on the side having the coating layer, 11 incisions and 11 incisions are made longitudinally and transversely, respectively, at an interval of 1 mm in a grid with a cutter knife to scribe a total of 100 square cells. Then, a polyester adhesive tape “No. 31B” manufactured by NITTO DENKO Corporation is pressure bonded thereon. After 24-hour standing, it is peeled off therefrom. This test is repeated 3 times at the same position. Then, whether peeling has occurred or not is visually observed.

Peeling occurs preferably in 10 or less cells, and further preferably in 2 or less cells out of the 100 cells.

6-13. Brittleness Test (Crack Resistance)

The crack resistance is an important characteristic for preventing a fracture defect from occurring due to handling such as coating, processing, or cutting of the antireflection film, coating of a self-adhesive, or bonding to various objects.

The antireflection film sample is cut into pieces of 35 mm×140 mm, and allowed to stand for 2 hours under the conditions of a temperature of 25° C., and 60% RH. Then, the diameter of curvature with which cracking starts to occur when the film is rolled in a tube is measured. Thus, the cracking of the surface can be evaluated.

As for the crack resistance of the film of the invention, the diameter of curvature with which cracking occurs when the film is rolled with the coating layer side facing outwardly is preferably 50 mm or less, more preferably 40 mm or less, and most preferably 30 mm or less. As for the cracking at the edge portion, it is preferable that there is no crack, or that the length of the crack is less than 1 mm on an average.

6-14. Dust Removability

The antireflection film of the invention is bonded onto a monitor. Dust (fiber wastes of padded mattress and clothes) is sprinkled on the monitor surface, and the dust is wiped off with a cleaning cloth. Thus, the dust removability can be evaluated.

It is preferable that the dust can be completely removed through 6 cycles of wiping operations, and it is further preferable that the dust can be completely removed through 3 or less cycles of wiping operations.

6-15. Performances of Liquid Crystal Display Device

Below, a description will be given to the characteristic evaluation method and the preferred conditions when the antireflection film of the invention is used on the display device.

The polarizing plate on the visible side provided in a liquid crystal display device “TH-15TA2” {manufactured by Matsushita Electric Industrial Co., Ltd.} using a TN type liquid crystal cell is peeled off. Instead, the antireflection film or the polarizing plate of the invention is bonded via a self-adhesive so that the coating side is the visible side, and that the transmission axis of the polarizing plate is in alignment with that of the polarizing plate bonded onto the product. In a 500-Lx bright room, the liquid crystal display device is set in a black display state, so that the following various characteristics can be evaluated visually from various visual angles.

[Evaluation of Nonuniformity of Image and Color Taste]

By the use of the manufactured liquid crystal display device, the nonuniformity and color taste changes during black display (L1) are visually evaluated by a plurality of observers.

When 10 observers evaluate them, the number of observers, who can recognize the nonuniformity, the left and right color taste changes, the color taste changes due to temperature and humidity, and white blur, is preferably 3 or less. It is more preferable that no observer can recognize them.

Whereas, the glare of external light is caused by the use of a fluorescent lamp, and the changes in glare can be relatively visually evaluated.

[Light Leakage During Black Display]

The light leakage rate during black display at an orientation of 45° from the front of the liquid crystal display device, and at a polar angle direction of 70° is measured. The light leakage rate is preferably 0.4% or less, and more preferably 0.1% or less.

[Contrast and Viewing Angle]

As for the contrast and the viewing angle, by the use of a measuring machine “EZ-Contrast 160D” (manufactured by ELDIM Co.), the contrast ratio, and the viewing angles in the lateral direction (the direction orthogonal to the rubbing direction of the cell) (the extent of the range of angle resulting in a contrast ratio of 10 or more) can be examined.

### EXAMPLES

Below, the invention will be fuirther described in details by way of examples, which should not be construed as limiting the scope of the invention. Incidentally, % represents mass % in the following Examples and Synthetic Examples, unless otherwise stated.

<Manufacturing of Antireflection Film>

### Example 1

[Synthesis of Fluorine-containing Polymer]

### Synthetic Example 1

### Synthesis of Fluorine-containing Polymer (P2)

Into an autoclave equipped with a stirrer made of stainless steel, with an internal volume of 100 mL, 18.5 g of ethyl acetate, 8.8 g of hydroxyethyl vinyl ether (HEVE), 1.0 g of “Silaplane FM-0725” {manufactured by Chisso Corporation)}, and 0.40 g of “V-65” (heat radical generator, manufactured by Wako Pure Chemical Industries, Ltd.} were charged. Degassing and nitrogen gas replacement in the system were carried out. Further, 15 g of hexafluoropropylene (HFP) was introduced in to the autoclave, and the temperature was increased up to 62° C. The pressure when the temperature in the autoclave had reached 62° C. was 8.9 kg/cm². While holding the inside of the autoclave at 62° C., the reaction was continued for 9 hours. Then, at the instant when the pressure had reached 6.2 kg/cm , the heating was stopped, and the autoclave was allowed to cool.

At the instant when the internal temperature decreased to room temperature, unreacted monomers were removed, and the autoclave was opened to recover the reaction solution. The obtained reaction solution was charged into a mixture of a large excess of hexane and 2-propanol. Then, the solvent was removed by decantation to recover the precipitated polymer. Further, the polymer was dissolved in a small amount of ethyl acetate, and reprecipitation from a mixture of hexane and 2-propanol was carried out twice. As a result, the residual monomers were completely removed, followed by vacuum drying, resulting in 8.3 g of a fluorine-containing polymer (P2). The number average molecular weight of the resulting polymer was 17000.

### Synthetic Example 2

### Synthesis of Fluorine-containing Polymer (P3)

Into an autoclave equipped with a stirrer made of stainless steel, with an internal volume of 100 mL, 30 g of ethyl acetate, 8.8 g of hydroxyethyl vinyl ether (HEVE), 0.88 g of “VPS-1001” {macroazo initiator: manufactured by Wako Pure Chemical Industries, Ltd.}, and 0.29 g of lauroyl peroxide were charged. Degassing and nitrogen gas replacement in the system were carried out. Further, 15 g of hexafluoropropylene (HFP) was introduced into the autoclave, and the temperature was increased up to 70° C. The pressure when the temperature in the autoclave had reached 70° C. was 9.0 kg/cm². While holding the inside of the autoclave at 70° C., the reaction was continued for 9 hours. Then, at the instant when the pressure had reached 6.0 kg/cm², the heating was stopped, and the autoclave was allowed to cool.

At the instant when the internal temperature decreased to room temperature, unreacted monomers were removed, and the autoclave was opened to recover the reaction solution. The obtained reaction solution was charged into a mixture of a large excess of hexane and 2-propanol. Then, the solvent was removed by decantation to recover the precipitated polymer. Further, the polymer was dissolved in a small amount of ethyl acetate, and reprecipitation from a mixture of hexane and 2-propanol was carried out twice. As a result, the residual monomers were completely removed, followed by vacuum drying, resulting in 19.3 g of a fluorine-containing polymer (P3). The number average molecular weight of the resulting polymer was 21000.

### Synthetic Examples 3 and 4

### Synthesis of Fluorine-containing Polymers (P1) and (P12)

Fluorine-containing polymers (P1) and (P12) were synthesized almost in the same manner as with the Synthetic Example 1. The respective number average molecular weights of the resulting fluorine-containing polymers are as shown in Tables 1 and 2 in this text.

### Synthetic Example 5

### Synthesis of p-toluenesulfonic acid salt

3.0 g of diethyl methyl amine was dissolved in 30 mL of 2-butanone, and 5.7 g of p-toluenesulfonic acid monohydrate was added little by little with stirring. Further, after another-hour stirring, the solvent was distilled off under reduced pressure. The resulting solid was recrystallized from acetone, thereby to obtain a diethylmethylamine salt of p-toluenesulfonic acid.

(Preparation of Sol)

In a reactor equipped with a stirrer and a reflux condenser, 120 parts of methyl ethyl ketone, 100 parts of acryloyloxypropyl trimethoxysilane {KBM5103, manufactured by Shin-Etsu Chemical Co., Ltd.), and 3 parts of diisopropoxy aluminum ethyl acetoacetate (trade name: Chelope EP-12, manufactured by Hope Chemical Co., Ltd.} were added and mixed. Then, 30 parts of ion exchange water was added thereto. The resulting mixture was allowed to react at 60° C. for 4 hours, and then cooled down to room temperature, resulting in a sol. The mass average molecular weight was 1600. Out of the components equal to or larger than oligomer components in size, the components with a molecular weight of 1000 to 20000 were found to account for 100%. Whereas, the gas chromatography analysis indicated that no acryloyloxypropyl trimethoxysilane of the raw material remained at all.

[Manufacturing of Antireflection Film]

[Preparation of Coating Solutions for Low Refractive Index Layer (LLL-1 to LLL-30]

Respective components shown in Table 4 were mixed, and the mixture was dissolved in a mixed solution of methyl ethyl ketone (MEK) and methyl isobutyl ketone (MIBK) (mixing ratio 30:70), thereby to produce each coating solution for a low refractive index layer with a solid content of 6%.

TABLE 4

| | | Coating solution for Low refractive index layer | | | | | | | | | | | |
|---|---|---|---|---|---|---|---|---|---|---|---|---|---|
| | | Fluorine- | | Curing | | Curing | | | | | | Inorganic | |
| | | containing | | agent | | catalyst | | | Polysiloxane | | Sol | particles | |
| | No. | Type | Amount | Type | Amount | Acid | Base | Amount | Type | Amount | Amount | Type | Amount |
| Invention | LLL-1 | P12 | 49 | H-2a | 17 | PTS | b-23 | 1 | — | — | 8 | Hollow | 25 |
| Invention | LLL-2 | P12 | 49 | H-1a | 17 | PTS | b-23 | 1 | — | — | 8 | Hollow | 25 |
| Invention | LLL-3 | P12 | 49 | CY303 | 17 | PTS | b-23 | 1 | — | — | 8 | Hollow | 25 |
| Invention | LLL-4 | P12 | 49 | MX-270 | 17 | PTS | b-23 | 1 | — | — | 8 | Hollow | 25 |
| Invention | LLL-5 | P12 | 49 | H-2a | 17 | DBS | b-23 | 1 | — | — | 8 | Hollow | 25 |
| Invention | LLL-6 | P12 | 49 | H-2a | 17 | BS | b-23 | 1 | — | — | 8 | Hollow | 25 |
| Invention | LLL-7 | P12 | 49 | H-2a | 17 | Phosphonic | b-23 | 1 | — | — | 8 | Hollow | 25 |
| Invention | LLL-8 | P12 | 49 | H-2a | 17 | Phosphoric | b-23 | 1 | — | — | 8 | Hollow | 25 |
| Invention | LLL-9 | P12 | 49 | H-2a | 17 | Acetic acid | b-23 | 1 | — | — | 8 | Hollow | 25 |
| Invention | LLL-10 | P12 | 44 | H-2a | 15 | PTS | b-23 | 1 | — | — | 15 | Hollow | 25 |
| Invention | LLL-11 | P12 | 55 | H-2a | 19 | PTS | b-23 | 1 | — | — | 0 | Hollow | 25 |
| Invention | LLL-12 | P12 | 59 | H-2a | 20 | PTS | b-23 | 1 | — | — | 10 | Hollow | 10 |
| Invention | LLL-13 | P12 | 65 | H-2a | 23 | PTS | b-23 | 1 | — | — | 11 | — | — |
| Invention | LLL-14 | P12 | 73 | H-2a | 25 | PTS | b-23 | 2 | — | — | 0 | — | — |
| Compar- | LLL-15 | P12 | 49 | H-2a | 17 | PTS | b-19 | 1 | — | — | 8 | Hollow | 25 |
| ative | | | | | | | | | | | | | |
| Invention | LLL-16 | P12 | 49 | H-2a | 17 | PTS | b-1 | 1 | — | — | 8 | Hollow | 25 |
| Invention | LLL-17 | P12 | 49 | H-2a | 17 | PTS | b-3 | 1 | — | — | 8 | Hollow | 25 |
| Invention | LLL-18 | P12 | 49 | H-2a | 17 | PTS | b-23 | 1 | — | — | 8 | MEK-ST1 | 25 |
| Invention | LLL-19 | P12 | 55 | H-2a | 19 | PTS | b-23 | 1 | — | — | 10 | MEK-ST1 | 10 |
| Invention | LLL-20 | P12 | 49 | H-2a | 17 | PTS | b-23 | 1 | — | — | 8 | Hollow | 25 |
| Invention | LLL-21 | P12 | 49 | H-2a | 17 | PTS | b-23 | 1 | — | — | 8 | Hollow | 25 |
| Invention | LLL-22 | P12 | 49 | H-2a | 17 | PTS | b-23 | 1 | — | — | 8 | Hollow | 25 |
| Invention | LLL-23 | P12 | 49 | H-2a | 17 | PTS | b-23 | 1 | — | — | 8 | Hollow | 25 |
| Invention | LLL-24 | P2 | 49 | H-2a | 17 | PTS | b-23 | 1 | — | — | 8 | Hollow | 25 |
| Invention | LLL-25 | P3 | 49 | H-2a | 17 | PTS | b-23 | 1 | — | — | 8 | Hollow | 25 |
| Invention | LLL-26 | P1 | 49 | H-2a | 17 | PTS | b-23 | 1 | — | — | 8 | Hollow | 25 |
| Invention | LLL-27 | P1 | 47 | H-2a | 17 | PTS | b-23 | 1 | FM | 2 | 8 | Hollow | 25 |
| Invention | LLL-28 | P1 | 47 | H-2a | 17 | PTS | b-23 | 1 | CMS | 2 | 8 | Hollow | 25 |
| Invention | LLL-29 | P1 | 47 | H-2a | 17 | PTS | b-23 | 1 | X-22 | 2 | 8 | Hollow | 25 |
| Invention | LLL-30 | P12 | 47 | H-2a | 17 | PTS | b-23 | 1 | X-22 | 2 | 8 | Hollow | 25 |

Incidentally, each numerical value of the amount used in Table 4 represents mass % of the solid content (or effective component) of each component occupied in the solid content of the coating solution for a low refractive index layer. Whereas, the abbreviations in Table 4 are as follow:
CY303: “CYMEL 303”, manufactured by Nihon Cytec Industries Inc., methyloled melamine.
MX-270: “NIKALAC MX-270”, manufactured by Sanwa Chemical Co., Ltd., tetramethoxymethyl glycol uryl.
MEK-STL: “MEK-STL”, manufactured by Nissan Chemical Industries, Ltd, colloidal silica, particles size 45 nm.
FM: “Silaplane FM-4425”, manufactured by Chisso Corporation, a silicone type compound.
CMS: “CMS-626”, manufactured by Gelest Co., a silicone type compound.
X-22: “X-22-160AS”, manufactured by Shin-Etsu Chemical Co., Ltd., a silicone type compound.

Whereas, “hollow silica” represents hollow silica (particle size 50 nm), manufactured by Catalysts & chemicals Industries Co., Ltd., and “H-1A” and “H-2A” in the columns of Curing agent represent the compounds of the following structure, respectively:

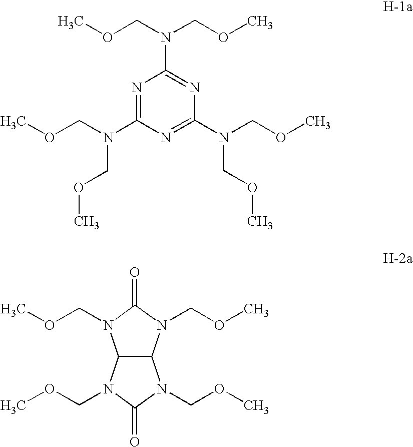

The name of each acid of the curing catalyst is expressed as the abbreviation described in this text. The pKa and the boiling point of the base of each curing catalyst used will be shown below.

| Base | :pKa | :boiling point |
|---|---|---|
| b-23 | 10.5 | 64 |
| b-19 | 10.7 | 88.8 |
| b-1 | 5.1 | 64 |
| b-3 | 5.7 | 115 |

[Preparation of Coating Solution for Antiglare Layer (HCL-1)]

| | |
|---|---|
| “PET-30” | 50.0 g |
| “IRGACURE 184” | 2.0 g |
| “SX-350” (30%) | 1.5 g |
| Crosslinked acrylic-styrene particles (30%) | 13.9 g |
| “KBM-5103” | 10.0 g |
| Toluene | 38.5 g |

The mixed solution was filtrated through a filter made of polypropylene with a pore diameter of 30 μm to prepare a coating solution for a hard coat layer (HCL-1).

The compounds respectively used will be shown below.

“PET-30”: a mixture of pentaerythritol triacrylate and pentaerythritol tetraacrylate {manufactured by NIPPON KAYAKU Co., Ltd.}

“IRGACURE 184”: polymerization initiator {manufactured by Ciba Specialty Chemicals, Ltd.}

“SX-350”: crosslinked polystyrene particles with an average particle diameter of 3.5 μm {refractive index 1.60, manufactured by by Soken Chemicals & Engineering Co., Ltd., a 30% toluene dispersion. To be used after dispersion at 10000 rpm by means of a POLYTRON dispersing apparatus for 20 minutes.}

“KBM-5103”: acryloyloxypropyl trimethoxysilane {manufactured by Shin-Etsu Chemical Co., Ltd}

[Preparation of Coating Solutions for an Antiglare Layer (HCL-2 to HCL-9)]

In order to manufacture films having various hazes due to internal scattering and surface scattering HCL-2 to HCL-9, each of which has been obtained by changing the amount of the light transmissive particles added contained in the HCL-1 and the ratios of two types of particles therein, were prepared. The type and the amount used of each component used is shown in Table 5. Incidentally, each numerical value of the amount used in Table 5 represents mass % of the solid content (or effective component ) of each component occupied in the solid content of the coating solution for an antiglare layer.

TABLE 5

| | | Coating solution for an antiglare layer | | | | | | | |
|---|---|---|---|---|---|---|---|---|---|
| | | | | Reactive | | | | Light | |
| | | Photopolymerizable | | organic silicon | | | | transmissive | |
| | | multifunctional | | compound | | Photopolymerization | | particles | |
| | | monomer | | | Amount | initiator | | | Amount |
| | No. | Type | Amount used | Type | used | Type | Amount used | Type | used |
| Invention | HCL-1 | PET-30 | 75.1 | KBM | 15.0 | I-184 | 3.0 | SX-350 | 0.68 |
| | | | | | | | | Ac-St | 6.26 |
| Invention | HCL-2 | PET-30 | 74.0 | KBM | 14.8 | I-184 | 3.0 | SX-350 | 0.68 |
| | | | | | | | | Ac-St | 7.50 |
| Comparative | HCL-3 | PET-30 | 72.0 | KBM | 14.4 | I-184 | 2.9 | SX-350 | 0.68 |
| Example | | | | | | | | Ac-St | 10.00 |
| Comparative | HCL-4 | PET-30 | 80.1 | KBM | 16.0 | I-184 | 3.2 | SX-350 | 0.68 |
| Example | | | | | | | | Ac-St | 0.00 |
| Invention | HCL-5 | PET-30 | 79.3 | KBM | 15.9 | I-184 | 3.2 | SX-350 | 0.68 |
| | | | | | | | | Ac-St | 1.00 |
| Invention | HCL-6 | PET-30 | 78.5 | KBM | 15.7 | I-184 | 3.1 | SX-350 | 0.68 |
| | | | | | | | | Ac-St | 2.00 |
| Invention | HCL-7 | PET-30 | 75.5 | KBM | 15.1 | I-184 | 3.0 | SX-350 | 0.10 |
| | | | | | | | | Ac-St | 6.26 |
| Invention | HCL-8 | PET-30 | 75.3 | KBM | 15.1 | I-184 | 3.0 | SX-350 | 0.32 |
| | | | | | | | | Ac-St | 6.26 |
| Invention | HCL-9 | PET-30 | 75.6 | KBM | 15.1 | I-184 | 3.0 | SX-350 | 0.05 |
| | | | | | | | | Ac-St | 6.26 |

[Manufacturing of Antireflection Film Sample 31]

A 80 μm-thick triacetyl cellulose film “TAC-80U” {manufactured by Fuji Photo Film, Co., Ltd.} was wound in a roll form. Thus, directly, the coating solution for a hard coat layer (HCL-2) was coated using a 50-mm dia microgravure roll having a gravure pattern with 180 lines/in., and a depth of 40 μm, and a doctor blade under the conditions of a number of revolutions of the gravure roll of 30 rpm and a transfer speed of 30 m/min. After drying at 60° C. for 150 seconds, an ultraviolet ray with an illuminance of 400 mW/cm², and an exposure dose of 110 mJ/cm² was applied thereto using a 160 W/cm “air cooled metal halide lamp” {manufactured by EYEGRAPHICS Co., Ltd.) at an oxygen concentration of 0.1% by volume under nitrogen purge. As a result, the coated layer was cured to form a 6 μm-thick layer, and the resulting film was coiled. The resulting antiglare layer (HC-2) manufactured in this manner had a surface roughness: Ra=0.18 μm and Rz=1.40 μm, a surface haze of 12%, and an internal haze of 29%.

On the antiglare layer obtained in this manner, the coating solution for a low refractive index layer LLL-1 was used. Thus, the adjustment was carried out so that the low refractive index layer film thickness was 95 nm. As a result, an antireflection film sample 32 was manufactured. The drying conditions for the low refractive index layer were set at 120° C. and for 10 minutes. The UV curing conditions were set at an illuminance of 120 mW/cm², and an exposure dose of 240 mJ/cm² by using a 240 W/cm “air cooled metal halide lamp” {manufactured by EYEGRAPHICS Co., Ltd.) while carrying out nitrogen purge so as to achieve an atmosphere with an oxygen concentration of 0.01% by volume or less.

[Manufacturing of Antireflection Films 1 to 30 and 32 to 44] In manufacturing of the antireflection film (32), coating solutions for a low refractive index layer and coating solutions for an antiglare layer were used in the respective combinations of Table 6, thereby to manufacture antireflection films 1 to 31, and 33 to 42.

[Saponification Treatment of Antireflection Film]

Each resulting antireflection film was treated/dried under the following saponification standard conditions:

Alkali bath: 1.5 mol/dm³ sodium hydroxide aqueous solution, 55° C.-120 seconds.

First water washing bath: tap water, 60 seconds.

Neutralization bath: 0.05 mol/dm³ sulfuric acid, 30° C.-20 seconds.

Second water washing bath: tap water, 60 seconds.

Drying: 120° C., 60 seconds.

[Evaluation of Antireflection Film]

The following evaluations were carried out using the saponified antireflection films obtained in this manner.

(Evaluation 1) Measurement of Average Reflectance

The average reflectance at 450 to 650 nm was used according to the method described in this text. For each sample processed into a polarizing plate, the one in the polarizing plate form was used as it was. For each display apparatus in the form of a film itself or not using a polarizing plate, the back side of the antireflection film was subjected to a surface roughening treatment. Then, a light absorption treatment (the transmittance at 380 to 780 nm is less than 10%) was carried out with a black ink, and the measurement was carried out on a black stage.

(Evaluation 2) Steel Wool Scratch Resistance Evaluation

The test was carried out with the method described in this text. Then, to the back side of the sample which has been completely rubbed, an oil-based black ink was applied. Thus, visual observation thereof was carried out with a reflected light, and the scratches at the rubbed part were rated according to the following criteria:

A: No scratch is observable at all even when observed very carefully.

AB: Unclear scratches are slightly observable when observed very carefully.

B: Unclear scratches can be observed.

BC: Medium degree of scratches can be observed.

C: There are scratches noticeable at a glance.

(Evaluation 3) “Magic Ink” Adhesion Evaluation

An adhesion test was carried out with the method described in this text. Each state when the mark has been wiped off with a cleaning cloth was observed. Thus, the magic adhesion was rated as follows:

AA: The mark of Magic can be completely wiped off.

A: The mark of Magic can be slightly observed.

AB: Some mark of Magic can be observed, but it is slight.

B: Some mark of Magic can be observed.

BC: The mark of Magic remains, but it can be substantially wiped off.

C: The mark of Magic can be hardly wiped off.

The configuration of the resulting antireflection film, the curing conditions for the low refractive index layer, and the evaluation results are shown in Table 6.

TABLE 6

| | Antireflection film | | | | | | | | | | |
|---|---|---|---|---|---|---|---|---|---|---|---|
| | | | Low refractive index layer | | | | | | | | |
| | | Antiglare | | Curing conditions | | | Evaluation results | | | | |
| | | layer | | | | Light curing | Haze | | | | |
| | | coating | | Heating | | UV | Internal | Surface | | | “Magic |
| | Sample | solution | Coating | Temperature | Time | illuminance | scattering | scattering | Average | Scratch | Ink” |
| | No. | No. | solution No. | (° C.) | (min.) | (mJ) | (%) | (%) | reflectance (%) | resistance | adhesion |
| Ex. 1-1 | 1 | HCL-1 | LLL-1 | 120 | 10 | 360 | 26 | 4 | 1.42 | A | AA |
| Ex. 1-2 | 2 | HCL-1 | LLL-2 | 120 | 10 | 360 | 26 | 4 | 1.42 | AB | AA |
| Ex. 1-3 | 3 | HCL-1 | LLL-3 | 120 | 10 | 360 | 26 | 4 | 1.43 | AB | AA |
| Ex. 1-4 | 4 | HCL-1 | LLL-4 | 120 | 10 | 360 | 26 | 4 | 1.42 | B | AA |
| Ex. 1-5 | 5 | HCL-1 | LLL-5 | 120 | 10 | 360 | 26 | 4 | 1.43 | A | AA |
| Ex. 1-6 | 6 | HCL-1 | LLL-6 | 120 | 10 | 360 | 26 | 4 | 1.42 | A | AA |
| Ex. 1-7 | 7 | HCL-1 | LLL-7 | 120 | 10 | 360 | 26 | 4 | 1.42 | AB | AA |
| Ex. 1-8 | 8 | HCL-1 | LLL-8 | 120 | 10 | 360 | 26 | 4 | 1.43 | B | A |
| Ex. 1-9 | 9 | HCL-1 | LLL-9 | 120 | 10 | 360 | 26 | 4 | 1.42 | B | A |
| Ex. 1-10 | 10 | HCL-1 | LLL-10 | 120 | 10 | 360 | 26 | 4 | 1.42 | A | AA |
| Ex. 1-11 | 11 | HCL-1 | LLL-11 | 120 | 10 | 360 | 26 | 4 | 1.41 | B | AA |
| Ex. 1-12 | 12 | HCL-1 | LLL-12 | 120 | 10 | 360 | 26 | 4 | 1.54 | B | A |
| Ex. 1-13 | 13 | HCL-1 | LLL-13 | 120 | 10 | 360 | 26 | 4 | 1.66 | B | A |
| Ex. 1-14 | 14 | HCL-1 | LLL-14 | 120 | 10 | 360 | 26 | 4 | 1.63 | B | A |
| Comp. Ex. | 15 | HCL-1 | LLL-15 | 120 | 10 | 360 | 26 | 4 | 1.42 | BC | B |
| 1-1 | | | | | | | | | | | |
| Ex. 1-15 | 16 | HCL-1 | LLL-16 | 120 | 10 | 360 | 26 | 4 | 1.42 | AB | AA |
| Ex. 1-16 | 17 | HCL-1 | LLL-17 | 120 | 10 | 360 | 26 | 4 | 1.42 | AB | AA |
| Ex. 1-17 | 18 | HCL-1 | LLL-18 | 120 | 10 | 360 | 26 | 4 | 1.47 | A | AA |
| Ex. 1-18 | 19 | HCL-1 | LLL-19 | 120 | 10 | 360 | 26 | 4 | 1.48 | AB | AA |
| Ex. 1-19 | 20 | HCL-1 | LLL-20 | 140 | 10 | 360 | 26 | 4 | 1.42 | A | A |
| Ex. 1-20 | 21 | HCL-1 | LLL-21 | 80 | 10 | 360 | 26 | 4 | 1.42 | AB | AA |
| Ex. 1-21 | 22 | HCL-1 | LLL-22 | 60 | 10 | 360 | 26 | 4 | 1.42 | B | AA |
| Ex. 1-22 | 23 | HCL-1 | LLL-23 | 120 | 10 | — | 26 | 4 | 1.42 | BA | B |
| Ex. 1-23 | 24 | HCL-1 | LLL-24 | 120 | 10 | 360 | 26 | 4 | 1.42 | A | A |
| Ex. 1-24 | 25 | HCL-1 | LLL-25 | 120 | 10 | 360 | 26 | 4 | 1.42 | A | A |
| Ex. 1-25 | 26 | HCL-1 | LLL-26 | 120 | 10 | 360 | 26 | 4 | 1.42 | A | B |
| Ex. 1-26 | 27 | HCL-1 | LLL-27 | 120 | 10 | 360 | 26 | 4 | 1.42 | A | AB |
| Ex. 1-27 | 28 | HCL-1 | LLL-28 | 120 | 10 | 360 | 26 | 4 | 1.42 | A | AB |
| Ex. 1-28 | 29 | HCL-1 | LLL-29 | 120 | 10 | 360 | 26 | 4 | 1.42 | A | A |
| Ex. 1-29 | 30 | HCL-1 | LLL-30 | 120 | 10 | 360 | 26 | 4 | 1.42 | A | AA |
| Ex. 1-30 | 31 | HCL-2 | LLL-1 | 120 | 10 | 360 | 27 | 9 | 1.42 | A | A |
| Comp. Ex. | 32 | HCL-2 | LLL-15 | 120 | 10 | 360 | 27 | 9 | 1.43 | BC | B |
| 1-2 | | | | | | | | | | | |
| Ex. 1-31 | 33 | HCL-2 | LLL-16 | 120 | 10 | 360 | 27 | 9 | 1.42 | A | A |
| Ex. 1-32 | 34 | HCL-2 | LLL-17 | 120 | 10 | 360 | 27 | 9 | 1.41 | A | A |
| Comp. Ex. | 35 | HCL-3 | LLL-1 | 120 | 10 | 360 | 23 | 14 | 1.42 | B | B |
| 1-3 | | | | | | | | | | | |
| Comp. Ex. | 36 | HCL-3 | LLL-15 | 120 | 10 | 360 | 23 | 14 | 1.43 | BC | B |
| 1-4 | | | | | | | | | | | |
| Comp. Ex. | 37 | HCL-3 | LLL-16 | 120 | 10 | 360 | 23 | 14 | 1.42 | B | B |
| 1-5 | | | | | | | | | | | |
| Comp. Ex. | 38 | HCL-3 | LLL-17 | 120 | 10 | 360 | 23 | 14 | 1.42 | B | B |
| 1-6 | | | | | | | | | | | |
| Comp. Ex. | 39 | HCL-4 | LLL-1 | 120 | 10 | 360 | 26 | 0 | 1.56 | C | BC |
| 1-7 | | | | | | | | | | | |
| Ex. 1-33 | 40 | HCL-5 | LLL-1 | 120 | 10 | 360 | 26 | 1.2 | 1.51 | AB | A |
| Ex. 1-34 | 41 | HCL-6 | LLL-1 | 120 | 10 | 360 | 26 | 1.7 | 1.42 | AB | A |
| Ex. 1-35 | 42 | HCL-7 | LLL-1 | 120 | 10 | 360 | 37 | 3 | 1.42 | A | AA |
| Ex. 1-36 | 43 | HCL-8 | LLL-1 | 120 | 10 | 360 | 12 | 3 | 1.42 | A | AA |
| Ex. 1-37 | 44 | HCL-9 | LLL-1 | 120 | 10 | 360 | 2 | 3 | 1.42 | A | AA |

As apparent from the examples, it is indicated that the antireflection film samples of Examples of the invention are excellent in scratch resistance, and also excellent in stain proof property.

The samples 15, 32 and 36 each not using the organic base of the invention for the curing catalyst can form only films low in curing activity, and largely inferior in scratch resistance.

Whereas, for the samples 35, 37 and 38 each having a surface haze of as high as 14%, the effects of use of the organic bases of the invention are small. Thus, both of the scratch resistance and the stain proof property are not sufficiently attained.

The advantage of the invention is particularly preferable for the sample 1. For the sample 2 in which the curing agent has been changed, the samples 8 and 9 in each of which the acid of the curing catalyst has been changed, the sample 13 and 14 not using inorganic particles, and the sample 23 not employing heat curing and light curing in combination, the scratch resistance and/or the stain proof property have been a little degraded.

For the sample in which the hollow silica content has been reduced as with the sample 12, and the sample in which MEK-STL has substituted therefor as with the sample 18 or 19, the reflectance has increased.

Whereas, for the sample 26 in which no silicon is contained in the fluorine-containing polymer for use in the low refractive index layer, and no stain proof agent has been added, the stain proof property has been deteriorated.

### Example 2

[Preparation of Coating Solution for a Low Refractive Index Layer (LLL-31)]

LLL-31 was prepared in the same manner as with LLL-1, except that the base of the curing catalyst was not used in the coating solution for a low refractive index layer LLL-1 in Example 1.

[Preparation of Coating Solution for a Low Refractive Index Layer (LLL-32)]

LLL-32 was prepared in the same manner as with LLL-1, except that the kind of the base of the curing catalyst was changed to (b-14) in the coating solution for a low refractive index layer LLL-1 in Example 1.

[Manufacturing of Antireflection Films 45 to 54]

The coating solution for an antiglare layer and the coating solution for a low refractive index layer were changed as shown in Table 7, in manufacturing of the antireflection film 31 of Example 1. Thus, antireflection films 45 to 54 were manufactured. During manufacturing of each antireflection film, the coating solution for a low refractive index layer was allowed to stand. Then, the stability of each coating solution was evaluated according to the following (evaluation 4). The evaluation results are shown together in Table 7.

(Evaluation 4) Coating Solution Stability Evaluation

The coating solution for a low refractive index layer was stored at 20° C. for 3 hours after mixing respective components. This was used as the reference (FR). Thus, the one stored at 40° C. for 1 week, and the one stored at 40° C. for 2 weeks were manufactured. By using these coating solutions, antireflection films were manufactured. Then, an oil-based black ink was applied to each back side, and a reflected light was visually observed. Thus, the surface conditions were rated according to the following criteria. The levels equal to, or better than AB is a practically allowable level.

A: No nonuniformity is observable even when observed very carefully.

AB: Unclear nonuniformity are slightly observable when observed very carefully.

B: Unclear nonuniformity is observable.

BC: Medium degree of nonuniformity is observable.

C: There is nonuniformity noticeable at a glance.

TABLE 7

| | | | | Evaluation results | | | | |
|---|---|---|---|---|---|---|---|---|
| | Antireflection film | | | | | Coating solution | | |
| | | | Low refractive | | | stability evaluation | | |
| | | Antiglare | index layer | Haze | | | 40° C.-1 W | 40° C.-2 W |
| | | coating | coating solution | Internal | Surface | FR surface | surface | surface |
| | Sample No. | solution No. | No. | scattering (%) | scattering (%) | conditions | conditions | conditions |
| Comp. Ex. 2-1 | 45 | HCL-1 | LLL-31 | 26 | 4 | A | C | C |
| Comp. Ex. 2-2 | 46 | HCL-2 | LLL-31 | 27 | 9 | A | C | C |
| Comp. Ex. 2-3 | 47 | HCL-3 | LLL-31 | 23 | 14 | A | BC | C |
| Ex. 2-1 | 48 | HCL-1 | LLL-32 | 26 | 4 | A | A | A |
| Ex. 2-2 | 49 | HCL-2 | LLL-32 | 27 | 9 | A | A | A |
| Comp. Ex. 2-4 | 50 | HCL-3 | LLL-32 | 23 | 14 | A | A | A |
| Ex. 2-3 | 51 | HCL-1 | LLL-26 | 26 | 4 | A | AB | B |
| Ex. 2-4 | 52 | HCL-1 | LLL-24 | 26 | 4 | A | A | A |
| Ex. 2-5 | 53 | HCL-1 | LLL-25 | 26 | 4 | A | A | A |
| Ex. 2-6 | 54 | HCL-1 | LLL-29 | 26 | 4 | A | A | AB |

These examples indicate the following fact. Each composition containing a salt formed from an organic base and an acid of the invention provides good surface conditions even after storage of the coating solution. Particularly, as apparent from the comparison between the samples 45 and 46 and the samples 48 and 49, for the sample with a surface haze of less than 10% which undergoes large deterioration of the surface conditions with time when not using an organic base, the improvement of the surface conditions by an organic base is effective. Further, the following fact is also indicated. The samples 52 and 53 in which the fluorine-containing polymer contains a polysiloxane unit are less susceptible to deterioration of the surface conditions with time of the coating solution as compared with the sample 51 in which the fluorine-containing polymer does not contain a polysiloxane unit.

<Manufacturing of a Polarizing Plate with an Antireflection Film>

### Example 3

A drawn polyvinyl alcohol film was allowed to adsorb iodine, thereby to manufacture a polarizing film. The antireflection film subjected to the saponification treatment of Example 1 was bonded onto one side of the polarizing film by the use of a polyvinyl alcohol type adhesive so that the support (triacetyl cellulose) side of the antireflection film became the polarizing film side. A viewing angle enlarging film “Wide View Film SA-12B”, manufactured by Fuji Photo Film, Co., Ltd.} having an optical compensation layer was subjected to a saponification treatment, and bonded onto another side of the polarizing film by the use of a polyvinyl alcohol type adhesive. A polarizing plate was manufactured in this manner. The evaluations according to Example 1 were carried out in this polarizing plate form. As a result, it was possible to obtain the same effects by using the polarizing plate using the antireflection film of the invention.

<Image Display Device>

### Example 4

The polarizing plate of the invention manufactured in Example 3 was mounted on a TN mode transmission type liquid crystal display device. As a result, it was possible to confirm that the display device is excellent in visibility, scratch resistance, and stain proof property.

### Example 5

The antireflection film sample of Example 1 was bonded on the glass plate on the surface of an organic EL display device via a self-adhesive. As a result, the reflection from the glass surface was suppressed, resulting in a display device with high visibility.

This application is based on Japanese Patent application JP 2005-240007, filed Aug. 22, 2005, the entire content of which is hereby incorporated by reference, the same as if set forth at length.

What is claimed is:

1. An antireflection film comprising a support and a layer formed by coating a composition containing at least one salt formed from an organic base whose conjugate acid has a pKa of from 5.0 to 10.5 and an acid, wherein the antireflection film has a haze value due to surface scattering of 1 % or more and less than 10%.

2. An antireflection film comprising a support and a layer formed by coating a composition containing at least one salt formed from a nitrogen-containing organic base having a boiling point of from 35° C. to 85° C. and an acid, wherein the antireflection film has a haze value due to surface scattering of 1% or more and less than 10%.

3. The antireflection film according to claim 1, wherein the acid is sulfonic acid.

4. The antireflection film according to claim 2, wherein the acid is sulfonic acid.

5. The antireflection film according to claim 1, wherein the layer formed by coating the composition is a low refractive index layer.

6. The antireflection film according to claim 2, wherein the layer formed by coating the composition is a low refractive index layer.

7. The antireflection film according to claim 1, wherein the composition further contains:
at least one fluorine-containing polymer having (a) a fluorine-containing vinyl monomer polymerization unit and (b) a hydroxyl group-containing vinyl monomer polymerization unit; and
at least one crosslinking agent reactable with a hydroxyl group, and
the layer formed by coating the composition is a low refractive index layer.

8. The antireflection film according to claim 2, wherein the composition further contains:
at least one fluorine-containing polymer having (a) a fluorine-containing vinyl monomer polymerization unit and (b) a hydroxyl group-containing vinyl monomer polymerization unit; and
at least one crosslinking agent reactable with a hydroxyl group, and
the layer formed by coating the composition is a low refractive index layer.

9. The antireflection film according to claim 7, wherein the crosslinking agent is a compound containing a nitrogen atom in the molecule, and having two or more carbon atoms, each substituted with an alkoxy group adjacent to the nitrogen atom.

10. The antireflection film according to claim 8, wherein the crosslinking agent is a compound containing a nitrogen atom in the molecule, and having two or more carbon atoms, each substituted with an alkoxy group adjacent to the nitrogen atom.

11. The antireflection film according to claim 1, which has a haze value due to internal scattering of from 5 to 30%.

12. The antireflection film according to claim 2, which has a haze value due to internal scattering of from 5 to 30%.

13. The antireflection film according to claim 1, which has a total haze value of from 5% to 35%.

14. The antireflection film according to claim 2, which has a total haze value of from 5% to 35%.

15. The antireflection film according to claim 7, wherein the fluorine-containing polymer has: (a) a fluorine-containing vinyl monomer polymerization unit; (b) a hydroxyl group-containing vinyl monomer polymerization unit; and (c) a polymerization unit having a graft moiety including a polysiloxane repeating unit represented by the following formula (1) at a side chain, and the fluorine-containing polymer has a main chain including only carbon atoms: 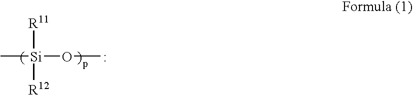
wherein R¹¹ and R¹² each independently represent an alkyl group or an aryl group, and p represents an integer of from 1 to 500.

16. The antireflection film according to claim 8, wherein the fluorine-containing polymer has: (a) a fluorine-containing vinyl monomer polymerization unit; (b) a hydroxyl group-containing vinyl monomer polymerization unit; and (c) a polymerization unit having a graft moiety including a polysiloxane repeating unit represented by the following formula (1) at a side chain, and the fluorine-containing polymer has a main chain including only carbon atoms: 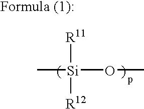
wherein R¹¹ and R¹² each independently represent an alkyl group or an aryl group, and p represents an integer of from 1 to 500.

17. The antireflection film according to claim 7, wherein the fluorine-containing polymer has: (a) a fluorine-containing vinyl monomer polymerization unit; and (b) a hydroxyl group-containing vinyl monomer polymerization unit, and the fluorine-containing polymer has (d) a polysiloxane repeating unit represented by the following formula (1) at a main chain: 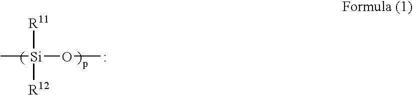
wherein R¹¹ and R¹² each independently represent an alkyl group or an aryl group, and p represents an integer of from 1 to 500.

18. The antireflection film according to claim 8, wherein the fluorine-containing polymer has: (a) a fluorine-containing vinyl monomer polymerization unit; and (b) a hydroxyl group-containing vinyl monomer polymerization unit, and the fluorine-containing polymer has (d) a polysiloxane repeating unit represented by the following formula (1) at a main chain: 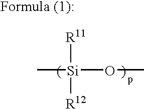
wherein R¹¹ and R¹² each independently represent an alkyl group or an aryl group, and p represents an integer of from 1 to 500.

19. The antireflection film according to claim 5, wherein the composition for forming the low refractive index layer further contains a compound having a hydroxyl group or a polysiloxane structure capable of reacting with a hydroxyl group to form a bond.

20. The antireflection film according to claim 6, wherein the composition for forming the low refractive index layer further contains a compound having a hydroxyl group or a polysiloxane structure capable of reacting with a hydroxyl group to form a bond.

21. The antireflection film according to claim 5, wherein the low refractive index layer contains inorganic oxide particles having a particle size of from 1 nm to 150 nm.

22. The antireflection film according to claim 6, wherein the low refractive index layer contains inorganic oxide particles having a particle size of from 1 nm to 150 nm.

23. The antireflection film according to claim 21, wherein the inorganic oxide particles are hollow silica particles.

24. The antireflection film according to claim 22, wherein the inorganic oxide particles are hollow silica particles.

25. A method for manufacturing an antireflection film, comprising:
coating a composition containing at least one salt formed from an organic base whose conjugate acid has a pKa of from 5.0 to 10.5 and an acid;
heating the coated composition at from 70° C. to 130° C. for from 5 minutes to 20 minutes; and
curing the coated composition with an active energy ray,
wherein the curing of the coated composition is conducted simultaneously with the heating of the coated composition, before the heating of the coated composition or after the coating of the coated composition.

26. A method for manufacturing an antireflection film, comprising:
coating a composition containing at least one salt formed from a nitrogen-containing organic base having a boiling point of from 35° C. to 85° C. and an acid;
heating the coated composition at from 70° C. to 130° C. for from 5 minutes to 20 minutes; and
curing the coated composition with an active energy ray,
wherein the curing of the coated composition is conducted simultaneously with the heating of the coated composition, before the heating of the coated composition or after the coating of the coated composition.

27. A polarizing plate comprising two protective films and a polarizing film provided between the protective films, wherein at least one of the protective films is the antireflection film according to claim 1.

28. A polarizing plate comprising two protective films and a polarizing film provided between the protective films, wherein at least one of the protective films is the antireflection film according to claim 2.

29. An image display device wherein the antireflection film according to claim 1 is provided at an outermost surface of the display.

30. An image display device wherein the antireflection film according to claim 2 is provided at an outermost surface of the display.
